(19) United States
(12) Patent Application Publication
(10) Pub. No.: US 2003/0182246 A1
(43) Pub. Date: Sep. 25, 2003

(54) Applications of fractal and/or chaotic techniques

(76) Inventors: William Nevil Heaton Johnson, St. Peter Port (GB); Jonathan Michael Blackledge, Leicester (GB); Bruce Lawrence John Murray, Barcombe (GB)

Correspondence Address: ECKERT SEAMANS CHERIN & MELLOTT, 600 GRANT STREET, 44TH FLOOR, PITTSBURGH, PA, 15219

(21) Appl. No.: 10/149,526

(22) PCT Filed: Dec. 11, 2000
(86) PCT No.: PCT/GB00/04736

(30) Foreign Application Priority Data
Dec. 10, 1999 (GB) 9929364.9

(51) Int. Cl. G06F 17/60; H04K 1/00; H04L 9/00; H04N 7/167

(52) U.S. Cl. 705/76; 380/201; 380/278

(57) ABSTRACT

This invention relates to the application of techniques based upon the mathematics of fractals and chaos in various fields including document verification, data encryption and weather forecasting. The invention also relates, in one of its aspects, to image processing.

This invention relates to the application of techniques based upon the mathematics of fractals and chaos in various fields including document verification, data encryption. The invention also relates, in one of its aspects to image processing.

For convenience, the description which follows is divided into five sections each relating to a respective aspect or set of aspects of the invention.

### SECTION 1

Making Money From Fractals and Chaos: Microbar™

Introduction

We are all accustomed to the use of bar coding which was first introduced in the late 1960s in California and has grown to dominate commercial transactions of all types and sizes. Microbar™ is a natural extension of the idea but with some important and commercially viable subtleties that are based on the application of fractal geometry and chaos.

The origins of Microbar go back to the mid 1990s and like all good ideas, were based on asking the right questions at the right time: Instead of using 1D bar codes why not try 2D dot codes? One of the reasons for considering this simple extension was due to the dramatic increase in the number of products that required bar code tagging. Another, more important reason, concerned the significant increase in counterfeit products.

Bar Codes

Product numbering or bar coding in the UK is the responsibility of the e-centre UK who issue unique bar codes for different products. The e-centre UK was a founder member of the European Article Numbering (EAN) Association, which is now known as EAN International. The EAN system was developed in 1976, following on from the success of an American system which was adopted as an industry standard in 1973. EAN tags are unique and unambiguous, and can identify any item anywhere in the world. These numbers are represented by bar codes which can be read by scanners throughout the supply chain, providing accurate information for improved management. As the number of products increases, so the number of bits required to represent a product uniquely must increase. The EAN system has recently introduced a new 128 bit bar-code (the EAN-128) to provide greater information on a larger diversity of products. They are used on traded units; retail outlets use a EAN-18 bar code.

Microbar's Origins

Compared with a conventional bar code, a Microbar serves two purposes: (i) converting from a 1D bar code to a 2D dot code provides the potential for greater information density; (ii) this information can be embedded into the product more compactly making it more difficult to copy.

In the early stages of Microbar's development, it was clear that a conventional laser scanning system would have to be replaced by a specialist reader—instead of scanning a conventional bar code with a “pencil line” laser beam, an image reader/decoder (hand-held or otherwise) would need to be used. The original idea evolved from the laser speckle coding techniques used to authenticate the components of nuclear weapons. It was developed by Professor Nick Phillips (Director of the Centre for Modern Optics at De Montfort University) and by Dr William Johnson (Chief Executive of Durand Technology Limited) and focused on the anti-counterfeiting market. It was based on a 2D dot code formed from a matrix of micro-reflectors. When exposed to laser light, a CCD camera records the scattered intensity from which the pattern is recovered (via suitable optics and appropriate digital image processing). The micro-reflectors (which look-like white dots in a black background) are embedded into a tiny micro-foil which is then attached to the product as a micro-label. The pattern of dots is generated by implementing a pseudo random number generator and binarizing the output to give a so called stochastic mask. This mask is then burnt into a suitable photopolymer. (Its a bit like looking at “cats eyes” on the road when driving in the dark, except that instead of being placed at regular intervals along the centre of the road, they are randomly distributed all over it.) The “seed” used to initiate the random number generator and the binarization threshold represent the “keys” used for identifying the product. If the stochastic mask for a given product correlates with the template used in the identification processes, then the product is passed as being genuine.

As always, good ideas suffer from technical, bureaucratic and capital investment problems (especially in the UK). In this case the main problem has been the high cost of introducing an optical Microbar into security documents and labels and the specialist optical readers/decoders required to detect and verify the codes. An additional problem is that counterfeiters are not stupid! Indeed, some of the best ideas for anti-counterfeiting technology along with methods of encryption, computer virus algorithms, hacking, cracking and so on are products of the counterfeit/criminal mind whose ideas often transcend those of an established authority. Whatever is put onto a label or at least, is seen to be on it, can in principle be copied (if enough effort is invested). For example, the holograms that are commonly used on debit and credit cards, software licensing agreements and on the new twenty pound note are relatively easy targets for counterfeiters. Furthermore, contrary to public opinion, such holograms convey no information whatsoever about the authentication of the product. As long as it looks right, its all right. Thus, although the optical Microbar could in principle provide a large amount of information pertinent to a given product, it was still copyable. What was required was a covert equivalent.

In Comes Russia

In 1996, De Montfort University won a prestigious grant from the Defence Evaluation and Research Agency at Malvern (formerly the royal Signals and Radar Establishment) to investigate novel methods of encryption and covert technology for digital communication systems (including radio, microwave and ATM networks). The aim was to develop a new digital Enigma-type machine based on the applications of fractals and chaos. This grant was (and is) unique in that it was awarded on the basis of employing a number of Research Assistants (mathematicians, computer scientists and engineers) from the Moscow State Technical University (MSTU). Since the end of the cold war, De Montfort University has had a long standing Memorandum of Agreement with MSTU—a university whose graduates include some of the great names in Russian science and engineering, including the aerodynamicist Tupolev and the inventor of Russian Radar and the current Vice Chancellor, Professor Federov. As expressed at the time by all concerned, if we had previously suggested that one day, young Russian scientists wkould be employed in the UK, financed by HMS government working on state of the art military communications systems, than off to hospital we would have gone!

One of the projects was based on using random scaling fractals to code bit streams. The technique, which later came to be known as Fractal Modulation, worked on the same principles as Frequency Modulation; instead of transmitting a coded bit stream by modulating the frequency of a sine wave generator, the fractal dimension of a fractal noise generator is modulated. In addition to spread spectrum and direct sequencing, Fractal Modulation provides a further covert method of transmission with the aim of making the transmitted signal “look like” background noise. Not only does the enemy not know what is being said (as a result of bit stream coding) but is not sure whether a transmission is taking place. As the project developed, it was realised that if a 2D bit map was considered instead of a 1D bit stream, then an image could be created which “looked like” noise but actually had information embedded in it. The idea evolved of introducing a technique that has a synergy with the conventional electronic water mark (commonly used in the transmission of digital images) and fractal camouflage but is more closely related to a Microbar where a random bit map is converted into a map of fractal noise. Thus, the Microbar evolved from being a stochastic mask composed of micro-reflectors implemented using laser optics to a “stochastic agent” used to encode information in a covert way using digital technology. That was the idea. Getting it to work using conventional printing and scanning technology has taken time but was done in the knowledge that specialist optical devices and substrate's would not be required and that a working system could be based on existing digital printer/reader technology as used by all the major security document printing companies.

Why Does It Work?

The digital Microbar system is a type of Steganography in which secret codes are introduced into an image without appearing to change it. For example, suppose you send an innocent memorandum discussing the weather or something, which you know will be intercepted. A simple code can be introduced by putting pin holes through appropriate letters in the text. Taking these letters from the text in a natural or pre-arranged order will allow the recipient of the document to obtain a coded message (providing of course, the interceptor does not see the pin holes and wonder why they are there!). Microbar technology uses a similar idea but makes the pin holes vanish (well sort of), using a method that is based on the use of self-affine stochastic fields.

Suppose you are shown two grey level images of totally different objects (a face and a house for example) but whose distribution in grey levels is exactly the same. If you were asked the question, are the images the same? then your answer will be “no”. If you were asked whether the images are statistically the same, your answer might be “I don't know” or “in what sense?” When we look at an image, our brain attempts to interpret it in terms of a set of geometric correlations with a library of known templates (developed from birth), in particular, information on the edges or boundaries of features which are familiar to us. It is easy to confuse this form of neural image processing by looking at pictures of objects that do not conform to our perception of the world—the Devil's triangle or Escher's famous lithograph “ascending and descending” for example. Thus, our visual sense is based (or has developed) on correlations that conform to a Euclidean perspective of the world. Imagine that our brain interpreted images through their statistics alone. In this case, if you were given the two images discussed above and asked the same question, you would answer “yes”. Suppose then that we construct two images of the same object but modify the distribution of grey levels of one of them in such a way that our (geometric) interpretation of the images is the same. Further, add colour into the “equation” in which the red, green and blue components can all have different statistics and it is clear that we can find many ways of confusing the human visual system because it is based on a Euclidean geometric paradigm with colour continuity. Moreover, construct an image which has all these properties but in addition, is statistically self-affine so that as we zoom into the image, the distribution of its RGB components are the same. Without going into the details of the encryption and decoding processes (which remain closed anyway), these are some of the basic principles upon which the current Microbar system works. In short, a Microbar introduces a stochastic agent into a digital image (encryption) which has three main effects: (i) it changes the statistics of the image without changing the image itself (covert); (ii) these statistics can be confirmed (or otherwise) at arbitrary scales (fractals); (iii) any copy made of the image introduces different statistics since no copy can be a perfect replica (anti-counterfeiting). Point (iii) is the reason why the Microbar can detect copies. Point (ii) is the reason why detection does not have to be done by a high resolution (slow) reader and point (i) is why it can't be seen. There is one further and important variation on a theme. By embedding a number of Microbar's into a printed document at different(random) locations, it is possible to produce an invisible code (similar to the “pin holes” idea discussed at the start of this Section). This code (i.e. the Microbars” coordinates) can be generated using a standard or preferably non-standard encryption algorithm whose key(s) are related via another encryption algorithm to the serial number(s) of the document or bar code(s). In the case of non-standard encryption algorithms, chaotic random number generation is used instead of conventional pseudo random number generation. For each aspect of the Microbar “secrets” discussed above, there are many refinements and adjustments required to get the idea to work in practice which depend on the interplay between the digital printer technology available, reader specifications, cost and encryption hierarchy (related to the value of the document to be encrypted).

Current State of Play

Introducing stochastic agents into printed or electronically communicated information has a huge number of applications. The commercial potential of Microbar™ was realised early on. As a result, a number of international patents have been established and a new company “Microbar Security Limited” set up in partnership with “Debden Security Printing”—the commercial arm of the Bank of England, where a new cryptography office has been established and where the “keys” associated with the whole process for each document can be kept physically and electronically secure. In June this year, Microbar was demonstrated for the first time publicly at the “First World Product and Image Security Convention” held in Barcelona. The demonstration was based on a Microbar encryption of a bank bond and a COTS (Commercial Of The Shelf) system developed to detect and decode the Microbar. The unveiling of this demonstration prototype has led to a number of contracts with leading security printing company's in the UK, USA, Germany, Russia and the Far East. One of the reasons for starting at the top (i.e. with very high value documents—bank bonds) was due to the fact that a major contribution to the decline of the Russian economy last year related to a rapid increase in the exchange of counterfeit Russian bank bonds. The IMF requested that the Federal Bank of Russia reduce the quantity of Roubles being printed in late 1997, a request which was agreed to, but traded-off by an increase in the production of bank bonds (this will not happen again with Microbar™).

The Future

The use of Microbar™ in the continuing battle against forgery will be of primary importance over the next few years. With the increased use of anti-counterfeit features for currency, Microbar represents a general purpose technology which can and should be used in addition to other techniques that include the use of fluorescent inks, foil holograms, optical, infrared and thermal watermarks, phase screens, enhanced paper/print quality, microprinting and so on. However, one of the most exiting prospects for the future is in its application to Smartcard technology and e-commerce security. As an added bonus, the theoretical models used to generate and process Microbar encrypted data are being adapted to analyse financial data and to develop a new and robust macro-economic volatility prediction metric. Thus, in the future, Microbar™ may not only be used to authenticate money but to help money keep its value!

Finally, self-affine data analysis is currently being applied to medicine. Early trials have shown that epedemiological time series data is statistically self-affine, irrespective of the type of disease. This may lead to new relationships between the study of health in terms of cause and effect. This approach—called Medisine™—will be of significant value in the analysis of health case and government expenditure in the next millenium.

In the above description, the references to “1D” and “2D” are, of course, abbreviations for one-dimensional (referring to a linear arrangement or series of marks) and two-dimensional (referring to an array of marks, e.g. on a flat sheet distributed in two perpendicular directions on the sheet, for example). respectively. The use of random scaling factors, fractal statistics, and the term “self-affine”, inter alia, are discussed in more detail in WO99/17260 which is incorporated herein by reference.

In the present specification, “comprise” means “includes or consists of” and “comprising” means “including or consisting of”.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

### SECTION 2

Anti-Counterfeiting and Signature Verification System

This invention relates to an anti-counterfeiting and signature verification system, and to components thereof The invention is particularly, but not exclusively, applicable to credit and debit cards and the like.

A typical credit or debit card has currently, on a reverse side of the card, a magnetic stripe adapted to be read by a magnetic card reader and a stripe of material adapted to receive the bearer's signature, executed generally by ballpoint pen in oil-based ink. The last-noted stripe, herein referred to, for convenience, as the signature stripe, may be pre-printed with a pattern or wording so as to make readily detectable any erasure of a previous signature and substitution of a new signature on a card which has been stolen. For the same reason, the signature stripe normally comprises a thin coating of a paint or plastics material covering wording, (such as “VOID”), on the card substrate, so that any attempt to remove the original signature by scraping the top layer off the signature stripe with a view to substituting the criminal's version of the legitimate card bearer's signature is likely to remove the stripe material in its entirety, leaving the underlying wording exposed to view. Whilst these measures safeguard against the more inept attempts to substitute signatures on stolen credit or debit cards, they are less effective against better-equipped criminals who may possess, or have access to, equipment capable of, for example, removing original signature stripes in their entirety and applying fresh signature stripes printed with a counterfeit copy of any pre-printed marking or wording originally present and which cards may be then be supplied to criminals who can “sign” the cards and subsequently use them fraudulently

It is among the objects of the invention to provide a system and components of such system, which will prevent, or at least render more difficult, criminal activities of the type discussed above.

According to the invention, there is provided a document, card, or the like, having an area adapted to receive a signature or other identifying marking, and which bears a two-dimensional coded marking adapted for reading by a complementary automatic reading device.

Preferably, the complementary automatic reading device includes means for detecting, from a perceived variation in such coding resulting from subsequent application of a signature, whether such signature corresponds with a predetermined authentic signature. The term “corresponds” in this context may signify an affirmative outcome of a more or less complex comparison algorithm adapted to accept as authentic signatures by the same individual who executed the predetermined signature, but to reject forged versions of such signatures executed by other individuals.

The two-dimensional coded marking referred to above may take the form referred to, for convenience, as “Microbar” in the Appendix forming part of this specification and may be a fractal coded marking of the kind disclosed in W099/17260, which is incorporated herein by reference.

In a preferred embodiment of the invention, as applied for example, to a credit card or debit card, a signature stripe on the card, as provided by the issuing bank or other institution, carries, as a unique identification, a two dimensional coded marking of the type referred to as “Microbar” in the annex hereto, which can be read by a complementary reading device which can determine on the basis of predetermined decryption algorithms not only the authenticity of the marking but also the unique identity thereof, (i.e. the device can ascertain, from the coded marking, the identity of the legitimate bearer, his or her account number, and other relevant details encoded in the marking). The complementary reading device will, it is envisaged, normally be an electrically operated electronic device with appropriate microprocessor facilities, thereading device being capable of communication with a central computing and database facility at premises of the bank or other institution issuing the card. The coding on the signature stripe is preferably statistically fractal in character (c.f. WO99/17260), with the advantage that minor damage to the stripe, such as may be occasioned by normal “wear and tear” will not prevent a genuine signature stripmarking being detected as genuine nor prevent the identification referred to.

It will be understood that the writing of a signature on the signature strip has the potential to alter the perception of the coded marking by the complementary reading device. However, because of the fractal nature of the coded marking, (or otherwise, because an appropriate measure of redundancy is incorporated in the marking, the application of a signature to the signature stripe does not, any more than the minor wear and tear damage referred to above, prevent identification of the marking by the reading device nor derivation of the information as to the identity of the legitimate card bearer, etc. Nevertheless, the reader and, more particularly, the associated data processing means, is arranged inter aha to execute predetermined algorithms to determine whether the effect of the signature on the signature stripe it has read is an effect attributable to the signature of the legitimate card bearer or is an effect indicative of some other marking, such as a forged signature applied to the signature strip. The reading device makes this determination by reference to data already held, e.g. at the central computing and database facility, relating to the signature of the legitimate card bearer, (for example derived from analysis of several sample signatures of the legitimate card bearer, applied to signature areas of base documents, bearing corresponding two-dimensional coded markings. The reading device may, in effect, subtract, from the pre-applied coded marking, the effects of a legitimate card bearer's signature and determine whether the result is consistent with the original, virgin, coded signature stripe. This procedure, assisted by the high statistical information density of the “Microbar” marking and the complexity of the statistical data in such marking, should actually prove simpler and more reliable than known automated signature recognition procedures. This increased simplicity and reliability may be attributable to a species of what is termed mathematically as “stochastic resonance”.

Thus, in preferred embodiments of the invention, not only is it possible for a credit card or debit card, for example, to carry in unobtrusively encrypted form not readily reproducible by a counterfeiter, but readily readable by the appropriate reading device, information identifying the legitimate user of the card, such as his account number, but it is possible for the reading device to verify the authenticity of the signature on the card.

In another embodiment of the invention, there is provided a credit or debit card or the like in which an image of the card bearer's signature is printed on the card by the bank or other issuing institution, being for example an image of a sample signature provided by the bearer to the bank when the relevant account was opened. The surface of the card bearing such image may, for example, be covered by a transparent resin layer, making undetected interference with the image virtually impossible. In this case the “Microbar” coding on the card may also be incorporated in the black markings which form the signature as well as on the surrounding area of the card, so that, for example, the signature on the card can have the same statistical fractal identity as the remainder, and can at any rate form part of the overall coded marking of the card. In general, where a signature is to be checked locally, e.g. at a point of sale, for authenticity, it may be appropriate to ensure that the area where the “test” signature is to be written, e.g. on a touch sensitive panel, should be of the same size and shape as an area to which the original “sample” signature was limited so that the person signing at the point of sale is placed under the same constraints as he was under when supplying the “sample” signature. The automatic signature reader can then be arranged to be sensitive to different effects such constraints may have on different persons so as to be even more likely to detect forgery.

In yet another embodiment, there may be no coded marking in the black lines forming the signature, but the remainder of the panel or area on the card receiving the printed signature has controlled fractal noise added in such a way that, whatever the signature, the signature panel, as a whole, of any card of the same type, has the same fractal statistics, and as a result, an automatic a card reader can check for authenticity simply by checking that the fractal statistics of the signature panel as a whole correspond to a predetermined set of such statistics. Many variations on this theme are possible. Thus, for example, the signature panel on the card may be sub-divided, notionally, into sub-panels, (the sub-panels would not necessarily be visible), with thefractal noise in the non-black portions of each sub-panel being adjusted to ensure that each sub-panel has the same fractal statistics, or has fractal statistics which are pre-determined for that sub-panel position.

### ANNEX

Introduction

We are all accustomed to the use of bar coding which was first introduced in the late 1960s in California and has grown to dominate commercial transactions of all types and sizes. Microbar™ is a natural extension of the idea but with some important and commercially viable subtleties that are based on the application of fractal geometry and chaos.

The origins of Microbar™ go back to the mid 1990s and like all good ideas, were based on asking the right questions at the right time: Instead of using 1D bar codes why not try 2D dot codes? One of the reasons for considering this simple extension was due to the dramatic increase in the number of products that required bar code tagging. Another, more important reason, concerned the significant increase in counterfeit products.

Bar Codes

Product numbering or bar coding in the UK is the responsibility of thee-centre UK who issue unique bar codes for different products. The e-centre UK was a founder member of the European Article Numbering (EAN)Association, which is now known as EAN International. The EAN system was developed in 1976, following on from the success of an American system which was adopted as an industry standard in 1973. EAN tags are unique and unambiguous, and can identify any item anywhere in the world. These numbers are represented by bar codes which can be read by scanners throughout the supply chain, providing accurate information for improved management. As the number of products increases, so the number of bits required to represent a product uniquely must increase. The EAN system has recently introduced a new 128 bit bar-code (the EAN-128) to provide greater information on a larger diversity of products. They are used on traded units; retail outlets use a EAN-18 bar code.

Microbar's Origins

Compared with a conventional bar code, a Microbar serves two purposes: (i) converting from a 1D bar code to a 2D dot code provides the potential for greater information density; (ii) this information can be embedded into the product more compactly making it more difficult to copy.

In the early stages of Microbar's development, it was clear that a conventional laser scanning system would have to be replaced by a specialist reader—instead of scanning a conventional bar code with a “pencil line” laser beam, an image reader/decoder (hand-held or otherwise) would need to be used. The original idea evolved from the laser speckle coding techniques used to authenticate the components of nuclear weapons. It was developed by Professor Nick Phillips (Director of the Centre for Modern Optics at De Montfort University) and by Dr William Johnson (Chief Executive of Durand Technology Limited) and focused on the anti-counterfeiting market. It was based on a 2D dot code formed from a matrix of micro-reflectors. When exposed to laser light, a CCD camera records the scattered intensity from which the pattern is recovered (via suitable optics and appropriate digital image processing). The micro-reflectors (which look-like white dots in a black background) are embedded into a tiny micro-foil which is then attached to the product as a micro-label. The pattern of dots is generated by implementing a pseudo random number generator and binarizing the output to give a so called stochastic mask. This mask is then burnt into a suitable photopolymer. (Its a bit like looking at “cats eyes” on the road when driving in the dark, except that instead of being placed at regular intervals along the centre of the road, they are randomly distributed all over it.) The “seed” used to initiate the random number generator and the binarization threshold represent the “keys” used for identifying the product. If the stochastic mask for a given product correlates with the template used in the identification processes, then the product is passed as being genuine.

As always, good ideas suffer from technical, bureaucratic and capital investment problems (especially in the UK). In this case the main problem has been the high cost of introducing an optical Microbar into security documents and labels and the specialist optical readers/decoders required to detect and verify the codes. An additional problem is that counterfeiters are not stupid! Indeed, some of the best ideas for anti-counterfeiting technology along with methods of encryption, computer virus algorithms, hacking, cracking and so on are products of the counterfeit/criminal mind whose ideas often transcend those of an established authority. Whatever is put onto a label or at least, is seen to be on it, can in principle be copied (if enough effort is invested). For example, the holograms that are commonly used on debit and credit cards, software licensing agreements and on the new twenty pound note are relatively easy targets for counterfeiters. Furthermore, contrary to public opinion, such holograms convey no information whatsoever about the authentication of the product. As long as it looks right, its all right. Thus, although the optical Microbar could in principle provide a large amount of information pertinent to a given product, it was still copyable. What was required was a covert equivalent.

In Comes Russia

In 1996, De Montfort University won a prestigious grant from the Defence Evaluation and Research Agency at Malvern (formerly the royal Signals and Radar Establishment) to investigate novel methods of encryption and covert technology for digital communication systems (including radio, microwave and ATM networks). The aim was to develop a new digital Enigma-type machine based on the applications of fractals and chaos. This grant was (and is) unique in that it was awarded on the basis of employing a number of Research Assistants (mathematicians, computer scientists and engineers) from the Moscow State Technical University (MSTU). Since the end of the cold war, De Montfort University has had a long standing Memorandum of Agreement with MSTU—a university whose graduates include some of the great names in Russian science and engineering, including the aerodynamicist Tupolev and the inventor of Russian Radar and the current Vice Chancellor, Professor Federov. As expressed at the time by all concerned, if we had previously suggested that one day, young Russian scientists wkould be employed in the UK, financed by HMS government working on state of the art military communications systems, than off to hospital we would have gone!

One of the projects was based on using random scaling fractals to code bit streams. The technique, which later came to be known as Fractal Modulation, worked on the same principles as Frequency Modulation; instead of transmitting a coded bit stream by modulating the frequency of a sine wave generator, the fractal dimension of a fractal noise generator is modulated. In addition to spread spectrum and direct sequencing, Fractal Modulation provides a further covert method of transmission with the aim of making the transmitted signal “look like” background noise. Not only does the enemy not know what is being said (as a result of bit stream coding) but is not sure whether a transmission is taking place. As the project developed, it was realised that if a 2D bit map was considered instead of a 1D bit stream, then an image could be created which “looked like” noise but actually had information embedded in it. The idea evolved of introducing a technique that has a synergy with the conventional electronic water mark (commonly used in the transmission of digital images) and fractal camouflage but is more closely related to a Microbar where a random bit map is converted into a map of fractal noise. Thus, the Microbar evolved from being a stochastic mask composed of micro-reflectors implemented using laser optics to a “stochastic agent” used to encode information in a covert way using digital technology. That was the idea. Getting it to work using conventional printing and scanning technology has taken time but was done in the knowledge that specialist optical devices and substrate's would not be required and that a working system could be based on existing digital printer/reader technology as used by all the major security document printing companies.

Why Does It Work?

The digital Microbar system is a type of Steganography in which secret codes are introduced into an image without appearing to change it. For example, suppose you send an innocent memorandum discussing the weather or something, which you know will be intercepted. A simple code can be introduced by putting pin holes through appropriate letters in the text. Taking these letters from the text in a natural or pre-arranged order will allow the recipient of the document to obtain a coded message (providing of course, the interceptor does not see the pin holes and wonder why they are there!). Microbar technology uses a similar idea but makes the pin holes vanish (well sort of), using a method that is based on the use of self-affine stochastic fields.

Suppose you are shown two grey level images of totally different objects (a face and a house for example) but whose distribution in grey levels is exactly the same. If you were asked the question, are the images the same? then your answer will be “no”. If you were asked whether the images are statistically the same, your answer might be “I don't know” or “in what sense?” When we look at an image, our brain attempts to interpret it in terms of a set of geometric correlations with a library of known templates (developed from birth), in particular, information on the edges or boundaries of features which are familiar to us. It is easy to confuse this form of neural image processing by looking at pictures of objects that do not conform to our perception of the world—the Devil's triangle or Escher's famous lithograph “ascending and descending” for example. Thus, our visual sense is based (or has developed) on correlations that conform to a Euclidean perspective of the world. Imagine that our brain interpreted images through their statistics alone. In this case, if you were given the two images discussed above and asked the same question, you would answer “yes”. Suppose then that we construct two images of the same object but modify the distribution of grey levels of one of them in such a way that our (geometric) interpretation of the images is the same. Further, add colour into the “equation” in which the red, green and blue components can all have different statistics and it is clear that we can find many ways of confusing the human visual system because it is based on a Euclidean geometric paradigm with colour continuity. Moreover, construct an image which has all these properties but in addition, is statistically self-affine so that as we zoom into the image, the distribution of its RGB components are the same. Without going into the details of the encryption and decoding processes (which remain closed anyway), these are some of the basic principles upon which the current Microbar system works. In short, a Microbar introduces a stochastic agent into a digital image (encryption) which has three main effects: (i) it changes the statistics of the image without changing the image itself (covert); (ii) these statistics can be confirmed (or otherwise) at arbitrary scales (fractals); (iii) any copy made of the image introduces different statistics since no copy can be a perfect replica (anti-counterfeiting). Point (iii) is the reason why the Microbar can detect copies. Point (ii) is the reason why detection does not have to be done by a high resolution (slow) reader and point (i) is why it can't be seen. There is one further and important variation on a theme. By embedding a number of Microbar's into a printed document at different(random) locations, it is possible to produce an invisible code (similar to the “pin holes” idea discussed at the start of this Section). This code (i.e. the Microbars” coordinates) can be generated using a standard or preferably non-standard encryption algorithm whose key(s) are related via another encryption algorithm to the serial number(s) of the document or bar code(s). In the case of non-standard encryption algorithms, chaotic random number generation is used instead of conventional pseudo random number generation. For each aspect of the Microbar “secrets” discussed above, there are many refinements and adjustments required to get the idea to work in practice which depend on the interplay between the digital printer technology available, reader specifications, cost and encryption hierarchy (related to the value of the document to be encrypted).

Current State of Play

Introducing stochastic agents into printed or electronically communicated information has a huge number of applications. The commercial potential of Microbar™ was realised early on. As a result, a number of international patents have been established and a new company “Microbar Security Limited” setup in partnership with “Debden Security Printing”—the commercial arm of the Bank of England, where a new cryptography office has been established and where the “keys” associated with the whole process for each document can be kept physically and electronically secure. In June this year, Microbar was demonstrated for the first time publicly at the “First World Product and Image Security Convention” held in Barcelona. The demonstration was based on a Microbar encryption of a bank bond and a COTS (Commercial Of The Shelf) system developed to detect and decode the Microbar. The unveiling of this demonstration prototype has led to a number of contracts with leading security printing company's in the UK, USA, Germany, Russia and the Far East. One of the reasons for starting at the top (i.e. with very high value documents—bank bonds) was due to the fact that a major contribution to the decline of the Russian economy last year related to a rapid increase in the exchange of counterfeit Russian bank bonds. The IMF requested that the Federal Bank of Russia reduce the quantity of Rubles being printed in late 1997, a request which was agreed to, but traded-off by an increase in the production of bank bonds (this will not happen again with Microbar™).

The Future

The use of Microbar™ in the continuing battle against forgery will be of primary importance over the next few years. With the increased use of anti-counterfeit features for currency, Microbar represents a general purpose technology which can and should be used in addition to other techniques that include the use of fluorescent inks, foil holograms, optical, infrared and thermal watermarks, phase screens, enhanced paper/print quality, micro printing and so on. However, one of the most exiting prospects for the future is in its application to Smartcard technology and e-commerce security. As an added bonus, the theoretical models used to generate and process Microbar encrypted data are being adapted to analyse financial data and to develop a new and robust macro-economic volatility prediction metric. Thus, in the future, Microbar™ may not only be used to authenticate money but to help money keep its value!

Finally, self-affine data analysis is currently being applied to medicine. Early trials have shown that epidemiological time series data is statistically self-affine, irrespective of the type of disease. This may lead to new relationships between the study of health in terms of cause and effect. This approach—called Medisine™ —will be of significant value in the analysis of health case and government expenditure in the next millenium.

### SECTION 3

Data Encryption and Modulation Using Fractals and Chaos

This invention relates to encryption and to data carriers, communication systems, document verification systems and the like embodying a novel and improved encryption method.

Encryption methods are known in which encrypted data takes the form of a pseudo-random number sequence generated in accordance with a predetermined algorithm operating upon a seed value and the data to be encrypted.

In accordance with the present invention, however, by a replacement of a standard algorithm that generates the encryption field (R₁, R₂, . . . R_{N}) with a chaotic algorithm, a greater level of security can be developed. In preferred embodiments of the invention, in addition, by using different classes of chaoticity at different times the level of security can be increased through what is in effect the introduction of non-stationary chaoticity. The nature of the invention in its preferred embodiments will be apparent from the research which forms the Annexe which constitutes the latter part of the present application.

The essence of the chaotic encryption technique is illustrated in Section 10.5(page x1-x2) of the Annexe which shows the principle of random chaotic number encryption, fractal modulation and there the demodulation plus de-encryption. The vitally important point here is embedded in the innocent little phrase on page x: “A sequence of pseudo-random or chaotic integers (R₀, R₁, . . . R_{N},) . . . ”. Conventional encryption software is based exclusively on the use pseudo-random number generators for which there is a “standard algorithm”. This standardisation is one of the principal reasons why there is an increase in hacking. By a simple replacement of a standard algorithm that generates the encryption field (R₁, R₂, . . . R_{N},) with a chaotic algorithm, a greater level of security can be developed. In addition, by using different classes of chaoticity at different times, the level of security can be increased through what is in effect the introduction of non-stationary chaoticity. This approach uses a chaotic data field R₁ and not a pseudo-random number field. Since there is in principle an unlimited class of chaotic random number generating algorithms this introduces the idea of designing a symmetric encryption system in which the key is a user defined algorithm (together with associated parameters) and an asymmetric system in which the public key is one of a wide range of algorithms operating for a limited period of time and distributed to all users during such a period. In the latter case, the private key is a number that is used to “drive” the algorithm via one or more of the parameters available.

This approach involves changes to aspects of conventional encryption systems in which the “hard-wired” components, common to most commercial systems, are changed. All interfaces, data structures, etc. can remain the same in such a way that the user would not notice any difference. This aspect is in itself important as it would not flag to users of such a system that any fundamental changes have taken place, thus increasing the level of security associated with the introduction of chaos based encryption.

### ANNEX

Data Encryption and Modulation Using Fractals and Chaos

Many techniques of coding and cryptography have been developed for protecting the confidentiality of the transmission of information over different media, including telephone lines, mobile radio, satellites and the Internet. In each technique, the purpose of the coding and encryption processes is to improve the reliability, privacy and integrity of the transmitted information. It is imperative that any encryption algorithm is not capable of being “cracked”. In simple terms this means that the possibility of finding out the original plain text from the corresponding cypher text (without knowing the appropriate encryption key) must be so small as to be discounted in practical terms. If this is true for a particular encryption algorithm, then the algorithm is said to be “cryptographically strong”.

With the rapidly growing use of the Internet for business transaction of all types and e-commerce in general, the design and implementation of cryptographically strong algorithms is becoming more and more important. However, a number of recent events have brought the true meaning of the term “cryptographically strong” into question. The increasing ability for hackers to penetrate sensitive communications systems means that a new generation of encryption software is required. This report, discuss an approach which is based on the use of fractals and chaos.

One of the principle problems with conventional encryption software is that the “work horse” is still based on a relatively primitive pseudo random number generator using variations on a theme of the linear congruential method. In this work, we consider the use of iterated sequences that lead to chaos and the generation of chaotic random numbers for bit stream coding. Further, we study the use of random fractals for coding bit streams(coded or otherwise) in terms of variations in fractal dimension (Fractal Modulation) such that the digital signal is characteristic of the background noise associated with the medium through which information is to be transmitted. Thisform of data encryption/modulation is of value in the transmission of sensitive information and represents an alternative and potentiallymore versatile approach to scrambling bit streams which has so far not been implemented in any commercial sector.

This report is in two principal parts; the first part provides a general introduction to cryptography and encryption (Chapters 1-3) and the second part provides background on the random number generators, chaotic processes and fractal signals (Chapters 4-8) used to develop the encryption system discussed in Chapters 9 and 10.

1. Introduction

The need to keep certain messages secret has been appreciated for thousands of years. The advantages gained from intercepting secret information is self-evident, and this has led to a continuous, fascinating battle between the “codemakers”and the “codebreakers”. The arena for this contest is the communications medium which has changed considerably over the years. It was not until the arrival of the telegraph that the art of communications, as we know it today, began. Society is now highly dependent on fast and accurate means of transmitting messages. As well as the long-established forms such as post and courier services, we now have more technical and sophisticated media such as radio, television, telephone, telex, fax, e-mail, videoconferencing and high speed data links. Usually the main aim is merely to transmit a message as quickly and cheaply as possible. However, there are a number of situations where the information is confidential and where an interceptor might be able to benefit immensely from the knowledge gained by monitoring the information circuit. In such situations, the communicants must take steps to conceal and protect the content of their message.

The purpose of this research monograph, is to provide an overview of an encryption technique based on chaotic random number sequences and fractal coding. We discuss a signal processing technique which enables digital signals to be transmitted confidentially and efficiently over a range of digital communications channels.

Transmitted information, whether it be derived from speech, visual images or written text, needs in many circumstances to be protected against eavesdropping. Access to the services provided by network operators to enable telecommunications must be protected so that charges for using the services can be properly levied against those that use them. The telecommunications services themselves must be protected against abuse which may deprive the operator of his revenue or undermine the legitimate prosecution of law enforcement.

The application of random fractal geometry for modelling naturally occurring signals (noise) and visual camouflage is well known. This is due to the fact the statistical and/or spectral characteristics of random fractals are consistent with many objects found in nature; a characteristic which is compounded in the term “statistical self-affinity”. This term refers to random processes which have similar probability density functions at different scales. For example, a random fractal signal is one whose distribution of amplitudes remains the same whatever the scale over which the signal is sampled. Thus, as we zoom into a random fractal signal, although the pattern of amplitude fluctuations will change across the field of view, the distribution of these amplitudes remains the same. Many noises found in nature are statistically self-affine including transmission noise.

Data Encryption and Camouflage using Fractals and Chaos (DECFC) is a technique whereby binary data is converted into sequences of random fractal signals and then combined in such a way that the final signal is indistinguishable from the background noise a system through which information is transmitted.

2. Cryptography

2.1 What is Cryptography?

The word cryptography comes from Greek; kryptos means “hidden” while graphia stands for “writing”. Cryptography is defined as “the science and study of secret writing” and concerns the ways in which communications and data can be encoded to prevent disclosure of their contents through eavesdropping or message interception, using codes, cyphers, and other methods.

Although the science of cryptography is very old, the desktop computer revolution has made it possible for cryptographic techniques to become widely used and accessible to non experts.

The history of cryptography can be traced from Ancient Egypt through to the present day. From Julius Caesar to Abraham Lincoln and the American Civil War, cyphers and cryptography has been a part of history.

During the second world war, the Germans developed the Enigma machine to have secure communications. Enigma codes were decrypted first in Poland in the late 1930s and then under the secret “Ultra Project” based at Bletchly Park in Buckinghamshire (UK) during the early 1940s. This led to a substantial reduction in the level of allied shipping sunk by German U-boats and together the invention of Radar was arguably one of the most important contributions that electronics made to the war effort. In addition, this work contributed significantly to the development of electronic computing after 1945.

Organisations in both the public and private sectors have become increasingly dependent on electronic data processing. Vast amounts of digital data are now gathered and stored in large computer data bases and transmitted between computers and terminal devices linked together in complex communications networks. Without appropriate safeguards, these data are susceptible to interception (e.g. via wiretaps) during transmission, or they may be physically removed or copied while in storage. This could result in unwanted exposures of data and potential invasions of privacy. Data are also susceptible to unauthorised deletion, modification, or addition during transmission or storage. This can result in illicit access to computing resources and services, falsification of personal data or business records, or the conduct of fraudulent transactions, including increases in credit authorisations, modification of funds transfers, and the issue of unauthorised payments.

Legislators, recognizing that the confidentiality and integrity of certain data must be protected, have passed laws to help prevent these problems. But laws alone cannot prevent attacks or eliminate threats to data processing systems. Additional steps must be taken to preserve the secrecy and integrity of computer data. Among the security measures that should be considered is cryptography, which embraces methods for rendering data unintelligible to unauthorised parties.

Cryptography is the only known practical method for protecting information transmitted through communications networks that uses land lines, communications satellites, and microwave facilities. In some instances, it can be the most economical way to protect stored data. Cryptographic procedures can also be used for message authentication, digital signatures and personal identification for authorising electronic funds transfer and credit card transactions.

2.2 Cryptanalysis

The whole point of cryptography is to keep the plaintext (or the key, or both) secret from eavesdroppers (also called adversaries, attackers, interceptors, interlopers, intruders, opponents, or simply the enemy). Eavesdroppers are assumed to have complete access to the communication between the sender and receiver.

Cryptanalysis is the science of recovering the plaintext of a message without access to the key. Successful cryptanalysis may recover the plaintext or the key. It also may find weaknesses in a cryptographic system that eventually leads to recovery of the plaintext or key. (The loss of a key though non-cryptanalytic means is called a compromise.)

An attempted cryptanalysis is called an attack. A fundamental assumption in cryptanalysis (first enunciated by the Dutchman A Kerckhoff) assumes that the cryptanalyst has complete details of the cryptographic algorithm and implementation. While real-world cryptanalysts do not always have such detailed information, it is good assumption to make. If others cannot break an algorithm, even with a knowledge of how it works, then they certainly will not be able to break it without that knowledge.

There a four principal types of cryptanalytic attacks; each of them assumes that the cryptanalyst has complete knowledge of the encryption algorithm used:

Cyphertext-only Attack

The cryptanalyst has the cyphertext of several messages, all of which have been encrypted using the same encryption algorithm. The cryptanalyst's job is to recover the plaintext of as many messages as possible, orto deduce the key (or keys) used to encrypt the messages, in order to decrypt other messages encrypted with the same keys.

Known-plaintext Attack

The cryptanalyst not only has access to the cyphertext of several messages, but also to the plaintext of those messages. The problem is to deduce the key (or keys) used to encrypt the messages or an algorithm to decrypt any new messages encrypted with the same key (or keys).

Chosen-plaintext Attack

The cryptanalyst not only has access to the cyphertext and associated plaintext for several messages, but also chooses the plaintext that gets encrypted. This is more powerful than a known-plaintext attack, because the cryptanalyst can choose specific plaintext blocks to encrypt those that might yield more information about the key. The problem is to deduce the key (or keys) used to encrypt the messages or an algorithm to decrypt any new messages encrypted with the same key (or keys).

Adaptive-chosen-plaintext Attack

This is a special case of a chosen-plaintext attack. Not only can the cryptanalyst choose the plaintext that is encrypted, but can also modify the choice based on the results of previous encryption. In a chosen-plaintext attack, a cryptanalyst might just be able to choose one large block of plaintext to be encrypted; in an adaptive-chosen-plaintext attack it is possible to choose a smaller block of plaintext and then choose another based on the results of the first, and so on.

In addition to the above, there are at least three other types of cryptanalytic attack.

Chosen-cyphertext Attack

The cryptanalyst can choose different cypher-texts to be decrypted and has access to the decrypted plaintext. For example, the cryptanalyst has access to a tamperproof box that does automatic decryption. The problem is to deduce the key. This attack is primarily applicable to public-key algorithms. A chosen-cyphertext attack is sometimes effective against a symmetric algorithm as well. (A chosen-plaintext attack and a chosen-cyphertext attack are together known as a chosen-text attack).

Chosen-key Attack

This attack does not mean that the cryptanalyst can choose the key; it means that there is some knowledge about the relationship between different keys—it is a rather obscure attack and not very practical.

Rubber-hose Cryptanalysis

The cryptanalyst threatens someone until the key is provided. Bribery is sometimes referred to as a purchase-key attack. This is a critical but very powerful attacks and is often the best way to break an algorithm.

2.3 Basic Cypher Systems

Before the development of digital computers, cryptography consisted of character-based algorithms. Different cryptographic algorithms either substituted characters for one another or transposed characters with one another. The better algorithms did both, many times each.

Although the technology for developing cypher systems is more complex now, the underlying philosophy remains the same. The primary change is that algorithms work on bits instead of characters. This is actually just a change in the alphabet size from 26 elements to 2 elements. Most good cryptographic algorithms still combine elements of substitution and transposition. In this section, an overview of cypher systems is given.

2.3.1 Substitution Cyphers (Including Codes)

As their name suggests, these preserve the order of the plaintext symbols, but disguise them. Each letter or group of letters is replaced by another letter or group to disguise it. In its simplest form, a becomes D, b becomes E, c becomes F etc.

More complex substitutions can be devised, e.g. a random (or key controlled) mapping of one letter to another. This general system is called a monoalphabetic substitution. They are relatively easy to decode if the statistical properties of natural languages are used. For example, in English, e is the most common letter followed by t, then a etc.

The cryptanalyst would count the relative occurrences of the letter in the cyphertext, or look for a word that would be expected in the message. To make the encryption more secure, a polyalphabetic cypher may be used, in which a matrix of alphabets is employed to smooth out the frequencies of the cyphertext letters.

It is in fact possible to construct an unbreakable cypher if the key is longer than the plaintext, although this method, known as a “one time key” has practical disadvantages.

2.3.2 Transposition Cyphers

A common example, the “column transposition cypher” is shown in Table 2.1. Here the Plaintext is: “This is an example of a simple transposition cypher”. The Cyphertext is:

“almniefheolpnatnepsorimsripdspiathesaatsicixfeocb”

TABLE 2.1
Example of Transposition Cypher

| K | E | Y | W | 0 | R | D |
|---|---|---|---|---|---|---|
| 3 | 2 | 7 | 6 | 4 | 5 | 1 |
| t | h | i | s | i | s | a |
| n | e | x | a | m | p | l |
| e | o | f | a | s | i | m |
| p | l | e | t | r | a | n |
| s | p | o | S | i | t | i |
| o | n | c | i | p | h | e |
| r | a | b | c | d | e | f |

The plaintext is ordered in rows under the key which numbers the columns so formed. Column 1 in the example is under the key letter closest to the start of the alphabet. The cyphertext is then read out by columns, starting with the column whose number is the lowest.

To break such a cypher, the cryptanalyst must guess the length of the keyword, and order of the columns.

2.4 Standardised Computer Cryptography

At present, there are two serious candidates for standardised computer cryptography. The first, which is chiefly represented by the so-called RSA cypher developed a MIT, is a “public key” system which, by its structure, is ideally suited to a society based upon electronic mail. However, in practice it is slow without special-purpose chips which, although under development, do not yet show signs of mass marketing. The second approach is the American Data Encryption Standard (DES) developed at IBM, which features in an increasing number of hardware products that are fast but expensive and not widely available. The DES is also available in software, but it tends to be rather slow, and expected improvements to the algorithm will only make it slower. Neither algorithm is yet suitable for mass communications, and even then, there is always the problem that widespread or constant use of any encryption algorithm increases the likelihood that an opponent will be able to attack it through analysis. Cyphers or individual keys for cyphers for general applications are best used selectively, and this acts against the idea of using cryptographics to guarantee privacy in mass communications.

The DES and the RSA cyphers represent a sort of branching in the approach tocryptology. Both proceed from the premise that all practical cyphers suitable for mass-market communications are ultimately breakable, but that security can rest in making the scale of work necessary to do it beyond all realistic possibilities. The DES is the resultof work on improving conventional cryptographic algorithms, and as such lies directly in an historical tradition. The RSA cypher, on the other hand, results more from a return to first mathematical principles, and in this sense matches DESs hard-line practicality with established theoretical principles.

2.5 The Strength of Security Systems

In the 1940s, Shannon conducted work in this area, leading to a theory of secrecy systems. His work assumed an attack based on cyphertext only (i.e. no known plaintext). He identified two basic classes of the encryption problem.

2.5.1 Unconditionally Secure

In this case, the cyphertext cannot be cracked even with unlimited computing power. This can only be achieved in practice if a totally random key is used of length equal to or greater than the equivalent plaintext, i.e. the key is never repeated. This infers that all de cypherment values are equally probable.

2.5.2 Computationally Secure

In this case, cryptanalysis is theoretically possible, but impractical due to the enormous amount of computer power required. Modem encryption systems are of this type.

Shannon's Security Theories were developed from his work on information theory. The analysis of a noisy communications channel is analogous to that of security via data encryption. The noise can be likened to the encyphering operation.

In information theory, a message M is transmitted over a noisy channel to a receiver. The message becomes corrupted forming M′. The receiver problem is then to reconstruct M from M′. In an encryption system, M corresponds to the plaintext and M′ to the cyphertext. This approach is central to the techniques developed in this report in which the noise is modelled using Random Scaling Fractal Signals.

2.5.3 Perfect Secrecy

The information theoretic properties of cryptographic systems can be decomposed into three classes of information.

(i) Plaintext messages M occurring with prior probabilities P(M) where

$${\sum }_{M} P ( M ) = 1$$

(ii) Cyphertext messages C occurring with probabilities P(C) where

$${\sum }_{C} P ( C ) = 1$$

Keys K chosen with prior probabilities P(K) where

$${\sum }_{K} P ( K ) = 1$$

Let P_{C}(M) be the probability that message M was sent, given that C was received (thus C is the encryption of message M). Perfect secrecy is defined by the condition

P_{C}(M)=P(M)

that is, intercepting the cyphertext gives a cryptanalyst no additional information.

Let P_{M}(C) be the probability of receiving cyphertext C given that M was sent. Then P(C) is the sum of the probabilities P(K) of the keys K that encypher M as C, i.e.

$${P}_{M} ( C ) = {\sum }_{K} P ( K ) = 1$$

Usually there is at most one key K such that the cyphertext is equal to the encryption of M and the key K for given M and C. However, some cyphers can transform the same plaintext into the same cyphertext under different keys.

A necessary and sufficient condition for perfect secrecy is that for every C,

P_{M}(C)=P(C)∀M

This means that the probability of receiving a particular cyphertext C given that M was sent (encyphered under some key) is the same as the probability of receiving C given that some other message M′ was sent (encyphered under a different key).

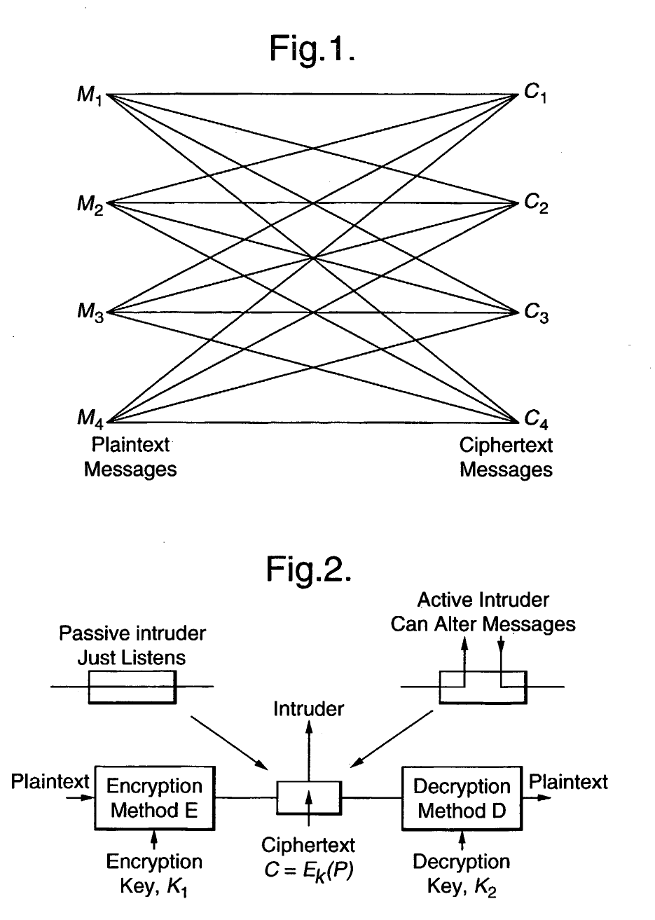

Perfect secrecy is possible using completely random keys at least as long as the messages they encypher. FIG. 1 illustrates a perfect system with four messages, all equally likely, and four keys, also equally likely. Here P_{C}(M)=P(M)=¼ and P_{M}(C)=P(C)=¼ for all M and C. A cryptanalyst intercepting one of the cyphertext messages C₁, C₂, C₃, or C₄ would have no way of determining which of the four keys was used and, therefore, whether the correct message is M₁, M₂, M₃, or M₄.

Perfect secrecy requires that the number of keys must be at least as great as the number of possible messages. Otherwise there would be some message M such that for a given C, no K decyphers C into M, implying that P_{C}=0. The cryptanalyst could thereby eliminate certain possible plaintext messages from consideration, increasing the chances of breaking the cypher.

2.6 Terminology

It is necessary at this point to define some terminology which is used later in this work and through the field of Cryptography. The following list provides the principal terms associated with cryptography and cryptanalysis.

Cypher: A method of secret writing such that an algorithm is used to disguise a message. This is not a code.

Cyphertext: The message after first modification by a cryptographic process.

Code: A cryptographic process in which a message is disguised by converting it to cyphertext by means of a translation table (or vice-versa).

Cryptanalyst: The process by which an unauthorised user attempts to obtain the original message from its cyphertext without full knowledge of the encryption systems.

Cryptology: Includes all aspects of cryptography and cryptanalysis.

Decypherment or Decryption: The intended process by which cyphertext is transformed to the original message or plaintext.

Encypherment or Decryption: The process by which plaintext is converted into cyphertext.

Key: A variable (or string) used to control the encryption or process.

Plaintext: An original message or data before encryption.

Private Key: A key value which is kept secret to one user.

Public Key: A key which is issued to multiple users.

Session Key: A key which is used only for a limited time.

Stenanography: The study of secret communication.

Trapdoor: A feature of a cypher which enables it to be easily broken without the key, but by possessing other knowledge hidden from other users.

Weak Key: A particular value of a key which under certain circumstances, enables a cypher to be broken.

Authentication: A mechanism for identifying that a message is genuine, or of identifying an individual user.

Bijection: A one-to-one mapping of elements of a set {A } to set {B} such that each A maps to a unique B, and each B maps to a unique A.

Exhaustive Search: Finding a key by checking each possible value.

Permutation: Changing the order of a set of data elements.

2.7 Possible Uses

Encryption is one of the basic elements of many aspects of computer security. It can underpin many other techniques, by making possible a required separation between sets of data. Some of the more common uses of encryption are outlined below, in alphabetical order rather than in any order of importance.

Audit Trail

An audit trail is a file containing a date and time stamped record of PC usage. When produced by a security product, an audit trail is often known as a security journal. An audit trail itemises what the PC was used for, allowing a security manager (controller) to monitor the user's actions.

An audit trail should always be stored in encrypted form, and be accessible only to authorised personnel.

Authentication

This is a mathematical process used to verify the correctness of data. In the case of a message, authentication is used to verify that the message has arrived exactly as it was sent, and that it was sent by the person who claims to have sent it. The process of authentication requires the application of a cryptographically strong encryption algorithm, to the data being authenticated.

Cryptographic Checksum

Cryptographic checksums use an encryption algorithm and an encryption key to calculate a checksum for a specified data set.

Where financial messages are concerned, a cryptographic checksum is often known as a “Message Authentication Code”.

Digital Signature

Digital signatures are checksums that depend on the content of a transmitted message, and also on a secret key, which can be checked without knowledge of that secret key (usually by using a public key).

A digital signature can only have originated from the owner of the secret key corresponding to the public key used to verify the digital signature.

On-the-fly Encryption

Also known as background encryption or auto-encryption, on-the-fly encryption means that data is encrypted immediately before it is written to disk, and encrypted after it has been read back from disk. On-the-fly encryption usually takes place transparently.

The above list should not be thought of as exhaustive. It does, however, illustrate that encryption techniques are fundamental in most areas of data security, as they can provide a barrier around any desired data.

Given a cryptographically strong encryption algorithm, this barrier can only be breached by possession of the correct encryption key. In short, the success or failure of encryption techniques depends crucially on the successful application of a key management system.

3 Encryption

3.1 Introduction

Encryption is the process of disguising information by creating cyphertext which cannot be understood by an unauthorised person. Decryption is the process of transforming cyphertext back into plaintext which can be read by anyone. Encryption is by no means new. Throughout history, from ancient times to the present day, man has used encryption techniques to prevent messages from being read by unauthorised persons. Such methods have until recent years been a monopoly of the military, but the advent of digital computers has brought encryption techniques into use by various civilian organisations.

Computers carry out encryption by applying an algorithm to each block ofdata that is to be encrypted. An algorithm is simply a set of rules which defines a method of performing a given task. Encryption algorithms would not be much use if they always gave the same cyphertext output for a particular plaintext input. To ensure that this does not happen, every encryption algorithm requires an encryption key. The algorithm uses the encryption key, which is changed at will, as part of the process of encryption. The basic size of each data block that is to be encrypted, and the size of the encryption key has to be precisely specified by every encryption algorithm.

The whole point of designing an encryption algorithm is to make sure that it cannot be “cracked”. In simple terms, this means that the possibility of finding out the original plaintext from the corresponding cyphertext, without knowing the appropriate encryption key, must be so small as to be discounted in practical terms. If this is true for a particular encryption algorithm, then the algorithm is said to be “cryptographically strong”. Encryption can be used very effectively in protecting data stored on disk, or data transmitted between two PCs, from unauthorised access. Encryption is not a cure-all; it should be applied selectively to information which really does need protecting. After all, the owner of a safe does not keep every single document in the safe; it would soon become full and therefore useless. The penalty paid for overuse of encryption techniques is that throughput and response times are severely affected.

Since the late 1970s, the mathematics of encryption has developed along two very distinct paths. This followed the invention of public key cryptography, which enabled encryption algorithms where the keys were said to be asymmetric, i.e. the encryption key and the decryption key were no longer required to be the same. This is discussed later.

3.1.1 Encryption Notation

The basic operation of an encryption system is to modify some plaintext (referred to as P) to form some cyphertext (referred to as C) under the control of a key K. The encryption operation is often represented by the symbol E so that we can write

C=E_{K}(P)

i.e. Cyphertext=Encryption of P under key K.

The decryption operation, D should restore the plaintext. We can write

P=D_{K}(C)

A general model for a cryptographic system may now be drawn as illustrated in FIG. 2.

This model also shows the communication of the cyphertext from transmitter (encryption) to receiver (decryption) and the possible actions of an intruder or cryptanalyst. The intruder may be passive, and simply record the cyphertext being transmitted or active. In this latter case, the cyphertext may be changed as it is transmitted, or new cyphertext inserted.

3.1.2 Symmetric Algorithms

By definition, a symmetric encryption algorithm is one where the same encryption key is required for encryption and decryption. This definition covers most encryption algorithms used through history until the advent of public key cryptography. When a symmetric algorithm is applied, if decryption is carried out using an incorrect encryption key, then the result is usually meaningless.

The rules which define a symmetric algorithm contain a definition of what sort of encryption key is required, and what size of data block is encrypted for each execution of the encryption algorithm. For example, in the case of the DES encryption algorithm, the encryption key is always 56 bits, and each data block is 64 bits long.

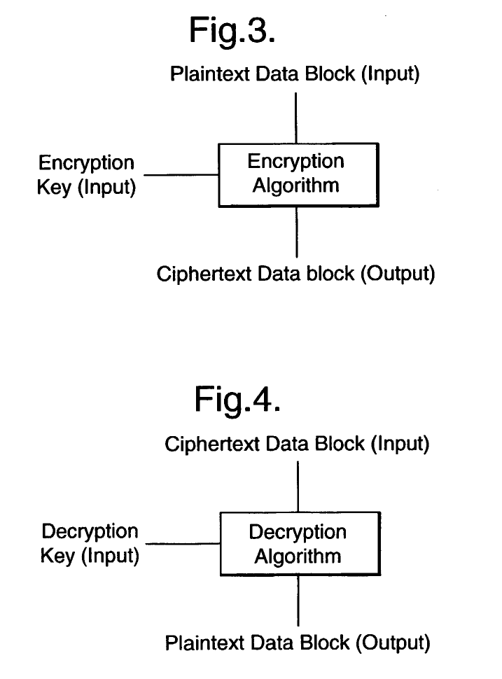

Symmetric encryption (FIG. 3) takes an encryption key and a plaintext datablock, and applies the encryption algorithm to these to produce a cyphertext block.

Symmetric decryption (FIG. 4) takes a cyphertext block, and the key used for encryption, and applies the inverse of the encryption algorithm to recreate the original plaintext data block.

3.1.3 Asymmetric Algorithms

An asymmetric encryption algorithm requires a pair of keys, one for encryption and one for decryption. The encryption key is published, and is freely available for anyone to use. The decryption key is kept secret. This means that anyone can use the encryption key to perform encryption, but decryption can only be performed by the holder of the decryption key. Note that the encryption key really can be “published” in the true sense of the word, there is no need to keep the value of the encryption key secret. This is the origin of the phrase “public key cryptography” for this type of encryption system; the key used to perform encryption really is a “public” key.

One clear advantage of an asymmetric encryption algorithm over a conventional symmetric encryption algorithm is that when asymmetric encryption is used to protect information transmitted between two sites, the same key does not need to be present at both sites. This presents a clear advantage when key management is being considered. Asymmetric encryption takes an encryption key and a plaintext datablock, and applies the encryption algorithm to these to produce a cyphertext block. Asymmetric decryption takes a cyphertext block, and the key used for decryption, and applies the decryption algorithm to these two to recreate the original plaintext data block.

3.1.4 Choice of Algorithm

When the decision to use encryption for some purpose has been taken, the choice of which particular encryption algorithm to use must then be made. Unless one has a technical knowledge of cryptography, and access to technical details of the encryption algorithm in question, one golden rule applies: if at all possible stick to published, well tested, encryption algorithms. This is not to say that unpublished encryptionalgorithms are cryptographically weak, only that without access to published details of how an encryption algorithm works, it is very difficult for anyone other than the original designer(s) of the algorithm to have any idea of its strength.

A major problem with encryption systems is that with two exceptions (see below), manufacturers tend to keep the encryption algorithm a heavily guarded secret. As a purchaser, how does one know whether the encryption algorithm is any good? In general, it is not possible to establish the quality of an algorithm and the purchaser is therefore forced to take a gamble and trust the manufacturer. No manufacturer is ever going to admit that their product uses an encryption algorithm that is inferior; such information is only ever obtained by those specifically investigating the algorithm/product for weaknesses.

One argument that is in favour of secret encryption algorithms is that the very secrecy of the algorithms adds to the “security” offered by it. Although this may be true, and is put forward almost universally by government users of encryption, such advantages are usually ephemeral. Government users have the resources to ensure that an encryption algorithm is thoroughly studied, and can insist upon being provided with details of how the encryption algorithm works (in confidence). They do not suffer from using poor encryption algorithms which hide their weaknesses behind a veil of secrecy, as they make sure that their encryption algorithms are unpublished, but extensively studied. For commercial usage, the best test of an algorithms strength is probably the fact that details of the encryption algorithm have been published, extensively scrutinised by mathematicians and cryptographers, and no compromising attacks have been published as a result.

All unpublished proprietary algorithms are weak to a greater or lesser degree. The important question is, how weak? Unless there is access to technical cryptographic competence, and a helpful supplier of encryption products, the only real solution is to use an algorithm for which all the relevant details have been published. There are possibly only two encryption algorithms for which this has been done that remained cryptographically strong after publication and the consequent intense security. These are the asymmetric RSA public key algorithm, and the symmetric DES algorithm. RSA is primarily used for key management whilst the DES algorithm is routinely used in the financial world.

If a proprietary encryption algorithm is used which is offered by many manufacturers, then the user is at the mercy of the designer of the algorithm. No matter what the specifications, there is no sample way to prove that an encryption algorithm is cryptographically strong. The converse, however, is not true. Any design fault in an encryption algorithm can reduce the algorithm to the point at which it is trivial to compromise. In general, it is not possible to establish whether an unpublished encryption algorithm is cryptographically strong, but it may be possible to establish (the hard way) that it is terminally weak! Unpublished proprietary encryption algorithms are often used as a means of speed the encryption process whilst still appearing to remain secure. If the details of all unpublished encryption algorithms were available publicly, it would probably reveal a whole spectrum of algorithm strength—from the sublime to the ridiculous. Without such details much has to be taken on trust.

3.2 Encryption Keys: Private and Public

Complex cyphers use a secret key to control a long sequence of complicated situations and transpositions. Substitution cyphers replace the actual bits, characters, or blocks of characters with substitutes e.g. one letter replaces another letter. Julius Caesar's military use of such a cypher was the first clearly documented case. In Caesar's cypher each letter of an original message is replaced with the letter three places beyond it in the alphabet. Transposition cyphers rearrange the order of the bits, characters, or blocks of characters that are being encrypted and decrypted. There are two general categories of cryptographic keys: Private key and Public key systems.

Private key systems use a single key. The single key is used both to encrypt and decrypt the information. Both sides of the transmission need a separate key and the key must be kept secret. The security of the transmission will depend on how well the key is protected. The US Government developed the Data Encryption Standard (DES) which operates on this basis and it is the actual US standard. DES keys are 56 bits long and this means that there are 72 quadrillion different possible keys. The length of the key has been criticised and it has been suggested that the DES key was designed to be long enough to frustrate corporate eavesdroppers, but short enough to be broken by the National Security Agency.

Export of DES is controlled by the US State Department. The DES system is becoming insecure because of its key length. The US government has offered to replace the DES with a new algorithm called Skipjack which involves escorted encryption. The technology is based on a tamper-resistant hardware chip (the Clipper Chip) that implements an NSA designed encryption algorithm called Skipjack, together with a method that allows all communications encrypted with the chip (regardless of what session key is used or how it is selected) to be decrypted through a special chip, unique key and a special Law Enforcement Access Field transmitted with the encrypted communications.

In the public key system, there are two keys: a public and a private key. Each user has both keys, and while the private key must be kept secret, the public key is publicly known. Both keys are mathematically related. If A encrypts a message with a private key, then B the recipient of the message, can decrypt it with A's public key. Similarly, anyone who knows A's public key can send a message by encrypting it with the public key. A will then decrypt it with the private key. Public key cryptography was developed in 1977 by Rivest, Shamir and Adleman (RSA) in the US. This kind of cryptography is more efficient than the private key cryptography because each user has only one key to encrypt and decrypt all the messages that are received. Pretty Good Privacy (PGP), an encryption software for electronic communications written by Philip R Zimmerman, is an example of public key cryptography.

3.2.1 Key Generation

An encryption key should be chosen at random from a very large number of possibilities. If the number of possible keys is small, then any potential attacker can simply try all possible encryption keys before stumbling across the correct one. If the choice of encryption key is not random, then the sequence used to choose the key could itself be used to guess which key is in use at any particular time.

The length of the key required is always set by the particular encryption algorithm in use. Thus key generation requires the production of a sequence of random bits of some stated length. This gives rise to a problem. All random number generators that operate entirely in software, with no external influence, are only pseudo random. They are mere sequence generators, but the sequence can of course be of very great length. The only way to generate truly random numbers is to use external hardware, or external stimuli, which go beyond the confines of a strictly software random number generator. The designers of hardware equipment go to great lengths to incorporate random bit generators which use random electrical noise as the source of random bits. However, this is expensive and difficult to design with any degree of reliability. For software encryption packages, the option of special hardware is not available. The best compromise is a long sequence, random number generator, with access to a time of day clock included to add an extra element of randomness.

Ideally, key generation should always be random—which precludes inventing an encryption key, and entering it at the keyboard. Humans are very bad at inventing random sets of characters, because patterns in character sequences make it much easier for them to remember the encryption key. The worst option of all for key generation is to allow keys to be invented by a user as words, phrases or numbers. This should be avoided if at all possible.

If an encryption system of any kind requires the encryption key to be entered by the user, and offers no possibility of using encryption keys which are random, it should not be treated seriously. It is often necessary to have the facility to be able to enter a known encryption key in order to communicate with some other system that provided the encryption key. However, this key should itself be randomly generated.

Key generation should under no circumstances be treated lightly. Key management and the design of cryptographically strong encryption algorithms it is one of the truly vital components of any encryption scheme. In this work, we investigate the use of keys using chaos generators rather than pseudo-random number generators.

3.2.2 Key Management

Once an encryption key has been generated, how it is managed then becomes of paramount importance. Key management comprises choosing, distributing, changing, and synchronizing encryption keys. Key generation can be thought of as similar to choosing the combination for the lock on a safe. Key management is making sure that the combination is not disclosed to any unauthorised person. Encryption offers no protection whatsoever if the relevant key(s) become known to an unauthorised person, and under such circumstances may even induce a false sense of security.

To facilitate secure key management, encryption keys are usually formed intoa key management hierarchy. Encryption keys are distributed only after they have themselves been encrypted by another encryption key, known as a “key encrypting key”, which is only ever used to encrypt other keys for the purposes of transportation or storage. It is never used to encrypt data. At the bottom of a key management hierarchy are data encrypting keys. This is a term used for an encryption key which is only ever used to encrypt data (not other keys). At the top of a key management hierarchy is an encryption key known as the master key. The only constraints on the number of distinct levels involved in a key management hierarchy are practical ones, but it is rare to come across a key management hierarchy with more than three distinct levels.

It should be appreciated that if there was a secure way to transmit a master key from one site to another, without humans being involved in the process, then that method would itself be used for the transmission of encrypted data. The master key would then not be required. Therefore, such a method does not exist, and cannot ever exist. No matter how complex a key management hierarchy is, the master key must always be kept secret by human means. This requires trusted personnel, and manual entry of the master key, which should be split into two or more components to help preserve its integrity. Each component of the master key is known only to one person, and all components must be individually entered before they are recombined to form the complete master key. Such a system cannot be compromised unless all the personnel involved are compromised, as any individual component of the master key is useless by itself.

Once an encryption key has itself been encrypted by a “key encrypting key” from a higher level in the key management hierarchy, then it can be transmitted or stored with impunity. There is no requirement to keep such encrypted keys secret. Keys that have been encrypted in this manner are typically written on to a floppy disk for storage, transmitted across networks, stored on EPROM or EEPROM, or written to magnetic strips cards. A key management hierarchy makes the security of the actual medium used for transmission or storage of encrypted keys completely irrelevant. There is no point in setting up an encryption system, and then executing the key management in a sloppy insecure way. Doing nothing is preferable.

3.3 Super Encypherment

The encypherment process used during key management can be strengthened by using triple encypherment. Two encryption keys are required for this process, which has the same effect, in cryptographic strength terms, as using a double length encryption key, each single encypherment is replaced by the following process: (i) encypher with key #1; (ii) decypher with key #2; (iii) encypher with key #1. Decryption is similarly achieved using: (i) decypher with key #1; (ii) encypher with key #2; decypher with key #1.

Other more complicated methods of super encypherment are possible; all of them involve increasing the number of calls to the basic encryption algorithm. The time required for an encryption is linear with the number of keys used, but the strength is exponential with key length. Hence doubling the key length has an enormous effect on the cryptographic strength of an encryption algorithm.

3.4 Encrypting Communications Channels

In theory, this encryption can take place at any layer in the Open Systems Interface (OSI) communications model. In practice, it takes place either at the lowest layers (one or two) or at higher layers. If it takes place at the lowest layers, it is called link-by-link encryption; everything going through a particular data link is encrypted. If it takes place at higher layers, it is called end-to-end encryption; the data are encrypted selectively and stay encrypted until they are decrypted by the intended final recipient. Each approach has its own benefits and drawbacks.

3.4.1 Link-by-Link Encryption

The easiest place to add encryption is at the physical layer. This is called link-by-link encryption. The interfaces to the physical layer are generally standardised and it is easy to connect hardware encryption devices at this point. These devices encrypt all data passing through them, including data, routing information, and protocol information. They can be used on any type of digital communication link. On the other hand, any intelligent switching or storing nodes between the sender and the receiver need to decrypt the data stream before processing it.

This type of encryption is very effective because everything is encrypted. A cryptanalyst can get no information about the structure of the information. There is no idea of who is talking to whom, the length of the messages they are sending are, what times of the day they communicate, and so on. This is called traffic-flow security: the enemy is not only denied access to the information, but also access to the knowledge of where and how much information is flowing.

Security does not depend on any traffic management techniques. Key management is also simple, only the two endpoints of the line need a common key, and they can change their key independently from the rest of the network.

Imagine a synchronous communications line, encrypted using 1-bit CFB. After initialization, the line can run indefinitely, recovering automatically from bit or synchronisataion errors. The line encrypts whenever messages are sent from one end to the other, otherwise it just encrypts and decrypts random data. There is no information on when messages are being sent and when they are not; there is no information on when messages begin and end. All that is observed is an endless stream of random-looking bits.

If the communications line is asynchronous, the same 1-bit CFB mode can be used. The difference is that the adversary can get information about the rate of transmission. If this information must be concealed, then some provision for passing dummy messages during idle times is required.

The biggest problem with encryption at the physical layer is that each physical link in the network needs to be encrypted; leaving any link unencrypted jeopardises the security of the entire network. If the network is large, the cost may quickly become prohibitive for this kind of encryption.

Additionally, every node in the network must be protected, since it processes unencrypted data. If all the network's users trust one another, and all nodes are in secure locations, this may be tolerable. But this is unlikely. Even in a single corporation, information might have to be kept secret within a department. If the network accidentally misroutes information, anyone can read it.

3.4.2 End-to-End Encryption

Another approach is to put encryption equipment between the network layer and the transport layer. The encryption device must understand the data according to the protocols up to layer three and encrypt only the transport data units, which are then recombined with the unencrypted routing information and sent to lower layers for transmission.

This approach avoids the encryption/decryption problem at the physical layer. By providing end-to-end encryption, the data remains encrypted until it reaches its final destination. The primary problem with end-to-end encryption is that the routing information for the data is not encrypted; a good cryptanalyst can learn much from who is talking to whom, at what times and for how long, without ever knowing the contents of those conversations. Key management is also more difficult, since individual users must make sure they have common keys.

Building end-to-end encryption equipment is difficult. Each particular communications system has its own protocols. Sometimes the interfaces between the levels are not well-defined, making the task even more difficult.

If encryption takes place at a high layer of the communications architecture, like the applications layer or the presentation layer, then it can be independent of the type of communication network used. It is still end-to-end encryption, but the encryption implementation does not have to be bothered about line codes, synchronisataion between modems, physical interfaces, and so forth. In the early days of electromechanical cryptography, encryption and decryption took place entirely off-line, this is only one step removed from that.

Encryption at these high layers interacts with the user software. This software is different for different computer architectures, and so the encryption must be optimised for different computer systems. Encryption can occur in the software itself or in specialised hardware. In the latter case, the computer will send the data to the specialised hardware for encryption before sending it to lower layers of the communication architecture for transmission. This process requires some intelligence and is not suitable for dumb terminals. Additionally, there may be compatibility problems with different types of computers.

The major disadvantage of end-to-end encryption is that it allows traffic analysis. Traffic analysis is the analysis of encrypted messages: where they come from, where they go to, how long they are, when they are sent, how frequent or infrequent they are, whether they coincide with outside events like meetings, and more. A lot of good information is buried in this data, and is therefore important to a cryptanalyst.

3.4.3 Combining the Two

Combining the two, whilst most expensive, is the most effective way of securing a network. Encryption of each physical link makes any analysis of the routing information impossible, while end-to-end encryption reduces the threat of unencrypted data at the various nodes in the network. Key management for the two schemes can be completely separate. The network managers can take care of encryption at the physical level, while the individual users have responsibility for end-to-end encryption.

3.5 Hardware Encryption Versus Software Encryption

3.5.1 Hardware

Until very recently, all encryption products were in the form of specialised hardware. These encryption/decryption boxes plugged into a communications line and encrypted all the data going across the line. Although software encryption is becoming more prevalent today, hardware is still the embodiment of choice for military and serious commercial applications. The NSA, for example, only authorises encryption in hardware. There are a number of reasons why this is so. The first is speed. The two most common encryption algorithms, DES and RSA, run inefficiently on general-purpose processors. While some cryptographers have tried to make their algorithms more suitable for software implementation, specialised hardware will always win a speed race. Additionally, encryption is often a computation-intensive task. Tying up the computer's primary processor for this is inefficient. Moving encryption to another chip, even if that chip is just another processor, makes the whole system faster.

The second reason is security. An encryption algorithm running on a generalised computer has no physical protection. Hardware encryption devices can be security encapsulated to prevent this. Tamperproof boxes can prevent someone from modifying a hardware encryption device. Special-purpose VLSI chips can be coated with a chemical such that any attempt to access their interior will result in the destruction of the chip's logic.

The final reason for the prevalence of hardware is the ease of installation. Most encryption applications do not involve general-purpose computers. People may wish to encrypt their telephone conversations, facsimile transmissions, or data links. It is cheaper to put special-purpose encryption hardware in telephones, facsimile machines, and modems than it is to put in a microprocessor and software.

The three basic kinds of encryption hardware on the market today are: self-contained encryption modules (that perform functions such as password verification and key management for banks), dedicated encryption boxes for communications links and boards that plug into personal computers.

More companies are starting to put encryption hardware into their communications equipment. Secure telephones, facsimile machines, and modems are all available.

Internal key management for these devices is generally secure, although there are as many different schemes as there are equipment vendors. Some schemes are more suited for one situation than another and buyers should know what kind of key management is incorporated into the encryption box and what they are expected to provide themselves.

3.5.2 Software

Any encryption algorithm can be implemented in software. The disadvantages are in speed, cost and ease of modification (or manipulation). The advantages are in flexibility and portability, ease of use, and ease of upgrade. Software based algorithms can be inexpensively copied and installed on many machines. They can be incorporated into larger applications, such as communication programs and, if written in a portable language such as C/C++, can be used and modified by a wide community.

Software encryption programs are popular and are available for all major operating systems. These are meant to protect individual files; the user generally has to manually encrypt and decrypt specific files. It is important that the key management scheme be secure. The keys should not be stored on disk anywhere (or even written to a place in memory from where the processor swaps out to disk). Keys and unencrypted files should be erased after encryption. Many programs are sloppy in this regard, and a user has to choose carefully.

A local programmer can always replace a software encryption algorithm with something of lower quality. But for most users, this is not a problem. If a local employee can break into the office and modify an encryption program, then it is also possible for that individual to set up a hidden camera on the wall, a wiretap on the telephone, and a TEMPEST detector along the street. If an individual of this type is more powerful than the user, then the user has lost the game before it starts.

3.6 Software Encryption Products

This topic attempts to place the data encryption techniques described in this report in its proper context amongst the many other security products that are currently available for the PC. It should in no way be thought of as an attempt to cover the whole range of products that are available. This is done very effectively by the many “Security Product Guides” that are published annually. Similarly, only a few commonly used products are described. All of the products discussed below are readily available.

3.6.1 Symmetric Algorithm Products

The following software packages use a symmetric encryption algorithm. They often offer encryption as just one of many other security features.

Datasafe is a memory-resident encryption utility, supplied on a copy protected disk. It intercepts DOS system calls, and applies encryption using a proprietary key unique to each copy of Datasafe. Using a different password for each file ensures unique encryption. Datasafe detects whether a file is encrypted, and can distinguish an encrypted file from a plaintext file. On-the-fly encryption is normally performed using a proprietary algorithm, but DES encryption is available using a stand-alone program.

Decrypt is a DES implementation for the 8086/8088 microprocessor family (as used in early PCs). Decrypt is designed to be easy to integrate into many types of program and specified hardware devices, such as hardware encryptors and point of sale terminals.

Diskguard is a software package which provides data encryption using the DES algorithm. One part of Diskguard is memory-resident, and may be accessed by an application program. This permits encryption of files, and/or blocks of memory. The second part of Diskguard accesses the memory-resident part through a menu-driven program. Each file is protected by a different key, which is in turn protected by its own password. Electronic Code Book and cypher Feedback modes of encryption can be used.

File-Guard is a file encryption program which uses a proprietary algorithm. File-Guard encrypts files and/or labels them as “Hidden”. Files which are marked as hidden do not appear in a directory listing.

Fly uses a proprietary algorithm, and an 8-character encryption key, to encrypt a specified file. The original file is always overwritten, therefore, once encryption is complete, no plaintext data from the original file remains on the disk. Overwriting the original plaintext could have interesting consequences if the PC experienced a power cut during the encryption process.

N-Code is a menu driven encryption utility for the MS-DOS operating system which uses a proprietary algorithm. Each encryption key can be up to 20 alphanumeric characters long, and is selected by the N-Code user. Access to the encryption functions provided by N-Code is password protected. A user can choose to encrypt just one file, many files within a subdirectory, or an entire disk subdirectory. The original plaintext file can either be left intact, or over-written by the encrypted data.

P/C Privacy is a file encryption utility available for a large number of operating systems ranging from MS-DOS on a PC, to VMS on a DES system, and/or MVS on a large IBM mainframe. P/C Privacy uses a proprietary encryption algorithm, and each individual encryption key can be up to 100 characters long. Every encrypted file is constrained to printable characters only. This helps to avoid many of the problems encountered during transmission of an encrypted file via modems and/or networks. This technique also increases the encrypted file size to roughly twice the size of the original plaintext file.

Privacy Plus is a software files encryption system capable of encrypting any type of file stored on any type of disk. Encryption is carried out using either the DES encryption algorithm, or a proprietary algorithm. Privacy Plus can be operated from batch files or can be menu driven. Memory-resident operation is possible if desired. Encrypted files can be hidden to prevent them appearing in a directory listing. An option is available which permits the security manager to unlock a user's files if the password has been forgotten, or the user has left the company. Note that this means that the encryption key, or a pointer to the correct encryption key, must be stored within every encrypted file. An option is also available which imposes multi-level security on top of Privacy Plus.

SecretDisk provides on-the-fly encryption of files stored in a specially prepared area of a disk. It works by constructing a hidden file on the disk (hard or floppy), and providing the necessary device drivers to persuade MS-DOS that this is a new drive. All files on a Secret Disk are encrypted using an encryption key formed from a password entered by the user. No key management is implemented, the password is simply committed to memory. If this password is forgotten, then there is no way to retrieve the encrypted data. Also included with Secret Disk is a DES file encryption utility, but again with no key management facilities. With a Secret Disk initialised, a choice must be made between using a proprietary encryption algorithm, and the DES algorithm. This choice affects the performance of Secret Disk drastically as the DES version of Secret Disk is about 50 times slower than the proprietary algorithm.

Ultralock encrypts data stored in a disk file. It resides in memory, capturing and processing file requests to ensure that all files contained within a particular file specification are encrypted when stored on disk. For example, the specification “B:MY*.TXT” encrypts all files created on drive B whose filename begins with “MY” that have an extension of “TXT”. Overlapping specifications can be given, and Ultralock will derive the correct encryption key. A user has the power to choose which files are encrypted, therefore, Ultralock encryption is discretionary in nature, not mandatory. The key specification process is extremely flexible, and allows very complex partitions between various types of files to be achieved. Ultralock uses its own, unpublished, proprietary encryption algorithm.

VSF-2 is a multi level data security system for the MS-DOS operating system. VSF-2 encrypts files on either a hard disk or floppy disk. A positive file erasure facility is included. The user must choose the file to be secured, and the appropriate security level (1 to 3). At level 1, the file is encrypted but still visible in a directory listing. Level 2 operation encrypts the file, but also makes the encrypted result a hidden file. Level 3 operation ensures that the file is erased if three unsuccessful decryption attempts are made.

There are many software encryption products available, and it should be obvious from the above list that a great number of them offer encryption using a proprietary (unpublished) algorithm. This must be approached with caution, as is discussed in depth at various places throughout this report. Over half of the products offer DES encryption, often as an adjunct to the “fast” proprietary algorithm. The promotional literature tends to imply that a user will be far better off using the proprietary algorithm as it executes far faster than the DES algorithm. This may be true, and it tends to make many of the products that offer on-the-fly encryption bearable; but at what expense?

Only two of the products discussed above offer key management facilities. This is a low percentage of the total number of products. Most of the software packages rely on the user entering the encryption key at runtime, rather like a password. In fact, many of them inextricably confuse the concepts of encryption key and password. Some products even manage to confuse the concepts of encryption key and encryption algorithm, by discussing variable algorithms. Key management is crucial. Humans are very poor at remembering encryption keys, and even worse at keeping an encryption key secret.

It is possible to obtain a software package offering just about any desired combination of features. Therefore, it is vitally important to analyse the reasons behind making the decision to use encryption. If these reasons are not clear, then the danger of purchasing an unsuitable product is increased. Products which provide encryption in software have one major advantage over all the other products discussed in the following sections—price. They are often an order of magnitude cheaper than the equivalent hardware product.

3.6.2 Asymmetric Algorithm Products

The following software packages use an asymmetric encryption algorithm. They often offer encryption as one of many security features.

Crypt Master is a software security package which uses the RSV public key encryption algorithm with a modulus length of 384 bits. Crypt Master can provide file encryption and/or digital signatures for any type of file. The RSA algorithm can be used as a key management system to transport encryption keys for a symmetric, proprietary encryption algorithm. This symmetric algorithm is then used for bulk file encryption. Digital signatures are provided using the RSA algorithm.

Public is a software package which uses the RSA public key encryption algorithm (with a modulus length of 512 bits) to secure transmitted messages. Encryption is used to prevent message inspection. The RSA algorithm is used to securely transport encryption keys for either the DES algorithm, or a proprietary encryption algorithm—one of which is used to encrypt the content of a specified file. Digital signatures are used to prevent message alteration. The asymmetry of the RSA algorithm permits a digital signature to be calculated with a secret RSA key which can be checked using the corresponding public RSA key. In a hierarchical menu system, public key management facilities and key generation software are all included.

MailSafe is a software package which uses the RSA public key encryption algorithm to encrypt and/or authenticate transmitted data. Key generation facilities are included, and once a pair of RSA keys have been generated, they can be used to design and/or encrypt files. Signing a file appends an RSA digital signature to the original data. This signature can be checked at any time. Utilities are available which offer data compression, management of RSA keys, and connections to electronic mail systems.

Unlike the products which offer encryption using a symmetric encryption algorithm, the above products are all that seem to be currently available which offer RSA encryption as a software package (the symmetric encryption products were selected from a long list). All but one of the products offer digital signature facilities as well as RSA encryption and decryption. Key management problems change their nature when public key algorithms are used. The basic problem becomes one of guaranteeing that a received public key is authentic. Given the complex (and slow) mathematics required to generate a public/secret key pair, and the slow encryption speed, these RSA software packages are often used to transfer keys for a symmetric encryption algorithm in a secure manner. Some of the packages even have in-built symmetric encryption facilities. The price advantage enjoyed by software packages which use a symmetric encryption algorithm does not spill over into products using RSA. They tend to be highly priced, sometimes almost as much as the products discussed below, which include special purpose hardware. This is merely a reflection of the size of the market for RSA products. This in itself is a reflection of the speed of encryption. Software based RSA is not suitable for slow PC's.

3.6.3 Location of Encryption

As with most PC products, software solutions are almost universally cheaper than the equivalent hardware products. When data held on disk is to be protected by encryption, it is always difficult to decide the level at which to operate. Too high in the DOS hierarchy, and the encryption has difficulty in copying with the multitude of ways in which applications can use DOS. Too low in the DOS hierarchy and key management becomes difficult, as the link between a file name and its associated data may be lost in track/sector formatting. Various solutions are possible:

(i) Treat encryption as a DOS application and let the user add encryption. This is how the encryption utility programs operate.

(ii) Try to process every DOS function call; this is how the on-the-fly encryption utilities work.

(iii) Impose encryption at the level of disk access, but remain high enough to permit encryption to be selected on the basis of the MS-DOS filenames. Ultralock seems to be somewhat unique in that it succeeds in existing at this level. It imposes encryption on the basis of file names (and/or extensions) whilst residing in memory. The penalty is that versions of Ultralock are specific to particular versions (or range of versions) of MS-DOS.

In reality the choice is usually between a proprietary algorithm for on-the-fly encryption, and either DES or RSA for secure encryption on a specific file-by-file basis. It is not advisable to invest in encryption packages which use a secret encryption algorithm (often called a proprietary algorithm), unless there is complete confidence in the company that designed the product. This confidence should be based on the designer of the product and not the salesman.

4 Data Compression

4.1 Introduction

The benefits of data compression have always been obvious. If a message can be compressed n times, it can be transmitted in 1/n of the time, or transmitted at the same speed through a channel with 1/n of the bandwidth. It can also be stored in 1/n of the volume of the original. A typical page of text that has been scanned requires megabytes, instead of kilobytes, of storage. For example, an 8.5 times 11 inch (U.S. standard letter size) page scanned at 600 times 600 dpi requires about 35 MB of storage at 8 bits per pixel—three orders of magnitude more than a page of ASCII text. Fortunately, most pages of text have significant redundancy, and a pixel map of these pages can be processed in order to store the page in less memory than the raw pixel map. This process of eliminating the redundancy in order to save storage space is called compression, or often data encoding. The success of the compression operation often depends on the amount of processing power that can be applied. The result of the compression is measured by the compression ratio (CR), which is defined as the ratio of the number of bits in the data before compression to the number of bits after compression. Although the storage cost per bit is about half a millionth of a dollar, a family album with several hundred photos can cost more than a thousand dollars to store! This is one area where image compression can play an important role. Storing images with less memory cuts cost. Another useful feature of image compression is the rapid transmission of data; fewer data requires less time to send, So how can data be compressed? Mostly, data contain some amount of redundancy that can sometimes be removed when the data is stored, and replaced when it is restored. However, eliminating this redundancy does not necessarily lead to high compression. Fortunately, the human eye is insensitive to a wide variety of information loss. That is, an image can be changed in many ways that are either not detected by the human eye or do not contribute to “degradation” of the image. If these changes lead to highly redundant data, then the data can be greatly compressed when the redundancy can be detected. For example, the sequence 2, 0, 0, 2, 0, 2, 2, 0, 0, 2, 0, 2, . . . is (in some sense) similar to 1, 1, 1, 1, 1 . . . , with random fluctuations of ±1. If the latter sequence can serve our purpose as well as the first, we would benefit from storing it in place of the first, since it can be specified very compactly. How much can a document be compressed? This depends on several factors that can only be approximated, even if we answer the following questions. What type of document is it—text, line art, gray-scale, or halftone? What is the complexity of the document? What sampling resolution was used to scan the input page? What computing resources are we willing to devote to the task? How long can we afford to process the image? Which compression algorithm are we going to use? Usually we can only estimate the achievable CR, based on the results of similar sets of documents under similar conditions. Compression ratios in the range of 0.5 to 200 are typical, depending on the above factors. (A CR less than 1.0 means that the algorithm has expanded the image instead of compressing it. This is common in the compression of halftone images.) The CR is a key parameter, since transmission time and storage space scale with its inverse. In some cases, images can be processed in the compressed domain, which means that the processing time also scales with the inverse of the CR.Compression is extremely important in document image processing because of thesize of scanned images.

4.1.1 Information Theory

Messages are transmitted in order to transfer information. Most messages have a certain amount of redundancy in addition to their information. Compression is achieved by reducing the amount of redundancy in a message while retaining all or most of its information. What is information? A binary communication must have some level of uncertainty in order to communicate information. Similarly, with an electronic image of a document, large areas of the same shade of gray do not convey information. These areas are redundant and can be compressed. A text document, for example, usually contains at least 95\% white space and can be compressed effectively. The various types of redundancies that can occur in documents are as follows: (i) sparse coverage of a document; (ii) repetitive scan lines; (iii) large smooth gray areas; (iv) large smooth halftone areas; (v) ASCII code, always 8 bits per character; (vi) double characters; (vii) long words, frequently used.

Entropy

Entropy E is a quantitative term for the amount of information in a string of symbols and is given by the following expression

$$E = - {\sum }_{i = 1}^{N} {P}_{i} {log}_{2} {P}_{i}$$

where Pᵢ is the probability of occurrence of each one of N independently occurring symbols. As an example, if we have a binary image with equal random probabilities of black and white pixels of 0.5 say, then the entropy is E=−[0.5×(−1.0)]−[0.5×(−1.0)]=1.0 bit of information per bit transmitted. On the other hand, if the probability of blackis 0.05 and the probability of white is0.95, the Entropy is equal to 0.22+0.07=0.29 bit per bit. As the probability of a block binary bit changes from 0.0 to 1.0, the total entropy varies from 0.0 to a peak of 1.0 and back to a value of 0.0 again. A basic ground rule of compression systems is that more frequent messages should be shorter, while less frequent messages can be longer.

4.2 Binary Data Compression

Most binary compression schemes are information-preserving, so that when binary data is compressed and then expanded, it will be exactly the same as the original, assuming that no errors have occurred. Gray-scale compression schemes, on the other hand, are often non-information-preserving, or lossy. Some “unimportant” information is discarded, so that better compression results can be achieved. If more information is discarded, a higher CR will result, but a point will be reached where the decompressed image will have a degraded appearance. Some of the techniques used in binary compression systems are listed below. Often several of these techniques are used in one compression system: (i) packing; (ii) run length coding; (iii) huffman coding; (iv) arithmetic coding; (v) predictive coding; (vi) READ coding; (vii) JPEG compression.

4.2.1 Runlength Coding

Run-length coding replaces a sequence of the same character by a shorter sequence which contains a numeric that indicates the number of characters in the original sequence. The actual method by which run-length coding is affected can vary, although the operational result is essentially the same. For example, consider the sequence ********, which might represent a portion of a heading. Here the sequence of eight asterisks can be replaced by a shorter sequence, such as Sc*8, where Sc represents a special compression-indicating character which, when encountered by a decompression program, informs the program that run-length encoding occurred. The next character in the sequence, the asterisk, tells the program what character was compressed. The third character in the compressed sequence, 8, tells the program how many compressed characters were in the compressed run-length coding sequence so the program can decompress the sequence back into its original sequence. Because the special compression-indicating character can occur naturally in data, when this technique is used the compression program will add a second character to the sequence when the character appears by itself. Thus, this technique can result in data expansion and explains why the compression-indicating character has to be carefully selected. Another popular method of implementing run-length coding involves using the character to be compressed as the compression-indicating character whenever a sequence of three or more characters occurs. Here, the program converts every sequence of three or more characters to the three characters followed by the character count. Thus, the sequence ******** would be compressed as ***8. Although this method of run-length coding requires one additional character, it eliminates the necessity of inserting an additional compression-indicating character when that character occurs by itself in a data stream.

The average length \overline{l} of these strings or clusters is given by

$$\overline{l} = {\sum }_{i = 1}^{N} P ( {l}_{i} ) {l}_{i}$$

where N is the number of clusters, lᵢ is the length of the ith cluster, and P(lᵢ) is the probability of the ith cluster. Their entropy is given by

$$E = - {\sum }_{i = 1}^{N} P ( {l}_{i} ) {log}_{2} P ( {l}_{i} )$$

The maximum possible CR for a run length encoding scheme is

$${CR}_{max} = \frac{\overline{l}}{E}$$

4.3 Compression, Encoding and Encryption

Using a data compression algorithms together with an encryption algorithm makes sense for two reasons:

(i) Cryptanalysis relies on exploring redundancies in the plaintext; compressing a file before encryption reduces these redundancies.

(ii) Encryption is time-consuming; compressing a file before encryption speeds up the entire process.

In is important to remember, that if a file to be encrypted, it is very useful to apply data compression to the content of the file before this takes place. The data compression can be reversed after the file has been decrypted. This is advantageous for two distinct reasons. First, the file to be encrypted is reduced in size, thus reducing the overhead caused by encryption. Second, if the original data contained regular patterns, these are made much more random bad the compression process, thereby making it more difficult to “crack” the encryption algorithm. If a system is designed which adds any type of transmission encoding or error detection and recovery, then it should be added after encryption. If there is noise in the communications path, the decryptions error-extension properties will only make that noise worse. FIG. 4.1 summarises these steps.

5 Random Number Generators

5.1 Introduction to Random Number Generators

Random-number generators are not random because they do not have to be. Most simple applications, such as computer games for example, need very few random numbers. However, cryptography is extremely sensitive to the properties of random-number generators. Use of a poor random-number generator can lead to strange correlations and unpredictable results. If a security algorithm is designed around a random-number generator, spurious correlations must be avoided at all costs.

The problem is that a random-number generator does not produce a random sequence. In general, random number generators do not necessarily produce anything that looks even remotely like the random sequences produced in nature. However, with some careful tuning, they can be made to approximate such sequences. Of course, it is impossible to produce something truly random on a computer. As John von Neumann states, “Anyone who considers arithmetical methods of producing random digits is, of course, in a state of sin”. Computers are deterministic—stuff goes in at one end, completely predictable operations occur inside, and different stuff comes out the other end. Put the same data into two identical computers, and the same data comes out of both of them (most of the time!).

A computer can only be in a finite number of states (a large finite number, but a finite number nonetheless), and the data that comes out will always be a deterministic function of the data that went in and the computer's current state. This means that any random-number generator on a computer (at least, on a finite-state machine) is, by definition, periodic. Anything that is periodic is, by definition, predictable and can not therefore be random. A true random-number generator requires some random input; a computer can not provide this.

5.1.1 Pseudo-Random Sequences

The best a computer can produce is a pseudo-random-sequence generator. Many authors have attempted to define a pseudo-random sequences formally. In this section an general overview is given.

A pseudo-random sequence is one that looks random. The sequence's period should be long enough so that a finite sequence of reasonable length—that is, one that is actually used—is not periodic. If for example, a billion random bits is required, then a random sequence generator should not be chosen that repeats after only sixteen thousand bits. These relatively short nonperiodic sequences should be as indistinguishable as possible from random sequences. For example, they should have about the same number of ones and zeros, about half the runs (sequences of the same bit) should be of length one, one quarter of length two, one eighth of length three, and so on. In addition, they should not be compressible. The distribution of run lengths for zeros and ones should be the same. These properties can be empirically measured and then compared with statistical expectations using a chi-square test.

For our purpose, a sequence generator is pseudo-random if it has the following property:

Property 1: It looks random, which means that it passes all the statistical tests of randomness that we can find.

Considerable effort has gone into producing good pseudo-random sequences on a computer. Discussions of generators abound in the academic literature, along with various tests of randomness. All of these generators are periodic (there is no exception); but with potential periods of 2²⁵⁶ bits and higher, they can be used for the largest applications.

The problem with all pseudo-random sequences is the correlations that result from their inevitable periodicity. Every pseudo-random sequence generator will produce them if they are use extensively; this fact is often used by a cryptanalyst to attack the system.

5.1.2 Cryptographically Secure Pseudo-Random Sequences

Cryptographic applications demand much more of a pseudo-random-sequence generator than do most other applications. Cryptographic randomness does not mean just statistical randomness. For a sequence to be crypto-graphically pseudo-randomly secure, it must also have the following property:

Property 2: It is unpredictable. It must be computationally non-feasible to predict what the next random bit will be, given complete knowledge of the algorithm or hardware generating the sequence and all of the previous bits in the stream.

Cryptographically secure pseudo-random sequences should not be compressible, unless the key is known. The key is related to the seed used to set the initial state of the generator.

Like any cryptographic algorithm, cryptographically secure pseudo-random-sequence generators are subject to attack. Just as it is possible to break an encryption algorithm, it is possible to break a cryptographically secure pseudo-random-sequence generator. Making generators resistant to attack is what cryptography is all about.

5.1.3 Real Random Sequences

Is there such a thing as randomness? What is a random sequence? How do you know if a sequence is random? Is for example “101110100” more random than “101010101”? Quantum mechanics tells us that there is honest-to-goodness randomness in the real world but can we preserve that randomness in the deterministic world of computer chips and finite-state machines?

Philosophy aside, from our point of view, a sequence generator is real random if it has this additional third property.

Property 3: It cannot be reliably reproduced. If the sequence generator is run twice with the exact same input (at least as exact as computationally possible), then the sequences are completely unrelated; their cross-correlation function is effectively zero.

The output of a generator satisfying the three properties given above is good enough for a one-time pad, key generation, and other cryptographic applications that require a truly random sequence generator. The difficulty is in determining whether a sequence is really random. If a string is repeatedly encrypted with DES and a given key, then a random-looking output will be obtained. It will not be possible to tell whether it is non-random unless time is rented on a DES cracker.

5.2 Cryptography and Random Numbers

Many authors suggest the use of random number generator functions in the math libraries which come with many compilers (e.g. the rand( ) function which is part of most C/C++compilers). Such generator functions are insecure and to be avoided for cryptographic purposes.

For cryptography, what is required is values which can not be guessed by an adversary any more easily than by trying all possibilities (“brute force” or “exhaustive search” strategies). There are several ways to acquire or generate such values, but none of them is guaranteed. Therefore, the selection of a random number source is a matter of art and assumptions.

There are a few simple guidelines to follow when using random number generators:

(i) Make sure that the program calls the generator's initialisation routine before it calls the generator.

(ii) Use seeds that are “somewhat random”, i.e. have a good mixture of bits. For example 2731774 and 10293082 are “safer” than 1 or 4096 (or some other power of two).

(iii) Note that two similar seeds (e.g. 23612 and 23613) may produce sequences that are correlated. Thus, for example, avoid initialising generators on different processors or different runs by just using the processor number or the run numbers as the seed.

(iv) Never trust the random number generator provided on a computer, unless someone who has a lot of expertise in this area can personally guarantee that it is a good generator. (N.B. This does not include guarantees from the computer vendor).

5.3 Linear Congruential Generators

The most popular method for creating random sequences is the linear congruential method, first introduced by D H Lehmer in 1949. The algorithm requires four parameters:

m, the modulus: m>0

a, the multiplier: 0<a<m

the increment: 0<c<m

x₀, the seed or starting value: 0<x₀<m

The sequence of random numbers is then generated from recursion relation,

xₙ₊₁=(axₙ+c) mod(m), n>0

The essential point to understand when employing this method is that not all values of the four parameters produce sequences that pass all the tests for randomness. All such generators eventually repeat themselves cyclically, the length of this cycle (the period) being at most m. When c=0, the algorithm, is faster and referred to as the multiplicity congruential method and many authors refer to mixed congruential methods when c=0.

To discuss all the mathematical justifications for the choice of m, c, a and x₀ is beyond the scope of this work. We therefore give a brief summary of some of the principal considerations.

For long periods, m must be large. The other factor to be considered in choosing m is the speed of the algorithm. Computing the next number in the sequence requires division by m and hence a convenient choice is the word size of the computer.

Perhaps the most subtle reasoning involves the choice of the multiplier a such that a cycle of period of maximum length is obtained. However, a long period is not the sole criterion that must be satisfied. For example, a=c=1, gives a sequence which has a maximum period m but is anything but random. It is always possible to obtain the maximum period but a satisfactory sequence is not always attained. When m is the product of distinct primes only a=1 will produce a full period, but when m is divisible by a high power of some prime, there is considerable latitude in the choice of a.

The following theorem dictates the choices that give a maximum period.

Theorem 5.1

The linear congruential sequence defined by a, m, c and x₀ has period of length m if and only if,

(i) c is relatively prime to m;

(ii) b=a−1 is a multiple of p for every prime p dividing m;

(iii) b is a multiple of 4, if m is a multiple of 4.

Traditionally uniform random number generators produce floating point numbers between 0 and 1, with other ranges obtainable by translation and scaling.

5.4 Data Sizing

In general, ciphering techniques based on random number sequences cause an enlargement of data size as a result of the ciphering process. In this section a rough estimation is made of dependence between the length of the input buffer and the output buffer.

Suppose the length of the input buffer is equal to n. If we combine all the input data to obtain a binary sequence, how many regions does it consist of? At most, it can include N=8n regions (if this sequence, from start to finish is something like “010101 . . . ” or “101010 . . . ”). At least, it can include 1 region (if the sequence, from start to finish is of the type “1111 . . . ” or “0000 . . . ”). If we restrict the maximum number of bits in a region to be equal to P, then the minimum number of regions will be least integer greater or equal to 8n/P. The average number of regions Nₐᵥ in a bit sequence will roughly be given by

$${N}_{a v} = \frac{8 n + 8 n / P}{2} = 4 n \frac{1 + P}{P}$$

We require log₂(Q+P)+1 bits to store the number of bits in any region where Q is the maximum value of the random number sequence. Hence, a bit sequence of length 8n, after ciphering will have an average length of

$${N}_{a v} = 4 n \frac{1 + P}{P} [ {log}_{2} ( Q + P ) + 1 ]$$

Dividing the final number of bits by the original, we obtain

$$4 n \frac{1 + P}{P} [ {log}_{2} ( Q + P ) + 1 ] \frac{1}{δ n } = \frac{1 + P}{2 P} [ {log}_{2} ( Q + P ) + 1 ]$$

Consider the case when P=8 and Q=8. Then after ciphering, the length of data will increase 3.375 times. Thus, an input of 512 bytes produces an output of approximately 1.8 Kb.

Cyphering techniques based on random number sequences depend on the following critical values:

(i) P—maximum number of bits in the bit segment;

(ii) Q—maximum value of random number sequence;

(iii) Order of bits (from left to right or reverse) in the bit field;

(iv) Placement of bit type in the bit field (leftmost or rightmost);

(v) The seed value and other parameters associated with the random number iterator.

From the list above, only the last point should be used as key values in a communications process. A ciphering technique should allow control over the rest of the parameters, although they could be derived once the seed is selected (which is the essential key parameter).

How can we increase the general security of the whole algorithm? One way is to make several iterations of the algorithm one after another, changing the initial conditions every time. The following data is then required to perform decoding: the number of iterations; the seed for each iteration sequence. This however, leads to a significant enlargement of the resulting data.

6 Chaos

6.1 Introduction

Chaos is derived from a Greek verb that means “to gage open”, but in our society, chaos evokes visions of disorder. In a sense, chaotic systems are in unstable equilibrium; even the slightest change to the initial conditions of the system at time t leads the system to a very different outcome at some arbitrary later time. Such systems are said to have a sensitive dependence on initial conditions.

Some system models such as that for the motion of planets within our solar system contain many variables, and yet are still relatively accurate. With chaotic systems, however, even when there are hundreds of thousands of variables involved, no accurate prediction of their behaviour can be made. For example, the weather is known to be a chaotic system. Despite the best efforts of beleaguered meteorologists to forecast the weather, they very frequently fail, especially at local levels. There is a famous anecdote about the movement of a butterfly's wings in Tokyo affecting the weather in New York. This is typical of a chaotic system and illustrates its sensitive dependence on initial conditions. Chaotic systems appear in virtually every aspect of life. Traffic patterns tend to be chaotic, the errant manoeuvre of even one car can create an accident or traffic jam that can affect thousands of others. The stock market is a chaotic system because the behaviour of one investor, depending on the political situation or corporation, can alter prices and supply. Politics, particularly the politics of non-democratic societies, is also chaotic in the sense that a slight change in the behaviour of a dominant individual can effect the behaviour of millions. In this sense, democracy can be defined as a “chaos limiting”. In general, chaos is the study of situations in which the slightest actions can have far-reaching repercussions.

6.2 The Feigenbaum Diagram

By way of a short introduction to chaotic systems, we consider the properties of the Feigenbaum diagram which has become an important icon of chaos theory. The diagram is a computer generated image and is necessarily so. That is to say that the details of it can not be obtained without the aid of a computer. Consequently, the mathematical properties associated with its structure would have remained elusive without the computer. This applies to the investigation of most chaotic systems whose properties are determined as much numerical experimentation as they are through the rigours and functional and stability analysis.

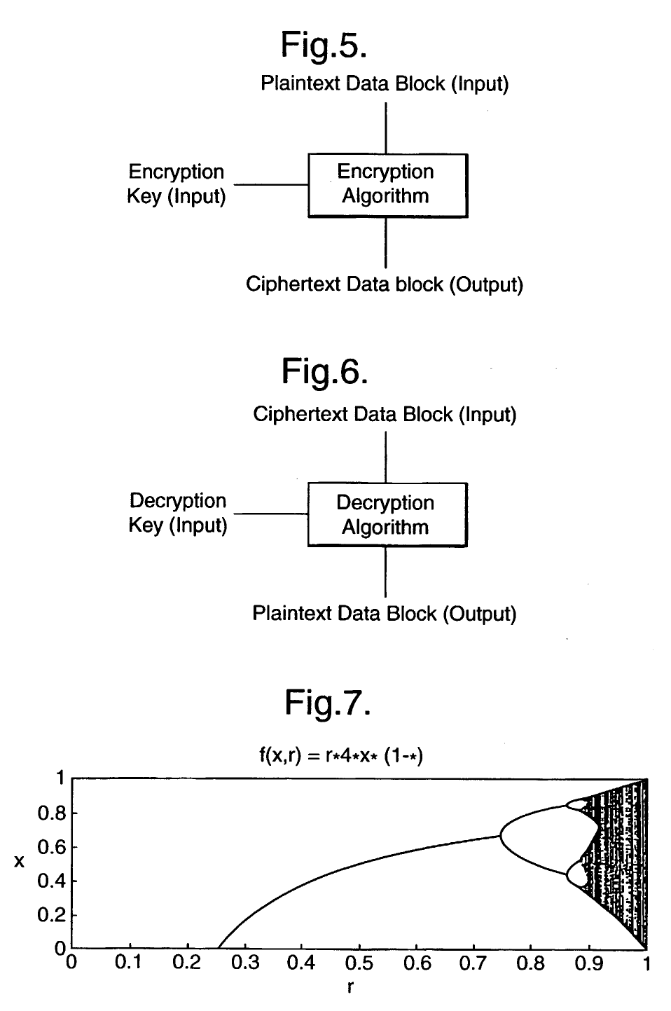

One essential structure seen in the Feigenbaum diagram (an example of which is given in FIG. 5) is the branching which portrays the dynamical behaviour of the iterator x→ax(1−x). Out of the major stem, we see two branches bifurcation, and out of these branches we see two more and so on. This is the period-doubling regime of the iterator.

For a=4, we have chaos and the points of the final state densely fill the complete interval, i.e. at a=4, chaos governs the whole interval from 0 to 1 (of the dependent axis). This image is called the Feigenbaum diagram because it is intimately connected with the ground breaking work of the physicist Mitchell Feigenbaum. Another point to note is that the chaotic region for 0.9<r<1 bifurcating structures are found at smaller scales (not visible in FIG. 7) which resemble the structures shown for 0.3<r<0.9. In other words the Feigenbaum diagram (like many other “phase space” diagrams) exhibits self-similar. This diagram is therefore an example of a fractal. In general, chaotic systems, if analysed in the appropriate phase space, are characterised by self-similar structures. Chaotic systems therefore produce fractal objects and can be analysed in terms of the fractal geometry that characterises them.

6.3 Example of a Chaos Generator: The Verhulst Process

The encryption techniques reported in this work depend on using a chaos generator instead of, or in addition to a pseudo-random number generator. Although many chaos generators exist and can in principle be used for this purpose, here, we consider one particular chaotic system—the “Verhulst Model”. This model describes the development of some population, influenced by some external environment. It assumes that the population growth rate depends on the current size of population.

We first normalise the population count by introducing x=P/N where P denotes the current population count and N is the maximum population count in a given environment. The range of x is then from 0 to 1. Let us index x by n, i.e. write xₙ to refer to the size of the population at time steps n=0,1,2, . . . The growth rate is then measured by xₙ₊₁/xₙ. Verhulst postulated that the growth rate at time n should be proportional to 1−xₙ (the fraction of the environment that is not yet used up by the population at time n). Thus, we can consider a population growth model based on

$$\frac{{x}_{n + 1}}{{x}_{n}} ∝ 1 - {x}_{n}$$

or after introducing a constant a and rearranging the result, xₙ₊₁=axₙ(1−xₙ) which yields the logistic model. Note, this is model used to generate the Feigenbaum diagram discussed in Section 5.1.2, i.e. the iterator x→axₙ(1−x).

Clearly, this process depends on two parameters: x₀ which defines the initial population size (seed value) and a which is a parameter of the process. One can expect that this process (as with any conventional process that can be described by a set of algebraical or differential equations), is of three kinds: (i) It can converge to some value x. (ii) It can be periodic. (iii) It can diverge and tend to infinity. However, this is not the case. The Verhulst generator, for certain initial values, is completely chaotic, i.e. it continues to be indefinitely irregular. This behaviour is compounded in the Feigenbaum diagram (FIG. 5) and is due to the nonlinearity of the iterator. In general, we can define four classes of behaviour depending on value of parameter r.

(i) 0<r<R₁: the process converges to some value p.

(ii) R₁<r<R₂: the process is period.

(iii) R₂<r<R₃: the process is chaotic.

(iv) R₃<r<0: the process tends to infinity.

The specific values of R₁, R₂ and R₃ depend on the seed value, but the general pattern remains the same. The region R₂<r<R₃ can be used for random number generation.

Another feature of this process is its sensitivity to the initial conditions. This effect is one of the central ingredients of what is called deterministic chaos. The main idea here is that any (however small) change in the initial conditions leads, after many iterations to a completely different resulting processes. In this sense, we cannot predict the development of this process at all due the impossibility of infinitely exact computations. However, we need to strictly determine the rounding rules which are used in generating a random sequence in order to receive the same results on different systems.

Many other chaos generators exist. In most cases they are compounded by iterative processes which are inherently nonlinear. This is not to say that all nonlinear processes produce chaos, but that chaotic processes are usually a result of nonlinear systems. A further discussion of this important issue is beyond the scope of this report.

7 Fractals

7.1 Fractal Geometry

Geometry, with its roots in ancient Greece, first dealt with the mathematically simplistic forms of spheres, cones, cubes etc. These exact forms, however, rarely occur naturally. A geometry suitable for describing natural objects—Fractal Geometry—was constructed this century and has only relatively recently (over the past twenty years)been research properly. This revolutionary field deals with shapes of infinite detail, such as coastlines, the branching of a river delta or nebulous forms of clouds for example and allows us to define and measure the properties of such objects. This measure is compounded in a metric called the Fractal Dimension.

Fracals arise in many diverse areas, from the complexity of natural phenomenon to the dynamic behaviour of nonlinear systems. Their striking wealth of detail has given them an immediate presence in our collective consciousness. Fractals are the subject of research by artists and scientists alike, making their study one of the truly renaissance activities of the late 20th century.

Definition

Unfortunately, a good definition of a fractal is elusive. Any particular definition either exclude sets that are thought of as fractals or to include sets that are not thought of as fractals. The definition of a ‘fractal’ should be regarded in the same way as the biologist regards the definition of ‘life’. There is no hard and fast definition, but just a list of properties and characteristic of a living thing. In the same way, it seems best to regard a fractal as a set that has properties such as those listed below, rather than to look for a precise definition which will almost certainly exclude some interesting cases.

If we consider a set F to be a fractal, then it should possess (some) of the following properties:

(i) F has detail at every scale.

(ii) F is (exactly, approximately, or statistically) self-similar.

(iii) The ‘Fractal Dimension’ of F is greater than its topological dimension.

(iv) There is a simple algorithmic description of F.

6.2 The Similarity (Fractal) Dimension

Central to fractal geometry is the concept of self-similarity, which means that some types of mainly naturally occurring objects look similar at different scales. Self-similar objects are compounded by a parameter called the ‘Similarity Dimension’ or the ‘Fractal Dimension’, D. This is defined as

$$N {τ}^{D} = 1 or D = - \frac{ln N}{ln τ} \qquad ( 6.1 )$$

where N is the number of distinct copies of an object which has been scaled down by a ratio r in all co-ordinates. There are two distinct types of fractals which exhibit this property:

(i) Deterministic Fractals;

(ii) Random Fractals.

Deterministic fractals are objects which look identical at all scales. Each magnification reveals an ever finer structure which is an exact replication of the whole, i.e. they are exactly self-similar. Random fractals do not, in general, possess such deterministic self-similarity; such fractal sets are composed of N distinct subsets, each of which is scaled down by a ratio r from the original and is identical in all statistical respects to the scaled original—they are statistically self-similar. The scaling ratios need not be the same for all scaled down copies. Certain fractals sets are composed of the union of N distinct subsets, each of which is scaled down by a ratio rᵢ<1, 1≦i≦N from the original in all co-ordinates. The similarity dimension is given by the generalisation of Eq. (6.1), namely

$${\sum }_{i = 1}^{N} {τ}_{i}^{D} = 1$$

A further generalisation leads to self-affine fractals sets which are scaled by different ratios in different co-ordinates. The equation

ƒ(λx)=λ^{H}ƒ(x) ∀λ>0 (6.2)

where λ is a scaling factor and H is a scaling exponent implies that a scaling in the x co-ordinate by λ gives a scaling of the ƒ coordinate by a factor λ^{H}. A special case of Eq. (6.2) occurs when H=1; in this case, we have a scaling of x by λ producing a scaling of ƒ by λ, i.e. ƒ(x) is self-similar.

Naturally occurring fractals differ from strictly mathematically defined fractals in that they do not display statistical or exact self-similarity over all scales but exhibit fractal properties over a limited range of scales.

6.3 Random Fractals

6.3.1 Classical Brownian Motion

There are many examples in the field of physics, chemistry and biology of random processes. Brownian motion is a relevant mathematical model for many such physical processes. These processes display properties which have now been shown to be best described as fractal processes.

In Brownian motion, the position of a particle at one time is not independent of the particles motion at a previous time. It is the increments of the position that are independent. Brownian motion in 1D is seen as a particle moving backwards and forwards on the x-axis for example. If we record the particles position on the x-axis at equally spaced time intervals, then we end up with a set of points on a line. Such a point-set is self-similar.

On the other hand, if we include time as an extra co-ordinate and plot the particles position against time—called the record of the motion—we obtain a point-set that is self-affine. In Section 6.3.2, we give an example of a physical process that has been modelled by Brownian motion.

6.3.2 Diffusion as an Example of Brownian Motion

For a particle moving in 1D (along the x-axis), consider the following model for its motion. At time interval τ a displacement (or increment) ξ is chosen at random from a Gaussian probability distribution given by

$$P ( ξ , τ ) = \frac{1}{\sqrt{4 πρτ}} exp ( - \frac{{ξ}^{2}}{4 ρτ} )$$

where ρ is the diffusion coefficient. The probability of finding ξ in the range ξ to ξ+dξ is P(ξ, τ)dξ and the sequence of the increments {ξᵢ} is a set of independent Gaussian random variables. The variance of the process is

$$⟨ {ξ}^{2} ⟩ = {\int }_{- ∞}^{∞} {ξ}^{2} P ( ξ , τ ) ⅆ ξ = 2 ρτ$$

where [symbol] • [symbol] denotes the expectation. The position of the particle at time t is then

$$x ( t ) = {\sum }_{i = 1}^{n} ξ i$$

Normally, for convenience, the extra condition x(0)=0 is imposed.

6.2.3 Scaling Properties

Suppose that we observe the motion not at intervals τ, but at intervals λτ where λ is some arbitrary number. For example, if λ=2, the increment ξ during time interval t to t+2τ will be given by ξ=ξ₁+ξ₂ where ξ₁ is the increment in time interval t to t+τ and ξ₂ is the increment in time interval t+τ to t+2τ. ξ₁ and ξ₂ are independent increments and hence the joint probability P(ξ₁:ξ₂, τ), that the first increment is the range ξ₁ to ξ₁+dξ₁ and the second increment is in the range ξ₂ to ξ₂+dξ₂ is given by

P(ξ₁:ξ₂, τ)=P(ξ₁, τ)P(ξ₂, τ)

Hence the probability density for ξ is given by integrating over all possible combinations of increments ξ₁ and ξ₂ such that ξ=ξ₁+ξ₂, i.e.

$$P ( ξ , 2 τ ) = {\int }_{- ∞}^{∞} P ( ξ - {ξ}_{1} , τ ) P ( {ξ}_{1} , τ ) ⅆ {ξ}_{1} = \frac{1}{\sqrt{4 π ρ2τ}} exp ( - \frac{{ξ}^{2}}{4 ρ2τ} )$$

Therefore, if the particle is viewed with half the time resolution, the increments are still a random Gaussian process with [symbol] ξ [symbol] =0, but with variance now given by [symbol] ξ² [symbol] =2×2ρτ, i.e. twice the value obtained when the process is viewed at intervals τ. In general, for observations at time interval λ, we obtain

$$P ( ξ , λτ ) = \frac{1}{\sqrt{4 πρλτ}} exp ( - \frac{{ξ}^{2}}{4 ρλτ} )$$

where [symbol] ξ [symbol] =0 and [symbol] ξ² [symbol] =λ×2ρτ. Note, that with τ=λτ and ξ=λ^{1/2}ξ, we have

P(ξ=λ^{1/2}ξ, τ=λτ)=λ^{-1/2}P(ξ, τ)

which is the scaling relation for the probability density. The above equation shows that the Brownian process is invariant in its statistical distribution under a transformation that changes the time scaled by a factor λ and the length scale by a factor λ^{1/2}. The name given to such transformations is affine and the curves or records that reproduce themselves in some sense under transformations of this type are called self-affine.

We may also find the probability distribution for the particle position x(t) by noting that

P[x(t)−x(t₀)]=P[x(t)−x(t₀), t−t₀]

which gives

$$P [ x ( t ) - x ( {t}_{0} ) ] = \frac{1}{\sqrt{4 πρ \vert t - {t}_{0} \vert}} exp ( - \frac{{[ x ( t ) - x ( {t}_{0} ) ]}^{2}}{4 ρ \vert t - {t}_{0} \vert} )$$

and satisfies the scaling relation

P[λ^{-1/2}, x(λt)−x(λt₀)]=λ^{-1/2}P[x(t)−x(t₀)]

In the above equation x(t₀) is the particles position at some arbitrary reference time.

Finally expressions for the mean, mean absolute and the variance of the particles position can be derived and are given respectively by

[symbol]

x(t)−x(t₀) [symbol] =0

$$⟨ \vert x ( t ) - x ( {t}_{0} ) \vert ⟩ = \sqrt{\frac{4 ρ}{π}} \vert t - {t}_{0} {\vert}^{\frac{1}{2}}$$

[symbol]

[x(t)−x(t₀)]² [symbol] =2ρ|t−t₀|

For ξ a normalised independent Gaussian random process, we then have

$$x ( t ) - x ( {t}_{0} ) ∝ ξ \vert t - {t}_{0} {\vert}^{\frac{1}{2}}$$

This result can be generalised to the form

x(t)−x(t₀)∝ξ|t−t₀|^{H}, 0<H<1

which provides the basis for Fractional Brownian Motion.

Fractional Brownian Motion is an example of statistical fractal geometry and is the basis for the coding technique discussed in the following chapter (albeit via a different approach which introduces fractional differentiation).

7 Random Fractal Coding

In this chapter, the theoretical basis is provided of Random Fractal Coding in which random fractals are used to code binary data in terms of variations in the fractal dimension such that the resulting fractal signals are characteristic of the background noise associated with the medium (HF radio, microwave, optical fibre etc.) through which information is to be transmitted. This form of ‘data camouflaging’ is of value in the transmission of sensitive information particularly for military communications networks and represents an alternative and potentially more versatile approach to the spectral broadening techniques commonly used to scramble signals.

The basic idea is to disguise the transmission of a bit stream by making it ‘look like’ background noise which spectral broadening does not attempt to do. Thus instead of transmitting a frequency modulated signal (in which 0 and 1 are allocated different frequencies), a fractal signal is transmitted in which 0 and 1 are allocated different fractal dimensions.

7.1 Introduction

The application of random fractal geometry for modelling naturally occurring signals (noise) and visual camouflage is well known. This is due to the fact that the statistical and spectral characteristics of random fractals are consistent with many objects found in nature; a characteristic which is compounded in the term ‘statistical self-affinity’. This term refers to random processes which have similar distributions at different scales. For example, a random fractal signal is one whose distribution of amplitudes remains the same whatever the scale over which the signal is sampled. Thus, as we zoom into a random fractal signal, although the pattern of amplitude fluctuations change, the probability density distribution of these amplitudes remains the same. Many noises found in nature are statistically self-affine including transmission noise.

The technique discussed in this section is based on converting bit streams into sequences of random fractal signals with the aim of making these signal indistinguishable from the background noise of the system through which information is transmitted. This method of data camouflage has applications in military communications systems in which binary data is scrambled and transmitted in a form that appears to be “like” the background “static” of the system. This relies significantly on the type and accuracy of the model that is chosen to simulate transmission noise.

8.2 Digital Communications Systems and Data Camouflaging

A Digital Communications Systems is a system that is based on transmitting and receiving bit streams (binary sequences). The basic processes involved are given below.

(i) Digital signal (speech, video etc.)

(ii) Conversion from floating point to binary form.

(iii) Modulation and transmission.

(iv) Demodulation and reception of binary sequence +transmission noise.

(v) Reconstruction of digital signal.

In the case of sensitive information, an additional step is required between stages (ii) and (iii) above where the binary form is coded according to a classified algorithm. Appropriate decoding is then introduced between stages (iv) and (v) with suitable pre-processing to reduce the effects of transmission noise for example. In addition, scrambling methods can be introduced during the transmission phase. The conventional approach to this is to apply “Spectral Broadening”. This is where the spectrum of the signal is distorted by adding random numbers to the out-of-band component of the spectrum. The original signal is then recovered by lowpass filtering. This approach requires an enhanced bandwidth but is effective in the sense that the signal can be recovered from data with a very low signal-to-noise ratio. From the view of transmitting sensitive information, the approach discussed above is ideal in that recovery of the information being transmitted is very difficult for any unauthorised reception. However, in this approach to data scrambling it is clear that information is being transmitted of a sensitive nature to any unauthorised reception. In this sense, the information is not camouflaged. The purpose of fractal coding is to try and make the information content of the transmission phase “look like” transmission noise so that any unauthorised receipt is incapable of distinguishing between the transmission of sensitive information and background “static”. For this purpose, the research reported here, has focused on the design of algorithms which encode binary sequences in terms of a unique set of fractal parameters which can then be used to produce a new digital (random fractal) signal which is characteristic of transmission noise. These fractal parameters represent main key(s) to this type of encryption. The principal criteria that have been adopted are as follows:

(i) The algorithm must produce a signal whose characteristics are compatible with a wide range of transmission noise.

(ii) The algorithm must be invertable and robust in the presence of genuine transmission noise (with low Signal-to-Noise Ratios).

(iii) The data produced by the algorithm should not require greater bandwidth than that of a conventional system.

(iv) The algorithm should ideally make use of conventional technology, i.e. digital spectrum generation (FFT), real-time correlators etc.

8.3 Models for Transmission Noise

The ideal approach for developing a model for transmission noise is to analyse the physics of a transmission system. There are a number of problems with his approach. First, the physical origins of many noise types are not well understood. Secondly, conventional approaches for modelling noise fields usually fail to accurately predict their characteristics. There are two principal approaches to defining the characteristics of a noise field:

(i) The Probability Distribution Function (PDF)—the shape or envelope of the distribution of amplitudes of the field.

(ii) The Power Spectral Density Function (PSDF) of the noise the shape or envelope of the power spectrum.

On the basis of these characteristics, nearly all noise field have two fundamental characteristics:

(i) The PSDF is characterized by irrational power laws.

(ii) The field is self-affine.

Here, we consider a phenomenological approach which is based on a power law that can be used to describe a range of PSDFs and is consistent with the signal being statistically self-affine.

We consider a PSDF of the form

$$P ( ω ) = \frac{A {ω}^{{2}_{g}}}{{( {ω}_{0}^{2} + {ω}^{2} )}^{q}}$$

where g and q are positive (floating point) numbers, A is a scaling factor and ω₀ is the characteristic frequency of the spectrum. This model is a generalisation of three distinct PSDFs used for stochastic modelling:

(i) Fractional Brownian Motion (g=0, ω₀=0)

(ii) Ornstein-Uhlenbeck model

$$( g = \frac{1}{2} , q = 1 )$$

(iii) Bermann process (q=1)

For ω>0 and q>g, the PSDF P(ω) is has as maximum when when ω=ω₀\sqrt{g/(q−g)}. The value of P(ω) at this point is

$$P ( ω ) = A {ω}_{0}^{2 ( g - g )} \frac{{g}^{g}}{{q}^{q}} {( q - g )}^{q - g}$$

Beyond this point, the PSDF decays and its asymptotic form is dominated by a ω^{-2q} power law which is consistent with random fractal signals. At low frequencies, the PSDF is characterised by the term ω^{2g}

The complex spectrum of the noise can then be written as

N(ω)=H_{gq}(ω)W(ω)

where H_{g,q} is the transfer function given by (B=\sqrt{A})

$${H}_{gq} = \frac{{B ( ⅈ ω )}^{g}}{{( {ω}_{0} + ⅈ ω )}^{q}}$$

and W(ω) is the complex spectrum of ‘Gaussian white noise’ (δ—uncorrelated noise). Here, the term ‘Gaussian white noise’ is defined conventionally as Gaussian noise (i.e. noise with a zero mean Gaussian distribution of amplitudes) whose PSDF is a constant. The noise field n(t) as a function of time t is then given by the inverse Fourier transform of N(ω), i.e.

$$n ( t ) = \frac{1}{2 π} {\int }_{- ∞}^{∞} N ( ω ) exp ( ⅈ ω t ) ⅆ ω = \frac{B}{Γ ( q )} {\int }_{- ∞}^{t} \frac{{ⅇ}^{- {ω}_{0} ( t - τ )}}{{( t - τ )}^{1 - q}} \frac{{ⅆ}^{g}}{ⅆ {τ}^{g}} ω ( τ ) ⅆ τ$$

where

$$w ( t ) = \frac{1}{2 π} {\int }_{- ∞}^{∞} W ( ω ) exp ( ⅈω t ) ⅆ ω$$

This new integral transform is an example of a fractional integral transform and contains a fractional derivative as part of its integrand.

Scaling Characteristics

The scaling characteristics of this transform can be investigated by considering the function

$$\begin{matrix}{n}^{′} ( t , {ω}_{0} ) = \frac{1}{Γ ( q )} {\int }_{- ∞}^{t} \frac{exp [ - {ω}_{0} ( t - τ ) ]}{{( t - τ )}^{1 - q}} \frac{{ⅆ}^{g}}{ⅆ {τ}^{g}} n ( λτ ) ⅆ τ \\ = \frac{{λ}^{g}}{{λ}^{q}} \frac{1}{Γ ( q )} {\int }_{- ∞}^{λ t} \frac{exp [ - \frac{{ω}_{0}}{λ} ( λ t - τ ) ]}{{( λ t - τ )}^{1 - q}} \frac{{ⅆ}^{g}}{ⅆ {τ}^{q}} n ( τ ) ⅆ τ = \frac{{λ}^{g}}{{λ}^{q}} n ( λ t , {ω}_{0} / λ )\end{matrix}$$

Hence, the scaling relationship for this model is

$$Pr [ {n}^{′} ( t , {ω}_{0} ) ] = \frac{{λ}^{g}}{{λ}^{q}} Pr [ n ( λ t , {ω}_{0} / λ ) ]$$

where Pr[ ] denotes the probability density function. Here, as we scale t by λ, the characteristic frequency ω₀ is scaled by 1/λ. The interpretation of this result, is that as we zoom into the signal ƒ(t), the distribution of amplitudes (i.e. the probability density function) remains the same (subject to a scaling factor of λ^{(g-q)}) and the characteristic frequency of the signal increases by a factor of 1/λ.

7.4 Random Scaling Fractal Signals

Given the PSDF

$$P ( ω ) = \frac{A {ω}^{2 g}}{{( {ω}_{0}^{2} + {ω}^{2} )}^{q}}$$

a random scaling fractal signal is obtained by setting g=0 and ω₀=0 We can then write

$$P ( ω ) = \frac{A}{ {ω}^{2 q}}$$

where q is defined in terms of the fractal dimension D (1<D<2) via the formula

$$q = \frac{5 - 2 D}{2}$$

This result is consistent with the spectral noise model (ignoring scaling constant A)

$$\begin{matrix}N ( ω ) = \frac{W ( ω )}{{( ⅈ ω )}^{q}} \\ n ( t ) = \hat{R} [ n ( t ) ] = \frac{1}{Γ ( q )} {\int }_{- ∞}^{t} \frac{ω ( τ )}{{( t - τ )}^{1 - q}} ⅆ τ\end{matrix}$$

which is a fractional integral transform known as the Riemann-Liouville transform. Note, that n can be considered to be a solution to the fractional stochastic differential equation

$$\frac{{ⅆ}^{q}}{ⅆ {t}^{q}} n ( t ) = ω ( t )$$

Also, the Riemann-Liouville integral has the following fundamental property

$$\begin{matrix}{n}^{′} ( t ) = \hat{R} [ ω ( λ t ) ] = \frac{1}{{λ}^{q}} n ( λ t ) \\ Pr [ {n}^{′} ( t ) ] = \frac{1}{{λ}^{q}} Pr [ n ( λ t ) ]\end{matrix}$$

which describes statistical self-affinity.

7.5 Algorithm for Computing Fractal Noise and the Fractal Dimension

The theoretical details discussed in the last section allow the following algorithm to be developed to generate fractal noise using a Fast Fourier Transform (FFT).

Step 1. Compute a pseudo-random (floating point) number sequence ωᵢ; i=0, 1, . . . , N−1 using the Linear Congruential Method discussed in Chapter 4.

Step 2. Compute the Discrete Fourier Transform (DFT) of ωᵢ giving Wᵢ (complex vector) using a standard FFT algorithm.

Step 3. Filter Wᵢ with 1/ωᵢ^{q} where q=(5−2D)/2, 1<D<2 and D—the Fractal Dimension of the signal—is defined by the user.

Step 4. Inverse DFT the result using a FFT to obtain nᵢ (real part of complex vector).

Inverse Solution

The inverse problem is then defined thus: Given nᵢ compute D. One obvious approach to this problem (one which is consistent with the theory given in Section 7.4) is to estimate D from the power spectrum of nᵢ whose expected form (for the positive half space) is

$${\hat{P}}_{i} = \frac{A}{{ω}_{i}^{β}} ; β = 2 q , {ω}_{i} > 0 ∀ i$$

Consider

e(A, β)=∥ ln Pᵢ−ln \hat{P}ᵢ∥₂²

where Pᵢ is the power spectrum of nᵢ.

Solving the equations (least squares method)

$$\frac{\partial e}{\partial β} = 0 ; \frac{\partial e}{\partial A} = 0$$

gives

$$\begin{matrix}β = \frac{N {\sum }_{i} ( ln {P}_{i} ) ( ln {ω}_{i} ) - ( {\sum }_{i} ln {ω}_{i} ) ( {\sum }_{i} ln {P}_{i} )}{N {\sum }_{i} {( ln {ω}_{i} )}^{2} - {( {\sum }_{i} ln {ω}_{i} )}^{2}} and \\ A = exp ( \frac{{\sum }_{i} ln {P}_{i} + β {\sum }_{i} ln {ω}_{i}}{N} )\end{matrix}$$

The algorithm required to implement this inverse solution can therefore be summarised as follows:

Step 1. Compute the power spectrum Pᵢ of fractal noise nᵢ using a FFT.

Step 2. Extract the positive half space data.

Step 3. Compute β using the formula above.

Step 4. Compute the Fractal Dimension D=(5−β)/2.

This algorithm provides a reconstruction of D that is on average accurate to 2 decimal places for N>64.

7.6 Fractal Coding of Binary Sequences

The method of coding involve generating fractal signals in which two fractal dimensions are used to differentiate between a zero bit and a non-zero bit. The technique is outlined below.

(i) Given a binary sequence, allocate Dₘᵢₙ to bit=0 and Dₘₐₓ to bit=1.

(ii) Compute a fractal signal of length N for each bit in the sequence.

(iii) Combine the results to produce a continuous stream of fractal noise.

In each case, the number of fractals per bit can be increased. This has the result of averaging out the variation in the estimates of the fractal dimensions. The information retrieval problem is then solved by computing the fractal dimensions using the Power Spectrum Method discussed in Section 7.5 using a conventional moving window principle to given the fractal dimension signature Dᵢ. The binary sequence is then obtained from the following algorithm: Given that

$$Δ = {D}_{min} + \frac{{D}_{max} - {D}_{min}}{2}$$

if

Dᵢ≦Δ

then bit=0

else

if Dᵢ>Δ

then bit=1

The principal criteria for the optimization of this coding technique (the basis for numerical experiments) is to minimize $D_\rm max-D_\rm min$ subject to accurate reconstruction in the presence of real transmission noise.

9. Overview of the Algorithm

9.1 Encryption

The data enciphering algorithm reported in this work uses the Random or Chaotic number generator discussed in Chapters 4 and 5 respectively and the Fractal Coding method discussed in Chapter 7. The algorithm consists of the following steps which provide a general description of each stage of the encryption and decryption process.

9.1.1 Encryption Using Runlength Coding

(i) Assuming the data has been transformed into a bit pattern, segments are extracted where values of the bits are the same, e.g. the bit sequence “011110000” is segmented into three regions as “0”, “1111”, “0000”. At this stage, the maximum number of bits in any region P is determined. In order to efficiently store the resulting data, this number must be power of 2. The type of each segment (i.e. whether it consists of 0's or 1's) is also stord for future use.

(ii) The total number of segments N is calculated.

(iii) The number of bits in each region is calculated. Using the example above, we get “1’, “4’, “4’. Note, the size of all segments are in the range [1,P].

9.1.2 Encryption by Using Chaotic and Psuedo Random Numbers

(iv) A sequence of random numbers of length N is generated using a psuedo random number generator or a chaos generator and normalised so that all floating point numbers are in the range [0, 1]. (Negative numbers are not considered because it is not strictly necessery to use them and they require one more bit to store and sign.) These numbers are then scaled and converted into (nearest) integers. The scale can be arbitrary. However, if the maximum value of the sequence is Q−1, then log₂Q log₂ᵢᵢᵢQ bits are required to store any number from the sequence. Thus in order to efficiently use these bits, Q should be a power of 2.

(v) The numbers from both sequences (i.e. those obtained from run length coding Kᵢ and the random integer sequence Rᵢ are added together to give a third sequence Dᵢ=Kᵢ+Rᵢ. The numbers associated with these new sequence fall into the range[0,P+Q]

(vi) Each integer in the sequence Dᵢ is transformed into its corresponding binary form i.e. to fill some binary field with corresponding data. To store any number, the bit field is required to be of length log₂(Q+P). A further bit is required to store the type (0 or 1). For this purpose the leftmost or rightmost bit of field can be used. It is necessery to use fields of the same size even if some numbers do not fill it completely, otherwise it is not possible to distinguish these combined bit fields during deciphering. The unnecessary bits are filled with 0's.

(vii) The binary fields are concatenated to give a continuous bit stream.

9.1.3 Camouflaging Bit Streams Using Fractal Coding.

Once the bit stream has been coded [steps (i)-(vii)]it can be camouflaged using the fractal coding scheme discussed in Chapter8. This is important in cases where the transmission of information is required to “look like” the background noise of a system through which information is transmitted. This method involves generating fractal signals in which two fractal dimensions are used to differentiate between a zero bit and a non-zero bit and would in practice replace the frequency modulation (and demodulation) that is currently used in digital communications systems. The basic steps involved are given below for completeness.

(viii) For bit=0 chose a minimum fractal dimension Dₘᵢₙ and for to bit=1 allocated a maximum fractal dimension Dₘₐₓ

(ix) Generate a fractal signal of length N (a power of 2) for each bit in the bit stream.

(x) Concatinate all fractal associate with each bit and transmit.

9.2 Decryption

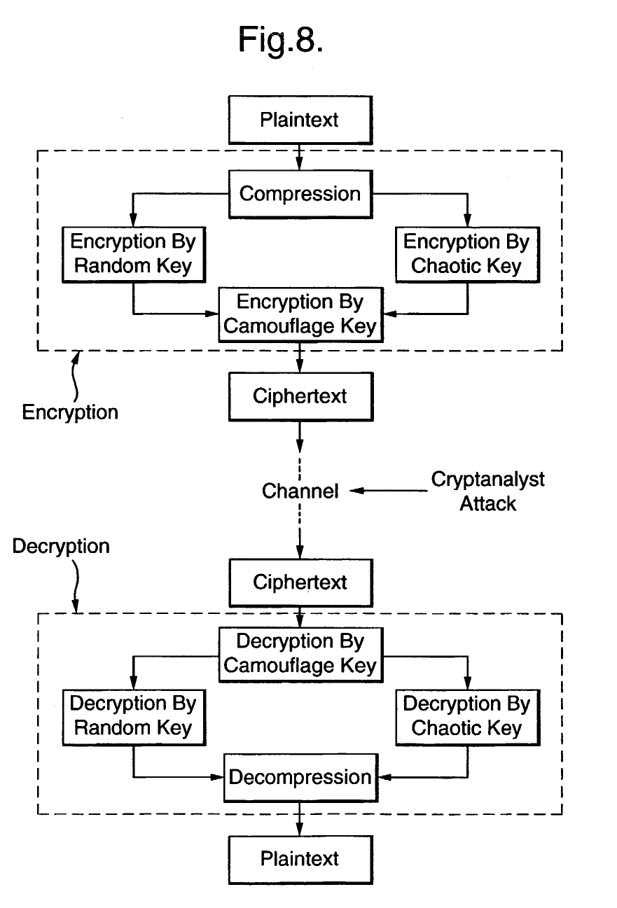

Decryption of the transmitted fractal signal is obtained using the methods discussed in Section 7.5 to recover the fractal dimensions and thus the coded bit stream. Reconstructing the original binaray sequence from the coded bit stream is then obtained using the inverse of the steps (i)-(vii) given above. This is illustrated in an example given in the following Chapter. A simple high level data flow diagram of this method of encryption is given in FIG. 8

10 Prototype Software System—DECFC

In this chapter, a brief summary is given of a prototype software package (Data Encryption and Camouflage using Fractal and Chaos—DECFC) that has been written to investigate the theoretical principles and algorithmic details presented so far. A detailed discussion of the systems and its software engineering is beyond the scope of this report. The system has been written primarily to research the numerical performanceof the techniques developed and as a work-bench for testing out new ideas.

10.1 Hardware Requirements

In its present form DECFC only requires an IBM PC/AT, or a close compatible, whichis running the MS-DOS or PC-DOS operating system, version 2.0 or above. DECFC requires approximately 4M of RAM over and above the operating system requirements. If the available PC has more than this minimum hardware configuration, then it should not cause any problems. Memory is required over and above the size of this executable file for the system stack.

10.2 Software

DECFC encrypts and decrypts input data. It is a parameter driven operating system utility, i.e. whenever DECFC is executed, it inspects the parameters passed to it and determines what action should be taken. The process of encryption uses a secret encrypted state. Secure key management is at the heart of any encryption system, and DECFC employs the best possible key management techniques that can be achieved with a symmetric encryption algorithm. Key management facilities are all accessed by activating menus available. Encryption and decryption are both performed using a commandline interpreter which can extract the chosen parameters from the DECFC command line. Encryption and decryption are, therefore, ideally suited to batch file operation.where complex file manipulations can be achieved by simply executing the appropriate batch file.

A two key management is used which contains chaotic or psuedo random encryption key and the camouflage encryption key. Two encryption keys are required for thispurpose. This process has the same effect, in cryptographic strength terms, as using adouble length encryption key. Each single decipherment is replaced by the followingprocess: (i) encipher with Chaotic or Random key; (ii) encipher with Camouflage key.

Decryption is similarly achieved using: (i) decipher with chaotic or random key; (ii) decipher with camouflage key.

The camouflage key is stored in encrypted form in a data. It is important to take particular care to ensure that this data is not available to unauthorised users.

Implementing encryption as a software package has the major advantage thatthe encryption process itself is not a constituent part of the process used to transmit the data. An encrypted message or data file can, therefore, be sent via any type ofmedium. The method of transport does notaffect the encryption. Once received, the data is decrypted using the appropriateencryption key. The original software (i.e. module library) has beendeveloped using Borland Turbo C++ (V3) compiler making extensive use of thegraphics functions available. Attempts have been made to provide clear self-commenting software.

10.3 Command Line Switches

The various facilities available within DECFC are activated by command lineswitches. A single letter acts as a switch character to tell DECFC the type ofcommand to be invoked. Upper and lower case has no significance for the switch characters. These switches are activated by entering the single first letter directly after the prompt from numeric keys. Once activated, they remain active until changed. The command line is passed and acted upon sequentially. The function of each of the command line switch characters is explained briefly below.

| | |
|---|---|
| Main menu choices | |
| G—Generate: | Generate the user required signal |
| L—Load sig: | Load the signal from the saved file |
| Q—Quit: | Quit the program\it Generate menu choices |
| P—Parameters: | Extract the signal parameters |
| E—Encode: | Execute the code menu |
| G—Generate: | Generate the encrypted signal |
| D—Decode: | Decrypt the signal |
| B—Back: | Return to the main menu |
| Code menu choices | |
| M—Manual: | Generate the manual binary code |
| R—Random: | Generate the random binary code |
| L—Load Code: | Generate the encrypted code by |
| | Random key or Chaotic key |
| B—Back: | Return back to the code menu |
| Key menu choices: | |
| R—Random key: | Create the Random key by user |
| C1—Chaotic key: | Create the Chaotic key by user |
| C2—Camouflage key: | Create the Camouflage key by user |

10.4 Windows

All the information produced by the DECFC system is contained within one of the five “windows” (boxed in areas of the screen). Each window has a designated function which is described below.

Menu Window. Menu choices are presented to the user in this window and information on the input and output binary sequences given.

Parameter Window. The fractal parameters are displayed for the user in this window. It provides information on the fractal size, fractals/bit, low fractal dimension and high fractal dimension which are either chosen be the use or given default values.

Code Window. Input binary data before and after reconstruction is displayed in this window. The reconstructed sequence is superimposed on the original code (dotted line). The original binary sequence and the estimated binary sequence are displayed with red and green lines respectively.

Signal Window. In this window, data encrypted by random numbers or chaotic numbers andcamouflage coding is displayed for analysis by the user.

Fractal Dimensions Window. In this window, original and reconstructed fractal dimensions are displayed for analysis by the user.

10.5 Example Results

This section provides a step-by-step example of the encryption system for a simple example input.

Encryption

With the execution of the program, the first step is to enter the seed for thepsuedo random number generator which can be any positive integer. This parameter is used to generate the Gaussian white noise used for computing the fractal signals.

Input data can then be generated either by loading it from a file. In this example, we consider the input

xc

The system transforms the characters into ASCII codes

120 99

and from the ASCII codes into a bit sequence

0111100001100011

This bit field is then segmented into fields which consist ofbits of one kind

| | | | | | |
|---|---|---|---|---|---|
| 0 | 1111 | 0000 | 11 | 000 | 11 |

The number of field $N$ is then computed.

N=6

The number of bits in each field is then obtained ($K_{—}0,K_{—}1, . . . ,K_N$) 144232

A sequence of psuedo-random or chaotic integers ($R_{—}0, R_{—}1, . . . ,R_N$) of length $N$ is then obtained to scamble the data.

Random key=1;

602067

These number sequences are then added together to give the$D_i=K_i+R_i,\h

i=0,1, . . . ,N$\startcode\

$$1 \; 4 \; 4 \; 2 \; 3 \; 2 \\ + \underline{6 \; 0 \; 2 \; 0 \; 6 \; 7}$$

$$7 \; 4 \; 6 \; 2 \; 9 \; 9$$

Each number of the resulting sequence is transformed to itsbinary equivalent

0000111 0000100 0000110 0000010 0001001 0001001

Concatenating the resulting bit fields into a single bit stream, we obtain

000011100001000000110000001000010010001001

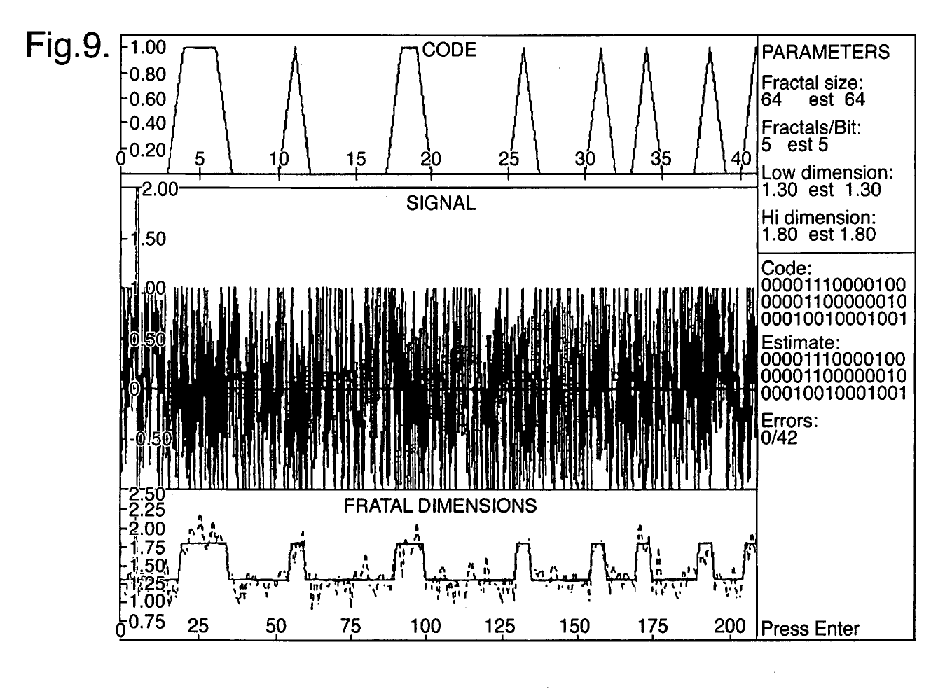

This encrypted data is shown graphically in FIG. 9 (CODE).

The bit stream can now be submitted to the fractal coding algorithm In this example, the default values of the fractal parameters are used (these values represent the fractal coding key).

Fractal size=64 Fractals

Bit=5

Low dimension=1.60

High dimension=1.90

In this case, five fractal signals, each of length 64 for each bit are computed and concatinated. This provide the fractal signal shown in the fractal window of FIG. 9.

Decryption

The information retrieval problem is solved by computing the fractal dimensionsusing the Power Spectrum Method discussed in Chapter 7 using a conventional moving window principle (Fractal Dimension Segmentation) to give the fractal dimension signature Dᵢ.

The binary sequence is then obtained from the following algorithm:

If Dᵢ≦Δ then bit=0

If Dᵢ>Δ then bit=1.

Where

Δ=Dₘᵢₙ+(Dₘₐₓ−Dₘᵢₙ)/2

The reconstructed fractal dimensions are shown in the fractal parameters window. The estimated binary sequence is displayed in the Menu Windowon the of FIG. 9 (“Estimate:’)

FIG. 9 Example of the output of the DECFC system

This estimated binary code after reconstruction is

000011100001000000110000001000010010001001

This bit stream is then segmented into 7 bit fields

| | | | | | |
|---|---|---|---|---|---|
| 000011 | 0000100 | 0000110 | 0000010 | 0001001 | 0001001 |

and transformed into the following integer sequence

7 4 6 2 9 9

Regenerating the random integer sequence (using the same Random key)and subtracting them from the integer sequence above we obtain

$$\begin{matrix}7 \; 4 \; 6 \; 2 \; 9 \; 9 \\ \underline{6 \; 0 \; 2 \; 0 \; 6 \; 7}\end{matrix}$$

$$\underline{ 1 \; 4 \; 4 \; 2 \; 3 \; 2}$$

Each integer is then convereted into its corresponding bit form.

| | | | | | |
|---|---|---|---|---|---|
| 0 | 1111 | 0000 | 11 | 000 | 11 |

and concatinated into the following bit pattern. 0111100001 100011 Changing this bit sequence of into decimal form we obtain theASCII codes

| | |
|---|---|
| 120 | 99 |

and finally, transforming this ASCII codes into output characters, we reconstruct the original two-character set xc.

11 Conclusions and Recommendations For Future Work

11.1 Conclusions

The purpose of this report has been to give an overview of encryption techniques and to discuss the uses of Fractals and Chaos in data security.

Two principal areas have been considered:

(i) The role of chaos generating algorithms for producing psuedo-random numbers.

(ii) The application of the theorey of random scaling fractal signals coding and camouflaging bit streams.

Only one chaos generationg algorithm has been considered based on the Vurhulst process in order to test out some of the ideas presented. The method of fractal signal generation and fractal dimension segmentationis also only one of fractal signal generation and fractal dimension segmentationis also only one of many numerical approaches that could be considered buthas been used effectively in this work to demonstarte the principles of fractal coding.

11.2 Recommendations For Future Work

Data Compression

As discussed in Chapter 4, there are many binary data compression techniques, but there are three main standards. First, there is a standard applied specifically to videoconferencing called H.261 (or, sometimes, px64) and has been formulated by the European Commission's Consultative Committee on International Telephony and Telegraphy (CCITT). Second is the Joint PhographicExperts Group (JPEG) which has now effectively created a standard for compressing still images. The third is called the Motion Picture Experts Group (MPEG). As the name suggests, MPEG seeks to define a standard for coding moving images and associated audio.

While standard schemes are likely to dominate the industry, there is still roomfor others. The most important is a scheme relying on a profound level of redndancyin form and shape in the natural word. It uses an approach known as Fractal Compression.

Future research in this area of work should include the applications of different data compression schemes and their use in the encryption techniques discussed in this report which has only considered runlength coding.

Chaos Generation

The advantages and diasvantages of using a chaos generator instead of a conventional pseudo-random number generator have not yet been fully investigated. The must include a complete study of the statistics associated with chaos based random number generators. Since there is an unlimited number of possible chaos generators to choose from, it might be possible to develop an encryption scheme which is based on a random selection of different chaos generating iterators, This approach could be integrated into a key hierarchy at many different levels.

Fractal Coding

The fractal noise model used in the coding operation is consistent with many noise types but is not as general as using a Power Spectral Density Function (PSDF) of the type

$$P(\omega)=A\omega\hat{ }2g\over (\omega_{—}0\hat{ }2+omega\hat{ }2)\hat{ }q$$ to describe the noise field.

Further work is now required to determine the PSDFs of different transmission noises and to quantify them in terms of the parameters q, g and ω₀. In cases where the transmission noise is dominated by a PSDF of the form ω^{2q} the fractal model used here is sufficient. The development of a coding technique based on the parameters q, g and ω₀ could provide a greater degree of flexibility and allow the noise field to be tailored to suit a wider class of data transmission systems. The value of such a scheme with regard to the extra computational effort require to develop a robust inverse solution (i.e. recover the parameters q, g and ω₀) is a matter for further research.

### SECTION 4

Title: “Improvements in or Relating to Image Processing”

THIS INVENTION relates to image processing and relates, more particularly, to a method of and apparatus for deriving from a plurality of “frames” of a video “footage”, a single image of a higher visual quality than the individual frames.

Anyone who has access to a conventional analogue video tape recorder with aframe freeze facility will be aware that the visual quality of a single frame in atypical video recording is subjectively significantly inferior to thenormally viewed (moving) video image. To a significant extent, of course, the quality of the (moving) video image provided by a domestic videorecorder is already significantly lower than that provided by directconversion of a typical of a transmitted TV signal, simply because of thereduced bandwidth of the video recorder itself, but nevertheless the factthat, to the human observer, the quality of the recorded video image seemsmuch better than that of the individual recorded frames suggests that thehuman eye/brain combination is, in effect, integrating the information froma whole series of video frames to arrive at a subjectively satisfying visual impression. It is one of the objects of the present invention to provide apparatus and a method for carrying out an analogous process to arrive at a “still” image, from a section of video footage, which is of significantly better visual quality than the individual “frames” of the same video footage.

According to one aspect of the present invention there is provided a method of processing a section of video “footage” to produce a “still” view of higher visual quality than the individual frames of that footage, comprising sampling, over a plurality of video “frames”, image quantities (such as brightness and hue or colour) for corresponding points over such frames, and processing the samples to produce a high quality “still” frame.

According to another aspect of the invention there is provided apparatus for processing a section of video footage to produce a “still” view of higher visual quality than the individual frames of that footage, the apparatus comprising means for receiving data in digital form corresponding to said frames, processing means for processing such data and producing digital data corresponding to an enhanced image based on such individual frames, and means for displaying or printing said enhanced image.

In the preferred mode of carrying out the invention, the video informationis processed digitally and accordingly, except where a digitised videosignal is already available, (for example, where the video signal is adigital TV signal or a corresponding video signal or comprises videofootage which has been recorded digitally) apparatus for carrying outthe invention may comprise means, known per se, for digitising analoguevideo frames or analogue video signals, whereby, for example, each videoframe is notionally divided up into rows and columns of “pixels” and digital data derived for each pixel, such digital data representing, for example, brightness, colour, (hue), etc. The invention may utilisevarious ways of processing the resulting data. For example, in one methodin accordance with the invention, the brightness and colour data for eachof a plurality of corresponding signals in a corresponding plurality ofsuccessive video frames, for example four or five successiveframes, may simply be averaged, thereby eliminating much high-frequency “noise”, (i.e. artefacts appearing only in individual frames and whichare not carried over several frames). In a situation where the sequenceof frames concerned was a sequence with minimal camera or subject movement, the “average” frame might correspond, noise reduction apart, with the video frame in the middle of that sequence. The processing apparatus is preferably also programmed to reject individual frames which differ significantly from this average and/or to determine when an “average” frame derived as indicated is so deficient in spatial frequencies in a predetermined range as to indicate that a sequence of frames selected encompasses a “cut” from one shot to another and so on. Thus a considerable amount of “pre-processing” is possible to ensure, as far as possible, that the frames actually processed are as little different from one another in picture content as possible. The views thus processed andaveraged may also be subjected to contrast enhancement and/or boundary/edgeenhancement techniques before further processing, or the further processingmay be arranged to effect any necessary contrast enhancement as well as enhancement in other respects. Section 4 of Part 2 of this section sets out in mathematical terms the techniques and algorithms which are preferably utilised in such further processing, as does Appendix A to said Part 2. Sections 1 to 3 of Part 2 of this Section provides background to Section 4 and discloses further techniques which may be utilised. All of these techniques are, of course, preferably implemented by means of a digital computer programmedwith a program incorporating steps which implement and correspond to themathematical procedures and steps set out in Part 2 of this Section.

It will be understood that the program followed may include variousrefinements, for example, adapted to identify “mass” displacement of pixelvalues from frame to frame due to camera movement or to movement of amajor part of the field of view, such as a moving subject, relative tothe camera, to identify direction of relative movement and use thisinformation in “de-blurring” efficiently, and also to take intoaccount the (known) scanning mechanism of the video system concerned, (in the case of TV or similar videofootage). The techniques used may include increase in the pixel density of the“still” image as compared with the digitised versions of the individual video frames (a species of the image reconstruction and super resolution referred to in Part 2 of this Section). Thus, in effect, the digitised versions of the individual video frames may be re-scaled to a higher density and image quantities for the “extra” pixels obtained by a sophisticated form of interpolation of values for adjoining pixels in the lower pixel density video frames.

Whilst it is envisaged that a primary use of the invention may be in derivingvisually acceptable “stills” from electronic video material, it will be understood that similar techniques can be applied to film material on “celluloid”. Furthermore, by applying the techniques in accordance with the invention tosuccessive sequences of, say, six or seven frames in succession, with theselected sequence of five or six frames being advanced by one frame at a time,(with appropriate allowance being made, as referred to above, for “cuts”, “fades”, and like cinematic devices), the invention may be applied to, for example, the restoration of antique film stock.

### PART 2

Inverse Problems and Deconvolution:

An Introduction to Image Restoration and Reconstruction

Summary

All image formation systems are inherently resolution limited. Moreover, many images are blurred due to a variety of physical effects such as motion in the object or image planes, the effects of turbulence and refraction and/or diffraction.

When an image is recorded that has been degraded in this manner, a number of digitalimage processing techniques can employed to “de-blur” the image andenhance its information content. Nearly all ofthese techniques are either directly or indirectly based on a mathematical model for the blurred imagewhich involves the convolution of two functions—the Point Spread Functionand the Object Function. Hence, “de-blurring” an image amounts to solving the inverse problem posed by this model which is known as “Deconvolution”. Image restoration attempts to provide a resolution compatible with the bandwidth of the imaging system (a resolution limited system). Image reconstruction attempt to provide a resolution that is greater than the inherent resolution of the data (i.e. the resolution limit of the imaging system). This is often known as super resolution. In addition to this general problem, there is the specific problem of reconstructing an image from a set of projections; a problem which is the basis of Computed Tomography and quantified in termsof an integral transform known as the Radon transform.

With regard to the discussion above, the aim of this document is to discuss:

(i) basic methods of solution;

(ii) essential algorithms;

(iii) some applications

| Notation | |
|---|---|
| BL | Band Limited |
| DFT | Discrete Fourier Transform |
| IDFT | Inverse Discrete Fourier Transform |
| FFT | Fast Fourier Transform |
| SNR | Signal-to-Noise Ratio |
| [symbol] [symbol] | 2D Convolution Operation |
| ⊙⊙ | 2D Correlation Operation |
| \hat{B} | Back-Projection Operator |
| E | Entropy |
| \hat{F}₁ | 1D Fourier Transform Operator |
| \hat{F}₁⁻¹ | Inverse iD Fourier Transform Operator |
| \hat{F}₂ | 2D Fourier Transform Operator |
| \hat{F}₂⁻² | Inverse 2D Fourier Transform Operator |
| Ĥ | Hilbert Transform Operator |
| \hat{R} | Radon Transform Operator |
| \hat{R}⁻¹ | Inverse Radon Transform Operator |
| P | Projection |
| δ | 1D Delta Function |
| δ² | 2D Delta Function |
| κ | 2D Spatial Frequency Vector |
| kₓ, k_{y} | Spatial Frequency Vectors |
| η | 2D Unit Vector |
| Γ | 2D Space Vector |
| ∀ | ‘Forall’ |
| sinc | sinc function sinc( [symbol] ) = sin( [symbol] )/ [symbol] |
| fᵢⱼ | Object Function |
| \hat{f}ᵢⱼ | Least Square Estimate of fᵢⱼ |
| nᵢⱼ | Noise Function |
| pᵢⱼ | Point Spread Function |
| sᵢⱼ | Recorded Signal/Image |
| cᵢⱼ | Correlation Function |
| Fᵢⱼ | DFT of fᵢⱼ |
| \hat{F}ᵢⱼ | DFT of \hat{f}ᵢⱼ |
| Nᵢⱼ | DFT of nᵢⱼ |
| Pᵢⱼ | DFT of pᵢⱼ |
| Pᵢ^{*}ⱼ | Complex Conjugate of Pᵢⱼ |
| Sᵢⱼ | DFT of sᵢⱼ |
| Cᵢⱼ | DFT of cᵢⱼ |

1. Introduction

The field of information science has brought about some of the most dramatic and important scientific development of the past twenty years. This has been due primarily to the massive increase in the power and availability of digital computers. One area of information technology which has grown rapidly as a result of this, has been digital signal and image processing. This subject has become increasingly important because of the growing demand to obtain information about the structure, composition and behaviour of objects without having to inspect them invasively. Deconvolution is a particularly important subject area in signal and image processing. In general, this problem is concerned with the restoration and/or reconstruction of information from known data and depends critically on a priori knowledge on the way in which the data (digital image for example) has been generated and recorded. Mathematically, the data obtained are usually related to some ‘Object Function’ via an integral transform. In this sense, deconvolution is concerned with inverting certain classes of integral equation—the convolution equation. In general, there is no exact or unique solution to the image restoration/reconstruction problem—it is an ill-posed problem. We attempt to find a ‘best estimate’ based on some physically viable criterion subject to certain conditions.

The fundamental imaging equation is given by

s=p [symbol] [symbol] ƒ+n

where s, p, ƒ and n are the image, the Point Spread Function (PSF), the Object Function and the noise respectively. The symbol [symbol] [symbol] denotes 2D convolution. The imaging equation is a stationary model for the image s in which the (blurring) effect of the PSF at any location in the ‘object plane’ is the same. Using the convolution theorem we can write this equation in the form

S=PF+N

where S, P, F and N are the (2D) Fourier transforms of s, p, ƒ and n respectively. Assuming that F is a broadband spectrum, there are two cases we should consider:

(i) P(kₓ, k_{y})→0 as (kₓ, k_{y})→∞ where kₓ and k_{y} are the spatial frequencies in the x and y directions respectively. The image restoration problem can then be stated as ‘recover F given S’.

(ii) P(kₓ, k_{y}) is bandlimited, i.e. P(kₓ, k_{y})=0 for certain values of kₓ and/or k_{y}. The image reconstruction problem can then be stated as ‘given S reconstruct F’. This typically requires the frequency components to be ‘synthesized’ beyond the bandwidth of the data. This is a (spectral) extrapolation problem

The image restoration problem can typically involve finding a solution for ƒ given that s=p [symbol] [symbol] ƒ+n where p is a Gaussian PSF given by (ignoring scaling)

p(x, y)=exp[−(x²+y²)/σ²]

(σ being the standard deviation) which has a spectrum of the form (ignoring scaling)

P(kₓ, k_{y})=exp[−σ²(kₓ²+k_{y} ²)]

This PSF is a piecewise continuous function as is its spectrum.

An example of an image reconstruction problem is ‘find ƒ given that s=p [symbol] [symbol] ƒ+n’ where p is given by (ignoring scaling)

p(x, y)=sinc(αx) sinc(βy)

This PSF has a spectrum of the form (ignoring scaling)

P(kₓ, k_{y})=H_{α}(kₓ)H_{β}(k_{y})

where

$${H}_{α} ( {k}_{x} ) = \{ \begin{matrix}1 & \vert {k}_{x} \vert \leq α \\ 0 & \vert {k}_{x} \vert > α\end{matrix} {H}_{β} ( {k}_{y} ) = \{ \begin{matrix}1 & \vert {k}_{y} \vert \leq β \\ 0 & \vert {k}_{y} \vert > β\end{matrix}$$

It is a piecewise continuous function but its spectrum is discontinuous, the bandwidth of p [symbol] [symbol] ƒ of being given by α in the x direction and β in the y direction.

2. Restoration of Blurred Images

To put the problem in perspective, consider the discrete case, i.e.

sᵢⱼ=pᵢⱼ [symbol] [symbol] ƒᵢⱼ+nᵢⱼ

where sᵢⱼ is a digital image. Suppose we neglect the term nᵢⱼ, then

sᵢⱼ=pᵢⱼ [symbol] [symbol] ƒᵢⱼ

or by the (discrete) convolution theorem

Sᵢⱼ=PᵢⱼFᵢⱼ

where Sᵢⱼ, Pᵢⱼ and Fᵢⱼ and the DFTs of sᵢⱼ, pᵢⱼ and ƒᵢⱼ respectively. Clearly,

$${F}_{ij} = \frac{{S}_{ij}}{{P}_{ij}}$$

and therefore

$${f}_{ij} = IDTF ( \frac{{S}_{ij}}{{P}_{ij}} )$$

$$\frac{1}{{P}_{ij}} = \frac{{P}_{ij}^{*}}{{\vert {P}_{ij} \vert}^{2}}$$

which is called the Inverse Filter.

Suppose, we were to implement this result on a digital computer; if Pᵢⱼ approached zero (in practice a very small number) for any value of i and/or j then depending on the compiler, the computer would respond with an output such as ‘ . . . arithmetic fault . . . divide by zero’. A simple solution would be to regularize the result, i.e. use

$${f}_{ij} = IDTF ( \frac{{P}_{ij}^{*} {S}_{ij}}{{\vert {P}_{ij} \vert}^{2} + constant} )$$

and ‘play around’ with the value of the constant until ‘something sensible’ was obtained which in turn would depend on the a priori information available on the form and support of ƒᵢⱼ. The regularization of the inverse filter is the basis for some of the methods which are discussed in these notes. We start by considering the criterion associated with the inverse filter.

2.1 The Inverse Filter

The criterion for the inverse filter is that the mean square of the noise is a minimum. Since

sᵢⱼ=pᵢⱼ [symbol] [symbol] ƒᵢⱼ+nᵢⱼ

we can write

nᵢⱼ=sᵢⱼ−pᵢⱼ [symbol] [symbol] ƒᵢⱼ

and therefore

e=∥nᵢⱼ∥²=∥sᵢⱼ−pᵢⱼ [symbol] [symbol] ƒᵢⱼ∥²

where

$$‖ {x}_{ij} ‖ ≡ {( {\sum }_{i}^{} {\sum }_{j}^{} {x}_{ij}^{2} )}^{\frac{1}{2}}$$

For the noise to be a minimum, we require

$$\frac{\partial e}{\partial {f}_{ij}} = 0$$

Differentiating (see Appendix A), we obtain

(sᵢⱼ−pᵢⱼ [symbol] [symbol] ƒᵢⱼ)⊙⊙pᵢⱼ=0

Using the convolution and correlation theorems, in Fourier space, this equation becomes

(Sᵢⱼ−PᵢⱼFᵢⱼ)P*ᵢⱼ=0

Hence, solving for Fᵢⱼ we obtain the result

$${F}_{ij} = \frac{{P}_{ij}^{*}}{{\vert {P}_{ij} \vert}^{2}} {S}_{ij}$$

The inverse filter is therefore given by

$$Inverse Filter = \frac{{P}_{ij}^{*}}{{\vert {P}_{ij} \vert}^{2}}$$

In principle, the inverse filter provides an exact solution to the problem when the noise term nᵢⱼ can be neglected. However, in practice, this solution is fraught with difficulties. First, the inverse filter is invariably a singular function. Equally bad, is the fact that even if the inverse filter is not singular, it is usually ill conditioned. This is where the magnitude of Pᵢⱼ goes to zero so quickly as (i, j) increases, that 1/ |Pᵢⱼ|² rapidly acquires extremely large values. The effect of this is to amplify the (usually) noisy high frequency components of Sᵢⱼ. This can lead to a restoration ƒᵢⱼ which is dominated by the noise in sᵢⱼ. The inverse filter can therefore only be used when:

(i) The filter is non-singular.

(ii) The SNR of the data is very large (i.e. ∥pᵢⱼ [symbol] [symbol] ƒᵢⱼ∥>>∥nᵢⱼ∥).

Such conditions are rare. A notable exception occurs in Computed Tomography which is covered in Section 5 of these notes in which the inverse filter associated with the ‘Back-Project and Deconvolution’ algorithm is non-singular.

The computational problems that arise from implementing the inverse filter can be avoided by using a variety of different filters whose individual properties and characteristics are suited to certain types of data. One of the most commonly used filters for image restoration is the Wiener filter which is considered next.

2.2 The Wiener Filter

An algorithm shall be derived for deconvolving images that have been blurred by some lowpass filtering process and corrupted by additive noise. In mathematical terms, given the imaging equation

sᵢⱼ=pᵢⱼ [symbol] [symbol] ƒᵢⱼ+nᵢⱼ (2.1)

the problem is to solve for ƒᵢⱼ given sᵢⱼ, pᵢⱼ and some knowledge of the SNR. This problem is solved using the least squares principle which provides a filter known as the Wiener filter.

The Wiener filter is based on considering an estimate \hat{ƒ}ᵢⱼ for ƒᵢⱼ of the form

\hat{ƒ}ᵢⱼ=qᵢⱼ [symbol] [symbol] sᵢⱼ (2.2)

Given this model, our problem is reduced to computing qᵢⱼ or equivalently its Fourier transform Qᵢⱼ. To do this, we make use of the error

$$e = {‖ {f}_{ij} - {\hat{f}}_{ij} ‖}^{2} ≡ {\sum }_{i}^{} {\sum }_{j}^{} {( {f}_{ij} - {\hat{f}}_{ij} )}^{2} \qquad ( 2.3 )$$

and find qᵢⱼ such that e is a minimum, i.e.

$$\frac{\partial e}{\partial {q}_{ij}} = 0$$

Substituting equation (2.2) into equation (2.3) and differentiating, we get

$$\frac{\partial e}{\partial {q}_{kl}} = - 2 {\sum }_{i}^{} {\sum }_{j}^{} ( {f}_{ij} - {\sum }_{n}^{} {\sum }_{m}^{} {s}_{i - n , j - m} {q}_{n m} ) \frac{\partial }{\partial {q}_{kl}} {\sum }_{n}^{} {\sum }_{m}^{} {s}_{i - n , j - m} {q}_{n m} = - 2 {\sum }_{i}^{} {\sum }_{j}^{} ( {f}_{ij} - {\sum }_{n}^{} {\sum }_{m}^{} {s}_{i - n , j - m} {q}_{n m} ) {s}_{i - k , j - l} = 0$$

Rearranging, we have

$${\sum }_{i}^{} {\sum }_{j}^{} {f}_{ij} {s}_{i - k , j - l} = {\sum }_{i}^{} {\sum }_{j}^{} ( {\sum }_{n}^{} {\sum }_{m}^{} {s}_{i - n , j - m} {q}_{n m} ) {s}_{i - k , j - l}$$

The left hand side of the above equation is a discrete correlation of ƒᵢⱼ with sᵢⱼ and the right hand side is a correlation of sᵢⱼ with the convolution

$${\sum }_{n}^{} {\sum }_{m}^{} {s}_{i - n , j - m} {q}_{n m}$$

Using operator notation, it is convenient to write this equation in the form

ƒᵢⱼ⊙⊙sᵢⱼ=(qᵢⱼ [symbol] [symbol] sᵢⱼ)⊙⊙sᵢⱼ

Moreover, using the correlation and convolution theorems, the equation above can be written in Fourier space as

FᵢⱼS*ᵢⱼ=QᵢⱼSᵢⱼS*ᵢⱼ

which, after rearranging gives

$${Q}_{ij} = \frac{{S}_{ij}^{*} {F}_{ij}}{{\vert {S}_{ij} \vert}^{2}}$$

Now, in Fourier space, equation (2.1) becomes

Sᵢⱼ=PᵢⱼFᵢⱼ+Nᵢⱼ

Using this result, we have

$${S}_{ij}^{*} {F}_{ij} = {( {P}_{ij} {F}_{ij} + {N}_{ij} )}^{*} {F}_{ij} = {P}_{ij}^{*} {\vert {F}_{ij} \vert}^{2} + {N}_{ij}^{*} {F}_{ij}$$

and

$${\vert {S}_{ij}^{*} \vert}^{2} = {S}_{ij} {S}_{ij}^{*} = ( {P}_{ij} {F}_{ij} + {N}_{ij} ) {( {P}_{ij} {F}_{ij} + {N}_{ij} )}^{*} = {\vert {P}_{ij} \vert}^{2} {\vert {F}_{ij} \vert}^{2} + {P}_{ij} {F}_{ij} {N}_{ij}^{*} + {N}_{ij} {P}_{ij}^{*} {F}_{ij}^{*} + {\vert {N}_{ij} \vert}^{2}$$

Hence, the filter Qᵢⱼ can be written in the form

$${Q}_{ij} = \frac{{P}_{ij}^{*} {\vert {F}_{ij} \vert}^{2} + {N}_{ij}^{*} {F}_{ij}}{{\vert {P}_{ij} \vert}^{2} {\vert {F}_{ij} \vert}^{2} + {D}_{ij} + {\vert {N}_{ij} \vert}^{2}}$$

where

Dᵢⱼ=PᵢⱼFᵢⱼN*ᵢⱼ+NᵢⱼP*ᵢⱼF*ᵢⱼ

Signal Independent Noise

This result can be simplified further by imposing a condition which is physically valid in the large majority of cases. The condition is that ƒᵢⱼ and nᵢⱼ are uncorrelated, i.e.

ƒᵢⱼ⊙⊙nᵢⱼ=0

and

nᵢⱼ⊙⊙ƒᵢⱼ=0

In this case, the noise is said to be ‘signal independent’ and it follows from the correlation theorem that

FᵢⱼN*ᵢⱼ=0

and

NᵢⱼF*ᵢⱼ=0

This result allows us to cancel the cross terms present in the last expression for Qᵢⱼ (i.e. set Dᵢⱼ=0 and N*ᵢⱼFᵢⱼ=0) leaving the formula

$${Q}_{ij} = \frac{{P}_{ij}^{*} {\vert {F}_{ij} \vert}^{2}}{{\vert {P}_{ij} \vert}^{2} {\vert {F}_{ij} \vert}^{2} + {\vert {N}_{ij} \vert}^{2}}$$

Finally, rearranging, we obtain the expression for the least squares or Wiener filter,

$${Q}_{ij} = \frac{{P}_{ij}^{*}}{{\vert {P}_{ij} \vert}^{2} + {\vert {N}_{ij} \vert}^{2} / {\vert {F}_{ij} \vert}^{2}}$$

Estimation of the Noise-to-Signal Power Ratio |Fᵢⱼ|² / |Nᵢⱼ|²

From the algebraic form of the Wiener Filter derived above, it is clear that this particular filter depends on:

(i) the functional form of the PSF Pᵢⱼ that is used;

(ii) the functional form of |Nᵢⱼ|² / |Fᵢⱼ|².

The PSF of the system can usually be found by literally imaging a single point source which leaves us with the problem of estimating the noise-to-signal power ratio |Nᵢⱼ|² / |Fᵢⱼ|². This problem can be solved if one has access to two successive images recorded under identical conditions.

Consider two digital images denoted by sᵢⱼ and s′ᵢⱼ of the same object function ƒᵢⱼ recorded using the same PSF pᵢⱼ (i.e. imaging system) but at different times and hence with different noise fields nᵢⱼ and n′ᵢⱼ. These images are given by

sᵢⱼ=pᵢⱼ [symbol] [symbol] ƒᵢⱼ+nᵢⱼ

and

s′ᵢⱼ=pᵢⱼ [symbol] [symbol] ƒᵢⱼ+n′ᵢⱼ

respectively where the noise functions are uncorrelated and signal independent, i.e.

nᵢⱼ⊙⊙n′ᵢⱼ=0 (2.4)

ƒᵢⱼ⊙nᵢⱼ=nᵢⱼ⊙⊙ƒᵢⱼ=0 (2.5)

and

ƒᵢⱼ⊙⊙n′ᵢⱼ=n′ᵢⱼ⊙⊙ƒᵢⱼ=0 (2.6)

We now proceed to compute the autocorrelation function of sᵢⱼ given by

cᵢⱼ=sᵢⱼ⊙⊙sᵢⱼ

Using the correlation theorem and employing equation (2.5) we get

$$\begin{matrix}{C}_{ij} = {S}_{ij} {S}_{ij}^{*} = ( {P}_{ij} {F}_{ij} + {N}_{ij} ) {( {P}_{ij} {F}_{ij} + {N}_{ij} )}^{*} \\ = {\vert {P}_{ij} \vert}^{2} {\vert {F}_{ij} \vert}^{2} + {\vert {N}_{ij} \vert}^{2}\end{matrix}$$

where Cᵢⱼ is the DFT of cᵢⱼ. Next, we correlate sᵢⱼ with s′ᵢⱼ giving the cross-correlation function

c′ᵢⱼ=sᵢⱼ⊙⊙s′ᵢⱼ

Using the correlation theorem again and this time, employing equations (2.4) and (2.6) we get

$$\begin{matrix}{C}_{ij}^{′} = {\vert {P}_{ij} \vert}^{2} {\vert {F}_{ij} \vert}^{2} + {P}_{ij} {F}_{ij} {N}_{ij}^{′ *} + {N}_{ij} {P}_{ij}^{*} {F}_{ij}^{*} + {N}_{ij} {N}_{ij}^{′ *} \\ = {\vert {P}_{ij} \vert}^{2} {\vert {F}_{ij} \vert}^{2}\end{matrix}$$

The noise-to-signal ratio can now be obtained by dividing Cᵢⱼ by C′ᵢⱼ giving

$$\frac{{C}_{ij}}{{C}_{ij}^{′}} = 1 + \frac{{\vert {N}_{ij} \vert}^{2}}{{\vert {P}_{ij} \vert}^{2} {\vert {F}_{ij} \vert}^{2}}$$

Re-arranging, we obtain the result

$$\frac{{\vert {N}_{ij} \vert}^{2}}{{\vert {F}_{ij} \vert}^{2}} = ( \frac{{C}_{ij}}{{C}_{ij}^{′}} - 1 ) {\vert {P}_{ij} \vert}^{2}$$

Note that both Cᵢⱼ and C′ᵢⱼ can be obtained from the available data sᵢⱼ and s′ᵢⱼ. Also, substituting this result into the formula for Qᵢⱼ, we obtain an expression for the Wiener filter in terms of Cᵢⱼ and C′ᵢⱼ given by

$${Q}_{ij} = \frac{{P}_{ij}^{*}}{{\vert {P}_{ij} \vert}^{2}} \frac{{C}_{ij}^{′}}{{C}_{ij}}$$

In those cases where the user has access to successive recordings, the method of computing the noise-to-signal power ratio described above can be employed. The problem is that in many practical cases, one does not have access to successive images and hence, the cross-correlation function c′ᵢⱼ cannot be computed. In this case, one is forced to make an approximation and consider a Wiener filter of the form

$$Wiener Filter = \frac{{P}_{ij}^{*}}{{\vert {P}_{ij} \vert}^{2} + constant}$$

The constant ideally reflects any available information on the average signal-to-noise ratio of the image. Typically, we consider an expression of the form

$$constant = \frac{1}{{( SNR )}^{2}}$$

where SNR stands for Signal-to-Noise Ratio. In practice, the exact value of this constant must be chosen by the user.

Before attempting to deconvolve an image the user must at least have some a priori knowledge on the functional form of the Point Spread Function. Absence of this information leads to a method of approach known as ‘Blind Deconvolution’. A common technique is to assume that the Point Spread Function is Gaussian, i.e.

pᵢⱼ=exp[−(i²+j²)/2σ²]

where σ is the standard deviation which must be defined by the user. In this case, the user has control of two parameters:

(i) the standard deviation of the Gaussian PSF;

(ii) the SNR.

In practice, the user must adjust these parameters until a suitable ‘user optimized’ reconstruction is obtained. In other words, the Wiener filter must be ‘tuned’ to give a result which is acceptable based on the judgement and intuition of the user. This interactive approach to image restoration is just one of many practical problems associated with deconvolution which should ideally be executed in real time.

2.3 The Power Spectrum Equalization Filter

As the name implies, the Power Spectrum Equalization (PSE) filter is based on finding an estimate \hat{ƒ}ᵢⱼ whose power spectrum is equal to the power spectrum of the desired function ƒᵢⱼ. In other words, \hat{ƒ}ᵢⱼ is obtained by employing the criterion

|Fᵢⱼ|²|\hat{F}ᵢⱼ|²

together with the linear convolution model

\hat{ƒ}ᵢⱼ=qᵢⱼ [symbol] [symbol] sᵢⱼ

Like the Wiener filter, the PSE filter also assumes that the noise is signal independent. Since

\hat{F}ᵢⱼ=QᵢⱼSᵢⱼ=Qᵢⱼ(PᵢⱼFᵢⱼ+Nᵢⱼ)

and given that N*ᵢⱼFᵢⱼ=0 and F*ᵢⱼNᵢⱼ=0, we have

|\hat{F}ᵢⱼ|²=\hat{F}ᵢⱼ\hat{F}*ᵢⱼ=|Qᵢⱼ|²(|Pᵢⱼ|²|Fᵢⱼ|²+|Nᵢⱼ|²)

Using the PSE criterion and solving for |Qᵢⱼ|, we obtain

$$\vert {Q}_{ij} \vert = {( \frac{1}{{\vert {P}_{ij} \vert}^{2} + {\vert {N}_{ij} \vert}^{2} / {\vert {F}_{ij} \vert}^{2}} )}^{\frac{1}{2}}$$

In the absence of accurate estimates for the noise to signal power ratio, we approximate the PSE filter by

$$PSE filter = {( \frac{1}{{\vert {P}_{ij} \vert}^{2} + constant} )}^{\frac{1}{2}}$$

where

$$constant = \frac{1}{{( SNR )}^{2}}$$

Note that the criterion used to derive this filter can be written in the form

$${\sum }_{i} {\sum }_{j} ( {\vert {F}_{ij} \vert}^{2} - {\vert {\hat{F}}_{ij} \vert}^{2} ) = 0$$

or using Parseval's theorem

$${\sum }_{i} {\sum }_{j} ( {\vert {f}_{ij} \vert}^{2} - {\vert {\hat{f}}_{ij} \vert}^{2} ) = 0$$

Compare this criterion with that use for the Wiener filter, i.e.

$$Minimise {\sum }_{i} {\sum }_{j} {( {f}_{ij} - {\hat{f}}_{ij} )}^{2}$$

2.4 The Matched Filter

Matched filtering is based on correlating the image sᵢⱼ with the complex conjugate of the PSF pᵢⱼ. The estimate \hat{ƒ}ᵢⱼ of ƒᵢⱼ can therefore be written as

\hat{ƒ}ᵢⱼ=p*ᵢⱼ⊙⊙sᵢⱼ

Assuming that nᵢⱼ=0, so that

sᵢⱼ=pᵢⱼ [symbol] [symbol] ƒᵢⱼ

we have

\hat{ƒ}ᵢⱼp*ᵢⱼ [symbol] [symbol] pᵢⱼ⊙⊙ƒᵢⱼ

which in Fourier space is

\hat{F}ᵢⱼ=|Pᵢⱼ|²Fᵢⱼ

Observe, that the amplitude spectrum of \hat{F}ᵢⱼ is given by |Pᵢⱼ|²|Fᵢⱼ| and that the phase information is determined by Fᵢⱼ alone.

Criterion For the Matched Filter

The criterion for the matched filter is as follows. Given that

sᵢⱼ=pᵢⱼ [symbol] [symbol] ƒᵢⱼ+nᵢⱼ

the match filter provides an estimate for ƒᵢⱼ of the form

\hat{ƒ}_{ij=q}ᵢⱼ [symbol] [symbol] sᵢⱼ

where qᵢⱼ is chosen in such a way that the ratio

$$R = \frac{{\vert {\sum }_{i} {\sum }_{j} {Q}_{ij} {P}_{ij} \vert}^{2}}{{\sum }_{i} {\sum }_{j} {\vert {N}_{ij} \vert}^{2} {\vert {Q}_{ij} \vert}^{2}}$$

is a maximum.

The matched filter Qᵢⱼ is found by first writing

$${Q}_{ij} {P}_{ij} = \vert {N}_{ij} \vert {Q}_{ij} \times \frac{{P}_{ij}}{\vert {N}_{ij} \vert}$$

and then using the inequality

$$\begin{matrix}{\vert {\sum }_{i} {\sum }_{j} {Q}_{ij} {P}_{ij} \vert}^{2} = {\vert {\sum }_{i} {\sum }_{j} \vert {N}_{ij} \vert {Q}_{ij} \frac{{P}_{ij}}{\vert {N}_{ij} \vert} \vert}^{2} \\ \leq {\sum }_{i} {\sum }_{j} {\vert {N}_{ij} \vert}^{2} {\vert {Q}_{ij} \vert}^{2} {\sum }_{i} {\sum }_{j} \frac{{\vert {P}_{ij} \vert}^{2}}{{\vert {N}_{ij} \vert}^{2}}\end{matrix}$$

From this result and the definition of R given above we get

$$R \leq {\sum }_{i} {\sum }_{j} \frac{{\vert {P}_{ij} \vert}^{2}}{{\vert {N}_{ij} \vert}^{2}}$$

Now, recall that the criterion for the matched filter is that R is a maximum. If this is the case, then

$$R = {\sum }_{i} {\sum }_{j} \frac{{\vert {P}_{ij} \vert}^{2}}{{\vert {N}_{ij} \vert}^{2}}$$

or

$${\vert {\sum }_{i} {\sum }_{j} \vert {N}_{ij} \vert {Q}_{ij} \frac{{P}_{ij}}{\vert {N}_{ij} \vert} \vert}^{2} = {\sum }_{i} {\sum }_{j} {\vert {N}_{ij} \vert}^{2} {\vert {Q}_{ij} \vert}^{2} {\sum }_{i} {\sum }_{j} \frac{{\vert {P}_{ij} \vert}^{2}}{{\vert {N}_{ij} \vert}^{2}}$$

This is true, if and only if

$$\vert {N}_{ij} \vert {Q}_{ij} = \frac{{P}_{ij}^{*}}{\vert {N}_{ij} \vert}$$

because we then have

$${\vert {\sum }_{i} {\sum }_{j} \frac{{\vert {P}_{ij} \vert}^{2}}{{\vert {N}_{ij} \vert}^{2}} \vert}^{2} = {\sum }_{i} {\sum }_{j} \frac{{\vert {P}_{ij} \vert}^{2}}{{\vert {N}_{ij} \vert}^{2}} {\sum }_{i} {\sum }_{j} \frac{{\vert {P}_{ij} \vert}^{2}}{{\vert {N}_{ij} \vert}^{2}}$$

Thus, R is a maximum when

$${Q}_{ij} = \frac{{P}_{ij}^{*}}{{\vert {N}_{ij} \vert}^{2}}$$

The Matched Filter for White Noise

If the noise nᵢⱼ is white, then its power spectrum is can be assumed to be a constant, i.e.

$${\vert {N}_{ij} \vert}^{2} = {N}_{0}^{2}$$

In this case

$${Q}_{ij} = \frac{{P}_{ij}^{*}}{{N}_{0}^{2}}$$

and

$${\hat{F}}_{ij} = \frac{{P}_{ij}^{*}}{{N}_{0}^{2}} {S}_{ij}$$

Hence, for white noise, the match filter provides an estimate which may be written in the form

$${\hat{f}}_{ij} = \frac{1}{{N}_{0}^{2}} {p}_{ij}^{*} ⊙ ⊙ {s}_{ij}$$

Deconvolution of Linear Frequency Modulated PSFs

The matched filter is frequently used in coherent imaging systems whose PSF is characterized by a linear frequency modulated response. Two well known examples are Synthetic Aperture Radar and imaging systems that use (Fresnel) zone plates. In this section, we shall consider a separable linear FM PSF and also switch to a continuous noise free functional form which makes the analysis easier. Thus, consider the case when the PSF is given by

p(x, y)=exp(iαx²) exp(iβy²); |x|≦X, |y|≦Y

where α and β are constants and X and Y determine the spatial support of the PSF. The phase of this PSF (in the x-direction say) is αx² and the instantaneous frequency is given by

$$\frac{ⅆ}{ⅆ x} ( α {x}^{2} ) = 2 α x$$

which varies linearly with x. Hence, the frequency modulations (in both x and y) are linear which is why the PSF is referred to as a linear FM PSF. In this case, the image that is obtained is given by (neglecting additive noise)

s(x, y)=exp(iαx²) exp(iβy²) [symbol] [symbol] ƒ(x, y); |x|≦X, |y|≦Y

Matched filtering, we get

\hat{ƒ}(x, y)=exp(−iαx²) exp(−iβy²)⊙⊙exp(iαx²) exp(iβy²) [symbol] [symbol] ƒ(x, y)

Now,

$$\begin{matrix}exp ( - ⅈ α {x}^{2} ) ⊙ exp ( ⅈα {x}^{2} ) = {\int }_{- X / 2}^{X / 2} exp [ - ⅈ {α ( z + x )}^{2} ] exp ( ⅈ α {z}^{2} ) ⅆ z \\ = exp ( - ⅈ α {x}^{2} ) {\int }_{- X / 2}^{X / 2} exp ( 2 ⅈ α zx ) ⅆ z\end{matrix}$$

Evaluating the integral over z, we have

exp(−iαx²)⊙exp(iαx²)=X exp(−iαx²) sinc(αXx)

Since the evaluation of the correlation integral over y is identical, we can write

\hat{ƒ}(x, y)=XY exp(−iαx²) exp(−iβy²) sinc(αXx) sinc(βYy) [symbol] [symbol] ƒ(x, y)

In many systems the spatial support of the linear FM PSF is relatively long. In this case,

cos(αx²) sinc(αXx)≃sinc(αXx), cos(βy²) sinc(βYy)≃sinc(βYy)

and

sin(αx²) sinc(αXx)≃0, sin(βy²) sinc(βYy)≃0

and so

\hat{ƒ}(x, y)≃XY sinc(αXx) sinc(βYy) [symbol] [symbol] ƒ(x, y)

In Fourier space, this last equation can be written as

$$\hat{F} ( {k}_{x} , {k}_{y} ) = \{ \begin{matrix}\frac{{π}^{2}}{α β} F ( {k}_{x} , {k}_{y} ) , & \vert k \vert \leq α X , \vert k \vert \leq β Y ; \\ 0 , & otherwise\end{matrix}$$

The estimate \hat{ƒ} is therefore a band limited estimate of ƒ whose bandwidth is determined by the product of the parameters α and β with the spatial supports X and Y respectively. Note, that the larger the values of αX and βY, the greater the bandwidth of the reconstruction.

2.5 Constrained Deconvolution

Constrained deconvolution provides a filter which gives the user additional control over the deconvolution process. This method is based on minimizing a linear operation on the object ƒᵢⱼ of the form gᵢⱼ [symbol] [symbol] ƒᵢⱼ subject to some other constraint. Using the least squares approach, we find an estimate for ƒᵢⱼ by minimizing ∥gᵢⱼ [symbol] [symbol] ƒᵢⱼ∥² subject to the constraint

∥sᵢⱼ−pᵢⱼ [symbol] [symbol] ƒᵢⱼ∥²=∥nᵢⱼ∥²

where

$${‖ {x}_{ij} ‖}^{2} ≡ {\sum }_{i} {\sum }_{j} {x}_{ij}^{2}$$

Using this result, we can write

∥gᵢⱼ [symbol] [symbol] ƒᵢⱼ∥²=∥gᵢⱼ [symbol] [symbol] ƒᵢⱼ∥²+λ(∥sᵢⱼ−pᵢⱼ [symbol] [symbol] ƒᵢⱼ∥²−∥nᵢⱼ∥²)

because the quantity inside the brackets on the right hand side is zero. The constant λ is called the Lagrange multiplier. Using the orthogonality principle (see Appendix A), ∥gᵢⱼ [symbol] [symbol] ƒᵢⱼ∥² is a minimum when

(gᵢⱼ [symbol] [symbol] ƒᵢⱼ)⊙⊙gᵢⱼ−λ(sᵢⱼ−pᵢⱼ [symbol] [symbol] ƒᵢⱼ)⊙⊙pᵢⱼ=0

In Fourier space, this equation becomes

|Gᵢⱼ|²Fᵢⱼ−λ(SᵢⱼP*ᵢⱼ−|Pᵢⱼ|²Fᵢⱼ)=0

Solving for Fᵢⱼ, we get

$${F}_{ij} = \frac{{S}_{ij} {P}_{ij}^{*}}{{\vert {P}_{ij} \vert}^{2} + γ {\vert {G}_{ij} \vert}^{2}}$$

where γ is the reciprocal of the Lagrange multiplier (=1/λ). Hence, the constrained least squares filter is given by

$$Constrained Least Squares Filter = \frac{{P}_{ij}^{*}}{{\vert {P}_{ij} \vert}^{2} + γ {\vert {G}_{ij} \vert}^{2}}$$

The important point about this filter is that it allows the user to change Gᵢⱼ to suite a particular application. This filter can be thought of as a generalization of the other filters. For example, if γ=0 then the inverse filter is obtained, if γ=1 and |Gᵢⱼ|²=|Nᵢⱼ|² / |Fᵢⱼ|² then the Wiener filter is obtained, and if γ=1 and |Gᵢⱼ|²=|Nᵢⱼ|²−|Pᵢⱼ|² then the matched filter it obtained.

The following table lists the filters discussed so far. In each case, the filter Qᵢⱼ provides a solution to the inversion of the following equation

sᵢⱼ=pᵢⱼ [symbol] [symbol] ƒᵢⱼ+nᵢⱼ,

the solution for ƒᵢⱼ being given by

ƒᵢⱼ=IDFT[QᵢⱼSᵢⱼ]

where IDFT stands for the 2D Discrete Inverse Fourier Transform and Sᵢⱼ is the DFT of the digital image sᵢⱼ. In all cases, the DFT and IDFT can be computed using a FFT.

| Name of Filter | Formula | Condition(s) |
|---|---|---|
| Inverse Filter | ${Q}_{ij} = {P}_{ij}^{*} / \vert {P}_{ij} {\vert}^{2}$ | $Minimize ‖ {n}_{ij} ‖$ |
| Wiener Filter | ${Q}_{ij} = \frac{{P}_{ij}^{*}}{{\vert {P}_{ij} \vert}^{2} + {\vert {F}_{ij} \vert}^{2} / {\vert {N}_{ij} \vert}^{2}}$ | $\begin{matrix}Minimize {‖ {f}_{ij} - {q}_{ij} ⊗ ⊗ {s}_{ij} ‖}^{2} ; \\ {N}_{ij}^{*} {F}_{ij} = 0 , {F}_{ij}^{*} {N}_{ij} = 0\end{matrix}$ |
| PSE Filter | ${Q}_{ij} = {( \frac{1}{{\vert {P}_{ij} \vert}^{2} + {\vert {F}_{ij} \vert}^{2} / {\vert {N}_{ij} \vert}^{2}} )}^{\frac{1}{2}}$ | $\begin{matrix}{\vert {F}_{ij} \vert}^{2} = {\vert {Q}_{ij} {S}_{ij} \vert}^{2} ; \\ {N}_{ij}^{*} {F}_{ij} = 0 , {F}_{ij}^{*} {N}_{ij} = 0\end{matrix}$ |
| Matched Filter | ${Q}_{ij} = {P}_{ij}^{*} / {\vert {N}_{ij} \vert}^{2}$ | $Maximize \frac{{\vert {\sum }_{i} {\sum }_{j} {Q}_{ij} {P}_{ij} \vert}^{2}}{{\sum }_{i} {\sum }_{j} {\vert {N}_{ij} \vert}^{2} {\vert {Q}_{ij} \vert}^{2}}$ |
| Constrained Filter | ${Q}_{ij} = \frac{{P}_{ij}^{*}}{{\vert {P}_{ij} \vert}^{2} + γ {\vert {G}_{ij} \vert}^{2}}$ | $Minimize {‖ {g}_{ij} ⊗ ⊗ {f}_{ij} ‖}^{2}$ |

2.5 Maximum Entropy Deconvolution

As before, we are interested in solving the imaging equation

sᵢⱼ=pᵢⱼ [symbol] [symbol] ƒᵢⱼ+nᵢⱼ

for the object ƒᵢⱼ. Instead of using a least squares error to constrain the solution for ƒᵢⱼ, we choose to find ƒᵢⱼ such that the entropy E, given by

$$E = - {\sum }_{i} {\sum }_{j} {f}_{ij} ln {f}_{ij}$$

is a maximum. Note, that because the ln function is used in defining the Entropy, the Maximum Entropy Method (MEM) must be restricted to cases where ƒᵢⱼ is real and positive.

From the imaging equation above, we can write

$${s}_{ij} - {\sum }_{n} {\sum }_{m} {p}_{i - n , j - m} {f}_{n m} = {n}_{ij}$$

where we have just written the convolution operation out in full. Squaring both sides and summing over i and j we can write

$${\sum }_{i} {\sum }_{j} {( {s}_{ij} - {\sum }_{n} {\sum }_{m} {p}_{i - n , j - m} {f}_{n m} )}^{2} - {\sum }_{i} {\sum }_{j} {n}_{ij}^{2} = 0$$

But this equation is true for any constant λ multiplying both terms on the left hand side. We can therefore write the equation for E as

$$\begin{matrix}E = - {\sum }_{i} {\sum }_{j} {f}_{ij} ln {f}_{ij} + λ [ {\sum }_{i} {\sum }_{j} {( {s}_{ij} - {\sum }_{n} {\sum }_{m} {p}_{n - i , m - j} {f}_{n m} )}^{2} - \\ {\sum }_{i} {\sum }_{j} {n}_{ij}^{2} ]\end{matrix}$$

because the second term on the right hand side is zero anyway (for all values of the Lagrange multiplier λ). Given this equation, our problem is to find ƒᵢⱼ such that the entropy E is a maximum, i.e.

$$\frac{\partial E}{\partial {f}_{ij}} = 0$$

Differentiating (an exercise which will be left to the reader), and switching to the notation for 2D convolution [symbol] [symbol] and 2D correlation ⊙⊙, we find that E is a maximum when

1+ln ƒᵢⱼ−2λ(sᵢⱼ⊙⊙pᵢⱼ −pᵢⱼ [symbol] [symbol] ƒᵢⱼ⊙⊙pᵢⱼ)=0

or, after rearranging,

ƒᵢⱼ=exp[−1+2λ(sᵢⱼ⊙⊙pᵢⱼ−pᵢⱼ [symbol] [symbol] ƒᵢⱼ⊙⊙pᵢⱼ)]

This equation is transcendental in ƒᵢⱼ and as such, requires that ƒᵢⱼ is evaluated iteratively, i.e.

$${f}_{ij}^{k + 1} = exp [ - 1 + 2 λ ( {s}_{ij} ⊙ ⊙ {p}_{ij} - {p}_{ij} ⊗ ⊗ {f}_{ij}^{k} ⊙ ⊙ {p}_{ij} ) ] ;$$

$$k = 0 , 1 , 2 , … , N$$

where ƒᵢⱼ⁰=0 ∀ i, j say. The rate of convergence of this solution is determined by the value of the Lagrange multiplier that is used.

In general, the iterative nature of this nonlinear estimation method is undesirable, primarily because it is time consuming and may require many iterations before a solution is achieved with a desired tolerance.

We shall end this section by demonstrating a rather interesting result which is based on linearizing the MEM. This is achieved by retaining the first two terms (i.e. the linear terms) in the series representation of the exponential function leaving us with the following equation

ƒᵢⱼ=2λ(sᵢⱼ⊙⊙pᵢⱼ−pᵢⱼ [symbol] [symbol] ƒᵢⱼ⊙⊙pᵢⱼ)

Using the convolution and correlation theorems, in Fourier space, this equation becomes

Fᵢⱼ=2λSᵢⱼP*ᵢⱼ−2λ|Pᵢⱼ|²Fᵢⱼ

Rearranging, we get

$${F}_{ij} = \frac{{S}_{ij} {P}_{ij}^{*}}{{\vert {P}_{ij} \vert}^{2} + 1 / 2 λ}$$

Hence, we can define a linearized maximum entropy filter of the form

$$\frac{{P}_{ij}^{*}}{\vert {P}_{ij} \vert + 1 / 2 λ}$$

Notice, that this filter is very similar to the Wiener filter. The only difference is that the Wiener filter is regularized by a constant determined by the SNR of the data whereas this filter is regularized by a constant determined by the Lagrange multiplier.

3. Bayesian Estimation

The processes discussed so far do not take into account the statistical nature of the noise inherent in a digital signal or image. To do this, another type of approach must be taken which is based on a result in probability theory called Bayes rule named after the English mathematician Thomas Bayes.

The Probability of an Event

Suppose we toss a coin, observe whether we get heads or tails and then repeat this process a number of times. As the number of trials increases, we expect that the number of times heads or tails occurs is half that of the number of trials. In other words, the probability of getting heads is ½ and the probability of getting tails is also ½. Similarly, if a dice with six faces is thrown repeatedly, then the probability of it landing on any one particular face is ⅙. In general, if an experiment is repeated N times and an event A occurs n times say, then the probability of this event P(A) is defined as

$$P ( A ) = {lim}_{N -> ∞} ( \frac{n}{N} )$$

The probability is the relative frequency of an event as the number of trials tends to infinity. In practice, only a finite number of trials can be conducted and we therefore define the probability of an event A as

$$P ( A ) ≃ \frac{n}{N}$$

where it is assumed that N is large.

The Joint Probability

Suppose we have two coins which we label C₁ and C₂. We toss both coins simultaneously N times and record the number of times C₁ is heads, the number of times C₂ is heads and the number of times C₁ and C₂ are heads together. What is the probability that C₁ and C₂ are heads together? Clearly, if m is the number of times out of N trials that heads occurs simultaneously, then the probability of such an event must be given by

$$P ( {C}_{1} heads and {C}_{2} heads ) = \frac{m}{N}$$

This is known as the joint probability of C₁ being heads when C₂ is heads. In general, if two events A and B are possible and m is the number of times both events occur simultaneously, then the joint probability is given by

$$P ( A and B ) = \frac{m}{N}$$

The Conditional Probability

Suppose we setup an experiment in which two events A and B can occur. We conduct N trials and record the number of times A occurs (which is n) and the number of times A and B occur simultaneously (which is m). In this case, the joint probability may written as

$$P ( A and B ) = \frac{m}{N} = \frac{m}{n} \times \frac{n}{N}$$

Now, the quotient n/N is the probability P(A) that event A occurs. The quotient m/n is the probability that events A and B occur simultaneously given that event A has occurred. The latter probability is known as the conditional probability and is written as

$$P ( B \vert A ) = \frac{m}{n}$$

where the symbol B |A means ‘B given A’. Hence, the joint probability can be written as

P(A and B)=P(A)P(B |A)

Suppose that we do a similar type of experiment but this time we record the number of times p that event B occurs and the number of times q that event A occurs simultaneously with event B. In this case, the joint probability of events B and A occurring together is given by

$$P ( B and A ) = \frac{q}{N} = \frac{q}{p} \times \frac{p}{N}$$

The quotient p/N is the probability P(B) that event B occurs and the quotient q/p is the probability of getting events B and A occurring simultaneously given that event B has occurred. The latter probability is just the probability of getting ‘A given B’, i.e.

$$P ( A \vert B ) = \frac{q}{p}$$

Hence, we have

P(B and A)=P(B)P(A |B)

Bayes Rule

The probability of getting A and B occurring simultaneously is exactly the same as getting B and A occurring simultaneously, i.e.

P(A and B)=P(B and A)

Hence, by using the definition of these joint probabilities in terms of the conditional probabilities we arrive at the following formula

P(A)P(B|A)=P(B)P(A |B)

or alternatively

$$P ( B \vert A ) = \frac{P ( B ) P ( A \vert B )}{P ( A )}$$

This result is known as Bayes rule. It relates the conditional probability of ‘B given A’ to that of ‘A given B’.

Bayesian Estimation in Signal and Image Processing

In signal and image analysis Bayes rule is written in the form

$$P ( f \vert s ) = \frac{P ( f ) P ( s \vert f )}{P ( s )}$$

where ƒ is the object that we want to recover from the signal

s(x)=p(x) [symbol] ƒ(x)+n(x)

or image

s(x, y)=p(x, y) [symbol] [symbol] ƒ(z, y)+n(x, y)

This result is the basis for a class of restoration methods which are known collectively as Bayesian estimators.

Bayesian estimation attempts to recover ƒ in such a way that the probability of getting ƒ given s is a maximum. In practice, this is done by assuming that P(ƒ) and P(s |ƒ) obey certain statistical distributions which are consistent with the experiment in which s is measured. In other words, models are chosen for P(ƒ) and P(s |ƒ) and then ƒ is computed at the point where P(ƒ|s) reaches its maximum value. This occurs when

$$\frac{\partial }{\partial f} P ( f \vert s ) = 0$$

The function P is the Probability Density Function (PDF). The PDF P(ƒ|s) is called the a posteriori PDF. Since the logarithm of a function varies monotonically with that function, the a posteriori PDF is also a maximum when

$$\frac{\partial }{\partial f} ln P ( f \vert s ) = 0$$

Now, using Bayes rule, we can write this equation as

$$\frac{\partial }{\partial f} ln P ( s \vert f ) + \frac{\partial }{\partial f} ln P ( f ) = 0$$

Because the solution to this equation for ƒ maximizes the a posteriori PDF, this method is known as the Maximum a Posterior or MAP method. To illustrate the principles of Bayesian estimation, we shall now present some simple examples of how this technique can be applied to data analysis.

Bayesian Estimation—Example 1

Suppose that we measure a single sample s (one real number) in an experiment where it is known a priori that

s=ƒ+n

where n is noise (a single random number). Suppose that it is also known a priori that the noise is determined by a Gaussian distribution of the form (ignoring scaling)

P(n)=exp(−n²/σₙ²)

where σₙ² is the standard deviation of the noise. Now, the probability of measuring s given ƒ—i.e. the conditional probability P(s |ƒ)—is determined by the noise since

n=s−ƒ

We can therefore write

P(s|ƒ)=exp[−(s−ƒ)²/σₙ²]

To find the MAP estimate, the PDF for ƒ must also be known. Suppose that ƒ also has a zero-mean Gaussian distribution of the form

P(ƒ)=exp(−ƒ²/σ_{ƒ}²)

Then,

$$\frac{\partial }{\partial f} ln P ( s \vert f ) + \frac{\partial }{\partial f} ln P ( f ) = \frac{2 ( s - f )}{{σ}_{n}^{2}} - \frac{2 f}{{σ}_{f}^{2}} = 0$$

Solving this equation for ƒ gives

$$f = \frac{s {Γ}^{2}}{1 + {Γ}^{2}}$$

where Γ is the SNR defined by

$$Γ = \frac{{σ}_{f}}{{σ}_{n}}$$

Notice, that as σₙ→0, ƒ→s which must be true since s=ƒ+n and n has a zero-mean Gaussian distribution. Also, note that the solution we acquire for ƒ is entirely dependent on the a priori information we have on the PDF for ƒ. A different PDF produces an entirely different solution. For example, suppose it is known or we have good reason to assume that ƒ obeys a Rayleigh distribution of the form

P(ƒ)=ƒexp(−ƒ²/σ_{ƒ}²), ƒ≧0

In this case,

$$\frac{\partial }{\partial f} ln P ( f ) = \frac{1}{f} - \frac{2 f}{{σ}_{f}^{2}}$$

and assuming that the noise obeys the same zero-mean Gaussian distribution

$$\frac{\partial }{\partial f} ln P ( s \vert f ) + \frac{\partial }{\partial f} ln P ( f ) = \frac{2 ( s - f )}{{σ}_{n}^{2}} + \frac{1}{f} - \frac{2 f}{{σ}_{f}^{2}} = 0$$

This equation is quadratic in ƒ. Solving it, we get

$$f = \frac{s {Γ}^{2}}{2 ( 1 + {Γ}^{2} )} ( 1 \pm \sqrt{1 + \frac{2 {σ}_{n}^{2}}{{s}^{2}} ( 1 + \frac{1}{{Γ}^{2}} )} )$$

The solution for ƒ which maximizes the value of P(ƒ|s), can then be written in the form

$$f = \frac{s}{2 a} ( 1 + \sqrt{1 + \frac{2 a {σ}_{n}^{2}}{{s}^{2}}} )$$

$$where$$

$$a = 1 + \frac{1}{{Γ}^{2}}$$

This is a nonlinear estimate for ƒ. If

$$\frac{{σ}_{n} \sqrt{2 a}}{s} << 1$$

$$then$$

$$f ≃ \frac{s}{a}$$

In this case, ƒ is linearly related to s. In fact, this linearized estimate is identical to the MAP estimate obtained earlier where it was assumed that ƒ had a Gaussian distribution.

From the example given above, it should now be clear that Bayesian estimation (i.e. the MAP method) is only as good as the a priori information on the statistical behaviour of ƒ—the object for which we seek a solution. However, when P(ƒ) is broadly distributed compared with P(s |ƒ), the peak value of the a posteriori PDF will lie close to the peak value of P(ƒ). In particular, if P(ƒ) is roughly constant, then

$$\frac{\partial }{\partial f} ln P ( f )$$

is close to zero and therefore

$$\frac{\partial }{\partial f} ln P ( f \vert s ) ≃ \frac{\partial }{\partial f} ln P ( s \vert f )$$

In this case, the a posteriori PDF is a maximum when

$$\frac{\partial }{\partial f} ln P ( s \vert f ) = 0$$

The estimate for ƒ that is obtained by solving this equation for ƒ is called the Maximum Likelihood or ML estimate. To obtain this estimate, only a priori knowledge on the statistical fluctuations of the conditional probability is required. If, as in the previous example, we assume that the noise is a zero-mean Gaussian distribution, then the ML estimate is given by

ƒ=s

Note that this is the same as the MAP estimate when the standard deviation of the noise is zero.

The basic and rather important difference between the MAP and ML estimates is that the ML estimate ignores a priori information about the statistical fluctuations of the objectƒ. It only requires a model for the statistical fluctuations of the noise. For this reason, the ML estimate is usually easier to compute. It is also the estimate to use in cases where there is a complete lack of knowledge about the statistical behaviour of the object.

Bayesian Estimation—Example 2

To further illustrate the difference between the MAP and ML estimate and to show their use in signal analysis, consider the case where we measure N samples of a real signal sᵢ in the presence of additive noise nᵢ which is the result of transmitting a known signal ƒᵢ modified by a random amplitude factor a. The samples of the signal are given by

sᵢ=aƒᵢ+nᵢ, i=1, 2, . . . , N

The problem is to find an estimate for a. To solve problems of this type using Bayesian estimation, we must introduce multidimensional probability theory. In this case, the PDF is a function of not just one number s but a set of numbers s₁, s₂, . . . , s_{N}. It is therefore a vector space. To emphasize this, we use the vector notation

P(s)≡P(sᵢ)≡P(s₁, s₂, s₃, . . . , s_{N})

The ML estimate is given by solving the equation

$$\frac{\partial }{\partial a} ln P ( s \vert a ) = 0$$

for a. Let us again assume that the noise is described by a zero-mean Gaussian distribution of the form

$$P ( n ) ≡ P ( {n}_{1} , {n}_{2} , … , {n}_{N} ) = exp ( - \frac{1}{{σ}_{n}^{2}} {\sum }_{i = 1}^{N} {n}_{i}^{2} )$$

The conditional probability is then given by

$$P ( s \vert a ) = exp ( - \frac{1}{{σ}_{n}^{2}} {\sum }_{i = 1}^{N} {( {s}_{i} - {af}_{i} )}^{2} )$$

$$and$$

$$\frac{\partial }{\partial a} ln P ( s \vert a ) = \frac{2}{{σ}_{n}^{2}} {\sum }_{i = 1}^{N} ( {s}_{i} - {af}_{i} ) {f}_{i} = 0$$

Solving this last equation for a we obtain the ML estimate

$$a = \frac{{\sum }_{i = 1}^{N} {s}_{i} {f}_{i}}{{\sum }_{i = 1}^{N} {f}_{i}^{2}}$$

The MAP estimate is obtained by solving the equation

$$\frac{\partial }{\partial a} ln P ( s \vert a ) + \frac{\partial }{\partial a} ln P ( a ) = 0$$

for a. Using the same distribution for the conditional PDF, let us assume that a has a zero-mean Gaussian distribution of the form

P(a)=exp(−a²/σₐ²)

where σₐ² is the standard deviation. In this case,

$$\frac{\partial }{\partial a} ln P ( a ) = - \frac{2 a}{{σ}_{a}^{2}}$$

and hence, the MAP estimate is obtained by solving the equation

$$\frac{\partial }{\partial a} ln P ( s \vert a ) + \frac{\partial }{\partial a} ln P ( a ) = \frac{2}{{σ}_{n}^{2}} {\sum }_{i = 1}^{N} ( {s}_{i} - {af}_{i} ) {f}_{i} - \frac{2 a}{{σ}_{a}^{2}} = 0$$

for a. The solution to this equation is given by

$$a = \frac{\frac{{σ}_{a}^{2}}{{σ}_{n}^{2}} {\sum }_{i = 1}^{N} {s}_{i} {f}_{i}}{1 + \frac{{σ}_{a}^{2}}{{σ}_{n}^{2}} {\sum }_{i = 1}^{N} {f}_{i}^{2}}$$

Note, that if σₐ>>σₙ, then,

$$a ≃ \frac{{\sum }_{i = 1}^{N} {s}_{i} {f}_{i}}{{\sum }_{i = 1}^{N} {f}_{i}^{2}}$$

which is the same as the ML estimate.

3.1 The Maximum Likelihood Filter

In the last section, the principles of Bayesian estimation were presented. We shall now use these principles to design deconvolution algorithms for digital images under the assumption that the statistics are Gaussian. The problem is as follows: Given the real digital image

$${s}_{ij} = {\sum }_{n} {\sum }_{m} {p}_{i - n , j - m} {f}_{n m} + {n}_{ij}$$

find an estimate for ƒᵢⱼ when pᵢⱼ is known together with the statistics for nᵢⱼ. In this section, the ML estimate for ƒᵢⱼ is determined by solving the equation

$$\frac{\partial }{\partial {f}_{ij}} ln P ( {s}_{ij} \vert {f}_{ij} ) = 0$$

As before, the algebraic form of the estimate depends upon the model that is chosen for the PDF. Let us assume that the noise has a zero-mean Gaussian distribution. In this case, the conditional PDF is given by

$$P ( {s}_{ij} \vert {f}_{ij} ) = exp [ - \frac{1}{{σ}_{n}^{2}} {\sum }_{i} {\sum }_{j} {( {s}_{ij} - {\sum }_{n} {\sum }_{m} {p}_{i - n , j - m} {f}_{n m} )}^{2} ]$$

where σₙ² is the standard deviation of the noise. Substituting this result into the previous equation and differentiating, we get

$$\frac{2}{{σ}_{n}^{2}} {\sum }_{i} {\sum }_{j} ( {s}_{ij} - {\sum }_{n} {\sum }_{m} {p}_{i - n , j - m} {f}_{n m} ) {p}_{i - k , j - l} = 0$$

$$or$$

$${\sum }_{i} {\sum }_{j} {s}_{ij} {p}_{i - k , j - l} = {\sum }_{i} {\sum }_{j} ( {\sum }_{n} {\sum }_{m} {p}_{i - n , j - m} {f}_{n m} ) {p}_{i - k , j - l}$$

Using the appropriate symbols, we may write this equation in the form

sᵢⱼ⊙⊙pᵢⱼ=(pᵢⱼ [symbol] [symbol] ƒᵢⱼ)⊙⊙pᵢⱼ

where ⊙⊙ and [symbol] [symbol] denote the 2D correlation and convolution sums respectively. The ML estimate is obtained by solving the equation above for ƒᵢⱼ. This can be done by transforming it into Fourier space. Using the correlation and convolution theorems, in Fourier space this equation becomes

$${S}_{ij} {P}_{ij}^{*} = ( {P}_{ij} {F}_{ij} ) {P}_{ij}^{*}$$

$$and thus$$

$${f}_{ij} = IDFT ( {F}_{ij} ) = IDFT ( \frac{{S}_{ij} {P}_{ij}^{*}}{{\vert {P}_{ij} \vert}^{2}} )$$

where IDFT is taken to denote the (2D) Inverse Discrete Fourier Transform. Hence for Gaussian statistics, the ML filter is given by

$$ML Filter = \frac{{P}_{m}^{*}}{{\vert {P}_{m} \vert}^{2}}$$

which is identical to the inverse filter.

3.2 The Maximum a Posteriori Filter

This filter is obtained by finding ƒᵢⱼ such that

$$\frac{\partial }{\partial {f}_{kl}} ln P ( {s}_{ij} \vert {f}_{ij} ) + \frac{\partial }{\partial {f}_{kl}} ln P ( {f}_{ij} ) = 0$$

Consider the following models for the PDFs

(i) Gaussian statistics for the noise

$$P ( {s}_{ij} \vert {f}_{ij} ) = exp [ - \frac{1}{{σ}_{n}^{2}} {\sum }_{i} {\sum }_{j} {( {s}_{ij} - {\sum }_{n} {\sum }_{m} {p}_{i - n , j - m} {f}_{n m} )}^{2} ]$$

(ii) Gaussian statistics for the object

$$P ( {f}_{ij} ) = exp ( - \frac{1}{{σ}_{f}^{2}} {\sum }_{i} {\sum }_{j} {f}_{ij}^{2} )$$

By substituting these expressions for P(sᵢⱼ|ƒᵢⱼ) and P(ƒᵢⱼ) into the equation above, we obtain

$$\frac{2}{{σ}_{n}^{2}} {\sum }_{i} {\sum }_{j} ( {s}_{ij} - {\sum }_{n} {\sum }_{m} {p}_{i - n , j - m} {f}_{n m} ) {p}_{i - k , j - l} - \frac{2}{{σ}_{f}^{2}} {f}_{kl} = 0$$

Rearranging, we may write this result in the form

$${s}_{ij} ⊙ ⊙ {p}_{ij} = \frac{{σ}_{n}^{2}}{{σ}_{f}^{2}} {f}_{ij} + ( {p}_{ij} ⊗ ⊗ {f}_{ij} ) ⊙ {p}_{ij}$$

In Fourier space, this equation becomes

$${S}_{ij} {P}_{ij}^{*} = \frac{1}{{Γ}^{2}} {F}_{ij} + {\vert {P}_{ij} \vert}^{2} {F}_{ij}$$

$$where$$

$$Γ = \frac{{σ}_{f}}{{σ}_{n}}$$

The MAP filter for Gaussian statistics is therefore given by

$$MAP Filter = \frac{{P}_{ij}^{*}}{{\vert {P}_{ij} \vert}^{2} + 1 / {Γ}^{2}}$$

Note, that this filter is the same as the Wiener filter under the assumption that the power spectra of the noise and object are constant. Also, note that

$${lim}_{{σ}_{n} -> 0} ( MAP Filter ) = ML Filter$$

4. Reconstruction of Bandlimited Images

A bandlimited function is a function whose spectral bandwidth is finite. Most real signals and images are bandlimited functions. This leads one to consider the problem of how the bandwidth and hence the resolution of a bandlimited image, can be increased synthetically using digital processing techniques. In other words, how can we extrapolate the spectrum of a bandlimited function from an incomplete sample.

Solutions to this type of problem are important in image analysis where a resolution is needed that is not an intrinsic characteristic of the image provided and is difficult or even impossible to achieve experimentally. The type of resolution that is obtained by spectral extrapolation is referred to as super resolution.

Because sampled data are always insufficient to specify a unique solution and since no algorithm is able to reconstruct equally well all characteristics of an image, it is essential that the user is able to play a role in the design and execution of an algorithm and incorporate maximum knowledge of the expected features. This allows optimum use to be made of the available data and the users experience, judgement and intuition. Hence, an important aspect of practical solutions to the spectral extrapolation problem is the incorporation of a priori information on the structure of an object.

In this section, an algorithm is discussed which combines a priori information with the least squares principle to reconstruct a two dimensional function from limited (i.e. incomplete) Fourier data. This algorithm is essentially a modified version of the Gerchberg-Papoulis algorithm to accommodate a user defined weighting function.

4.1 The Gerchberg-Papoulis Method

Let us consider the case where we have an image ƒ(x, y) characterized by a discrete spectrum Fₙₘ which is composed of a finite number of samples:

$$- \frac{N}{2} \leq n \leq \frac{N}{2} \\ - \frac{M}{2} \leq m \leq \frac{M}{2}$$

These data are related to the image by the equation

$${F}_{n m} = {\int }_{- X}^{X} {\int }_{- Y}^{Y} f ( x , y ) {e}^{- i ( {k}_{n} x + {k}_{m} y )} ⅆ x ⅆ y$$

Here, ƒ is assumed to be of finite support X and Y, i.e.,

|x|≦X and |y|≦Y

and kₙ, kₘ are discrete spatial frequencies. With this data, we can define the BandLimited function

$${f}_{BL} ( x , y ) = {\sum }_{n} {\sum }_{m} {F}_{n m} {ⅇ}^{ⅈ ( {k}_{n} x + {k}_{m} y )}$$

which is related to Fₙₘ by a two-dimensional Fourier Series. Our problem is to reconstruct ƒ given Fₙₘ or equivalently, ƒ_{BL}. In this section, a solution to this problem is presented using the least squares principle. First, we consider a model for an estimate \hat{ƒ} of ƒ given by

$$\hat{f} ( x , y ) = {\sum }_{n} {\sum }_{m} {A}_{n m} {ⅇ}^{ⅈ ( {k}_{n} x + {k}_{m} y )} \qquad ( 4.1 )$$

This model is just a two-dimensional Fourier series representation of the object. Given this model, our problem is reduced to that of fining the coefficients Aₙₘ.

Using the least squares method, we compute Aₙₘ by minimizing the mean square error

$$e = {\int }_{- X}^{X} {\int }_{- Y}^{Y} {\vert f ( x , y ) - \hat{f} ( x , y ) \vert}^{2} ⅆ x ⅆ y$$

This error is a minimum when

$$\frac{\partial e}{\partial {A}_{n m}} = 0$$

Differentiating, we obtain (see Appendix A)

$$\begin{matrix}\frac{\partial e}{\partial {A}_{pq}} = \frac{\partial }{\partial {A}_{pq}} {\int }_{- X}^{X} {\int }_{- Y}^{Y} {\vert f ( x , y ) - {\sum }_{n} {\sum }_{m} {A}_{n m} {ⅇ}^{ⅈ ( {k}_{n} x + {k}_{m} y )} \vert}^{2} ⅆ x ⅆ y \\ = {\int }_{- X}^{X} {\int }_{- Y}^{Y} ( f ( x , y ) - {\sum }_{n} {\sum }_{m} {A}_{n m} {ⅇ}^{ⅈ ( {k}_{n} x + {k}_{m} y )} ) {ⅇ}^{- ⅈ ( {k}_{p} x + {k}_{q} y )} ⅆ x ⅆ y\end{matrix}$$

Thus, e is a minimum when

$$\begin{matrix}{\int }_{- X}^{X} {\int }_{- Y}^{Y} f ( x , y ) {ⅇ}^{- ⅈ ( {k}_{p} x + {k}_{q} y )} ⅆ x ⅆ y = \\ {\sum }_{n} {\sum }_{m} {A}_{n m} {\int }_{- X}^{X} {\int }_{- Y}^{Y} {ⅇ}^{- ⅈ ( {k}_{p} - {k}_{n} ) x} {ⅇ}^{- ⅈ ( {k}_{q} - {k}_{m} ) y} ⅆ x ⅆ y\end{matrix}$$

The left hand side the above equation is just the Fourier data F_{pq}. Hence, after evaluating the integrals on he right hand side, we get

$${F}_{pq} = 4 XY {\sum }_{n} {\sum }_{m} {A}_{n m} sin c [ ( {k}_{p} - {k}_{n} ) X ] sin c [ ( {k}_{q} - {k}_{m} ) Y ] \qquad ( 4.2 )$$

The estimate \hat{ƒ}(x, y) can be computed by solving the equation above for the coefficients Aₙₘ. This is a two-dimensional version of the Gerchberg-Papoulis method and is a least squares approximation of ƒ(x, y).

4.2 Incorporation of a Priori Information

Since we have considered an image ƒ of finite support, we can write equation (4.1) in the following ‘closed form’:

$$\hat{f} ( x , y ) = w ( x , y ) {\sum }_{n} {\sum }_{m} {A}_{n m} {ⅇ}^{ⅈ ( {k}_{n} x + {k}_{m} y )} \qquad ( 4.3 )$$

where

$$w ( x , y ) = \{ \begin{matrix}1 , & \vert x \vert \leq X , & \vert y \vert \leq Y \\ 0 , & \vert x \vert > X , & \vert y \vert > Y\end{matrix}$$

Writing it in this form, we observe that ω (i.e. essentially the values of X and Y) represents a simple but crucial form of a priori information. This information is required to compute the sinc functions given in equation (4.2) and hence the coefficients Aₙₘ. Note, that the sinc functions (in particular the zero locations) are sensitive to the precise values of X and Y and hence small errors in X and Y can dramatically effect the computation of Aₙₘ. In other words, equation (4.2) is ill-conditioned.

The algebraic form of equation (4.3) suggests incorporating further a priori information into the ‘weighting function’ ω in addition to the support of the object ƒ. We therefore consider an estimate of the form

$$\hat{f} ( x , y ) = w ( x , y ) {\sum }_{n} {\sum }_{m} {A}_{n m} {ⅇ}^{ⅈ ( {k}_{n} x + {k}_{m} y )}$$

where ω is now a generalized weighting function composed of limited a priori information on the structure of ƒ. If we now employ a least squares method to find Aₙₘ based on the previous mean square error function, we obtain the following equation

$${\int }_{- X}^{X} {\int }_{- Y}^{Y} f ( x , y ) w ( x , y ) {ⅇ}^{- ⅈ ( {k}_{p} x + {k}_{q} y )} ⅆ x ⅆ y = {\sum }_{ n}^{} {\sum }_{ m}^{} {A}_{nm} {\int }_{- X}^{X} {\int }_{- Y}^{Y} {[ w ( x , y ) ]}^{2} {ⅇ}^{- ⅈ ( {k}_{p} - {k}_{n} ) x} {ⅇ}^{- ⅈ ( {k}_{q} - {k}_{m} ) y} ⅆ x ⅆ y$$

The problem with this result is that the data on the left hand side is not the same as the Fourier data provided F_{pq}. In other words, the result is not ‘data consistent’. To overcome this problem we introduce a modified version of the least square method which involves minimizing the error

$$e = {\int }_{- X}^{X} {\int }_{- Y}^{Y} \vert f ( x , y ) - \hat{f} ( x , y ) {\vert}^{2} \frac{1}{w ( x , y )} ⅆ x ⅆ y \qquad \text{(4.4} )$$

In this case, we find that e is a minimum when

$${F}_{pq} = {\sum }_{ n}^{} {\sum }_{ m}^{} {A}_{nm} {W}_{p - n , q - m} \qquad \text{(4.5)}$$

where

$${W}_{p - n , q - m} = {\int }_{- X}^{X} {\int }_{- Y}^{Y} w ( x , y ) {ⅇ}^{- ⅈ ( {k}_{p} - {k}_{n} ) x} {ⅇ}^{- ⅈ ( {k}_{q} - {k}_{m} ) y} ⅆ x ⅆ y$$

Equation (4.5) is data consistent, the right hand side of this equation being a discrete convolution of Aₙₘ with Wₙₘ. Hence, using the notation for convolution, we may write this equation in the form

Fₙₘ=Aₙₘ [symbol] [symbol] Wₙₘ

Using the convolution theorem, in real space, this equation becomes

ƒ_{BL}(x, y)=a(x, y)ω_{BL}(x, y)

where

$${f}_{BL} ( x , y ) = {\sum }_{ n}^{} {\sum }_{ m}^{} {F}_{nm} {ⅇ}^{ⅈ ( {k}_{n} x + {k}_{m} y )}$$

$${w}_{BL} ( x , y ) = {\sum }_{ n}^{} {\sum }_{ m}^{} {W}_{nm} {ⅇ}^{ⅈ ( {k}_{n} x + {k}_{m } y )}$$

$$and$$

$$a ( x , y ) = {\sum }_{ n}^{} {\sum }_{ m}^{} {A}_{nm} {ⅇ}^{ⅈ ( {k}_{n} x + {k}_{m} y )}$$

Now, since

$$\hat{f} ( x , y ) = w ( x , y ) {\sum }_{ n}^{} {\sum }_{ m}^{} {A}_{nm} {ⅇ}^{ⅈ ( {k}_{n} x + {k}_{m} y )} = w ( x , y ) a ( x , y )$$

we obtain the simple algebraic result

$$\hat{f} ( x , y ) = \frac{w ( x , y )}{{w}_{BL} ( x , y )} {f}_{BL} ( x , y )$$

Here ω_{BL} is a bandlimited weighting function, bandlimited by the same extent as ƒ_{BL}.

The algorithm presented above is based on an inverse weighted least squares error [i.e. equation (4.4)]. It is essentially an adaption of the Gerchberg-Papoulis method, modified to:

(i) accommodate a generalized weighting function ω(x, y);

(ii) provide data consistency [i.e. equation (4.5)].

The weighting function ω(x, y) can be used to encode as much information as is available on the structural characteristics of ƒ(x, y). Since equation (4.4) involves 1/ω(x, y), ω(x, y) must be confined to being a positive non-zero function. We can summarize this algorithm in the form

$$reconstruction = \frac{bandlimited image \times a priori information }{bandlimited a priori information}$$

Clearly, the success of this algorithm depends on the quality of the a priori information that is available, just as the performance of the Wiener filter or MEM depends upon a priori information on the functional form of the Point Spread Function.

5. Reconstruction From Projections: Computed Tomography (CT)

Computed Tomography (CT) is used in a wide range of applications, most notably for medical imaging (the CT-scan). The mathematical basis of this mode of imaging is compounded in an integral transform called the Radon transform, named after the Austrian mathematician, Johannes Radon. Since the development of the CT-scan, the Radon transform has found applications in many diverse subject areas; from astrophysics to seismic exploration and more recently, computer vision.

This section is concerned with the Radon transform and some of the numerical techniques that can be used to compute it. Particular attention is focused on three methods of computing the inverse Radon transform using (i) back-projection and deconvolution, (ii) filtered back-projection and (iii) the central slice theorem.

5.1 Computed Tomography

In 1917, J Radon published a paper in which he showed that the complete set of one-dimensional projections obtained from a continuous two-dimensional function, contains all the information required to reconstruct this same function. A projection is obtained by integrating a 2D function over a set of parallel lines and is characteristic of its angle of rotation in the 2D plane. The Radon transform provides one of the most successful theoretical basis for imaging both the two-dimensional and three-dimensional internal structure of inhomogeneous objects. Consequently, it has a wide range of applications.

The mathematics of projection tomography considers continuous functions. The inverse problem therefore involves the reconstruction of an object function from an infinite set of projections. In practice, only a finite number of projections can be taken. Hence, only an approximation to the original function can be obtained by computing the inverse Radon transform digitally. The accuracy of this approximation can be improved by increasing the number of projections used and employing image enhancement techniques.

5.2 Some Applications of Computed Tomography

Due to the rapid advances in the field of computed tomography, the horizons of radiology have expanded beyond traditional X-ray radiography to embrace X-ray CT, microwave CT, ultrasonic CT and emission CT to name but a few. All these subject applications are based on the Radon transform.

Other areas were the Radon transform has been applied are in computer vision (linear feature recognition) and astronomy (e.g. mapping solar microwave emissions).

X-ray Tomography

The X-ray problem was the prototype application for the active reconstruction of images. The term ‘active’, arises from the use of external probes to collect information about projections. An alternative approach (i.e. passive reconstruction), does not require external probes.

The X-ray process involves recording X-rays on a photographic plate as they emerge from a three dimensional object after having been attenuated by an amount that is determined by the path followed by a particular ray through the object. This gives an image known as a radiograph. Each grey level of this type of image is determined by the combined effect of all the absorbing elements that lie along the path of an individual ray.

We can consider a three dimensional object to be composed of two dimensional slices which are stacked, one on top of the other. Instead of looking at the absorption of X-rays over a composite stack of these slices, we can choose to study the absorption of X-rays as they pass through an individual slice. To do this, the absorption properties over the finite thickness of the slice must be assumed to be constant. The type of imaging produced by looking at the material composition and properties of a slice is known as a tomography. The absorption of X-rays as they pass through a slice provides a single profile of the X-ray intensity. This profile is characteristic of the material in the slice.

A single profile of the X-ray intensity associated with a particular slice only provides a qualitative account of the distribution of material in a slice. In other words, we only have one-dimensional information about a two dimensional object just as in conventional X-ray radiography, we only have two-dimensional information (an image) about a three dimensional object. A further degree of information can be obtained by changing the direction of the X-ray beam. This is determined by the angle of rotation θ of a slice relative to the source or equivalently, the location of the source relative to the slice. Either way, further information on the composition of the material may be obtained by observing how the X-ray intensity profile varies with the angle of rotation.

In X-ray imaging, computer tomography provides a quantitative image of the absorption coefficient of X-rays with initial intensity I₀. If an X-ray passes through a homogeneous material with attenuation coefficient α over a length L, then the resulting intensity is just

I=I₀exp(−αL)

If the material is inhomogeneous, then we can consider the path along which the ray travels to consist of different attenuation coefficients αᵢ over elemental lengths Δlᵢ. The resulting intensity is given by

I=I₀exp[−(α₁Δl₁+α₂Δl₂+ . . . +α_{N}Δl_{N})]

where

$${\sum }_{i = 1}^{N`} Δ {l}_{i} = L$$

As Δlᵢ→0, this result becomes

$$I = {I}_{0} exp ( - {\int }_{L}^{} α ⅆ l )$$

By computing the natural logarithm of I/I₀, we obtain the data

$$P = {\int }_{L}^{} α ⅆ l$$

$$where$$

$$P = - ln ( \frac{I}{{I}_{0}} )$$

The value of the intensity and therefore P depends upon the point where the ray passes through the object which shall be denoted by z. It also depends on the orientation of the object about its centre θ. Hence, by adjusting the source of X-rays and the orientation of the attenuating object, a full sequence of projections can be obtained which are related to the two dimensional attenuation coefficient α(x, y) by the equation

$$P ( z , θ ) = {\int }_{L}^{} α ( x , y ) ⅆ l$$

where dl is an element of a line passing through the function α(x, y) and L depends on z and θ. This function is a line integral through the two- dimensional X-ray absorption coefficient α(x, y). It is a projection of this function and characteristic of θ. If P is known for all values of z and θ, then P is the Radon transform of α and that α can be reconstructed from P by employing the inverse Radon transform.

Advances in CT scanning have been closely related to the development of faster and more effective algorithms in conjunction with technological improvements in hardware. The modern scanned images have come a long way since the original body scanning pictures produced by Hounsfield in 1970. Major advances have occurred with the development of a new generation of scanners called Dynamic Spatial Reconstructors. These machines provide two very powerful new dimensions to computed tomography; high resolution and synchronous (fully three dimensional) scanning. Their capabilities have revolutionized present day medical imaging capabilities. For example, they allow the dynamic study of anatomical structural and functional relationships of moving organ systems such as heart, lungs and circulatory systems. These new generation CT systems are now capable of simultaneous three dimensional reconstructions of vascular anatomy and circulatory dynamics in any region of the body.

Ultrasonic Computed Tomography

As in X-ray computed tomography, the aim of Ultrasonic Computed Tomography (UCT) is to reconstruct transverse cross sectional images from projection data obtained when a probe (ultrasound in this case) passes through the object. Under appropriate conditions, the probe may be used to determine ultrasonic attenuation and ultrasonic velocity distributions of an inhomogeneous object. The latter case is based on emitting short pulses of ultrasound and recording the time taken for each pulse to reach a detector. If the material in which the pulse propagates is homogeneous, the ‘time-of-flight’ for the pulse to traverse the distance between source and detector along a line L, is given by the expression

$$t = \frac{L}{υ}$$

where v is the velocity at which the pulse propagates through the material. If the material is homogeneous along L, then the time of flight becomes

$$t ( z , θ ) = {\int }_{L}^{} \frac{ⅆ l}{υ ( x , y )}$$

A tomogram of the inhomogeneous velocity of the material can then be obtained by inverting the above equation. This result is the basis of UCT imaging.

In addition to performing ‘time-of-flight’ experiments, the decay in amplitude of the ultrasonic probe can be measured. This allows a tomogram of the ultrasonic absorption of a material to be obtained. Images of this kind may be interpreted as maps of the viscosity of the material since it is the viscous nature of a material that is responsible for absorbing ultrasonic radiation. By using electromagnetic probes, we can obtain information about the spatial distribution of the dielectric characteristics of a material using an appropriate time of flight experiment or the conductivity of a material by measuring the decay in amplitude of the electromagnetic field.

Emission Computed Tomography

Emission Computed Tomography (ECT) refers to the use of radioactive isotopes as passive probes. The passive approach does not require external probes. There is a probe involved but it comes from the object itself. In the case of ECT, we determine the distribution (location and concentration) of some radioactive isotope inside an object by studying the emitted photons.

There are two basic types of ECT depending on whether the isotope utilized is a single photon emitter, such as iodine-131, or a positron (e⁺ or β⁺) emitter, such as carbon-11. When a β⁺ emitter is used, the ejected positron loses most of its energy over a few millimetres. As it comes to rest, it annihilates with a nearby electron resulting in the formation of two γ-ray photons which travel in opposite directions along the same path. If a ring of detectors is placed around the object and two of the detectors simultaneously record γ-ray photons, then the radio-nucleide is known to lie somewhere along the line between the detectors. The reconstruction problem can therefore be cast in terms of the Radon transform where a complete set of projections is a measure of the total radio-nucleide emission.

The use of ECT has provided a dramatic advancement in nuclear medicine including investigations into brain and heart metabolisms. Other possibilities include new methods for cancer detection. In engineering applications ECT has be used to investigate the distribution of oil in different engines for example by doping the oil with a suitable radio-nucleide

Diffraction Tomography

Diffraction tomography is a method of imaging which is based on reconstructing an object from measurement on the way in which it diffracts a wavefield probe. Unlike X-ray CT, this involves the use of a radiation field whose wavelength is the same order of magnitude as the object (e.g. ultrasound, with a wavelength ˜10⁻³ m for example and millimetric microwaves). Two methods have been researched to date using (i) CW (Continuous Wave) fields and (ii) pulsed fields. In the latter case, it can been shown that the time history of the diffraction pattern set-up by a short pulse of radiation is related to the internal structure of the diffracting object by the Radon transform. Hence, in principle, the object can be reconstructed by employing algorithms for computing the inverse Radon transform.

Computer Vision

An interesting applications of the Radon transform has been in the area of computer vision. Computer vision is concerned with the analysis and recognition of features in an images. It is particularly important to manufacturing industry for automatic inspection and for military applications (e.g. guided weapons systems and automatic targeting).

The projection transform utilized in computer vision is the Hough transform. The Hough transform was derived independently from the Radon transform in the early 1960s. However, the Hough transform is just a special case of the Radon transform and is used in the identification of lines in digital images.

The Radon transform of a function concentrated at a point, described by the 2D delta function

δ²(x−x₀, y−y₀)=δ(x−x₀)δ(y−y₀)

yields a sinusoidal curve

p=x₀ cos θ+y₀ sin θ

in pθ-plane. All co-linear points in the xy-plane along a line determined by fixed values θ and p, map to sinusoidal curves in the pθ-plane and intersect in the same point. Thus, if we choose a suitable method for plotting the projections of a digital image as a function of θ and p, it follows that the Radon transform may be regarded as a line to point transformation. By utilizing the line detection properties of the Radon transform, the edges of manufactured objects can be analysed against there known characteristics. From these characteristics, identification of faults can be spotted.

Other areas of science which are realising the important properties of the Radon transformation include the fields of astronomy, optics, and nuclear magnetic resonance.

5.3 The Radon Transform

In this section, the Radon transform of a two-dimensional ‘Object Function’ ƒ(x, y) on a Euclidean space will be discussed. To start with, the geometry of the Radon transform shall be presented to provide a conceptual guide to its operation and transformation properties. This will be followed by a rigourous mathematical derivation of the Radon transform which is based entirely on the analytical properties of the two-dimensional Dirac delta function.

A Conceptual Guide to the Radon Transform

Consider an inhomogeneous object of compact support, defined in a two-dimensional Cartesian space by the object function ƒ(x, y). The mapping defined by the projection or line integral of ƒ along all possible lines L can be written in the form

$$P = {\int }_{L}^{} f ( x , y ) ⅆ l$$

where dl is an increment of length along L.

The projection P depends on two variables; the angle of rotation of the object in the xy-plane and the distance z of the line of integration L from the centre of the object. Hence, the equation above represents a mapping from (x, y) cartesian co-ordinates to (z, θ) polar coordinates. This can be indicated explicitly by writing

$$P ( z , θ ) = {\int }_{L ( x , θ )}^{} f ( x , y ) ⅆ l \qquad ( 5.1 )$$

If P(z, θ) is known for all z and θ, then P(z, θ) is the Radon transform of ƒ(x, y), i.e.

P=\hat{R}ƒ

where \hat{R} is the Radon transform operator.

There are a number of equivalent ways of attempting to define the Radon transform operator \hat{R}. The approach used here is one of defining \hat{R} in terms of a two-dimensional integral transform, the Kernel of this transform being the Dirac delta function which allows a range of analytical properties to be exploited. The main mathematical results are defined in the following section, where the function P (the Radon transform of the object function ƒ) is shown to be related to ƒ by

P(z, θ)=\hat{R}ƒ(x, y)=∫ƒ(r)δ(z−\hat{n}·r)d²r

where \hat{n} is a unit vector which points in a direction perpendicular to the family of parallel lines of integration L. The integral in the equation above is taken over the spatial extent of the object function ƒ which is taken to have finite support.

Noting that

\hat{n}·r=x cos θ+y sin θ

the equation for the projections P(z, θ) becomes

P(z, θ)=∫∫ƒ(x, y)δ(z−x cos θ−y sin θ)dxdy

This function only exits when

z=x cos θ+y sin θ

the delta function being zero otherwise. The equivalence between this definition for P and the one given by equation (5.1) becomes clear if we consider a projection to be just the family of line integrals through the object function when it has been rotated about its axis by an angle θ. To illustrate this, consider the case when θ=0. In this case, using the equation for P above we get

P(z, 0)=∫∫ƒ(x, y)δ(z−x)dxdy=∫ƒ(z, y)dy

Here, the projection P(z, 0) is obtained by integrating the object over y for all values of the projection co-ordinate z. As a second example, consider the case when θ=π/2, giving

P(z, π/2)=∫∫ƒ(x, y)δ(z−y)dxdy=∫ƒ(x, y)dx

In this case, the projection is obtained by integrating along x for all values of z.

The material discussed here is concerned with methods of computing both the forward and inverse Radon transform. The former case involves computing the integral given in equation (5.1). The inverse Radon transform is concerned with solving the problem of reconstructing the object function ƒ(x, y) given the projections P(z, θ) for all values of z and θ, i.e. inverting the integral transform

P=\hat{R}ƒ

giving

ƒ=\hat{R}⁻¹P

where R⁻¹ is the inverse Radon transform operator. The problem is therefore compounded in developing accurate and efficient methods for computing \hat{R}⁻¹ using a digital computer.

5.4 Derivation of the Radon Transform

In this section, the Radon transform shall be derived using the analytical properties of the two-dimensional Dirac delta function alone. Various results shall be employed with the aim of expressing the two-dimensional delta function in a prescribed integral form. The result will then be combined with the sampling property of the two-dimensional delta function to obtain a formal definition of the Radon transform and its inverse. Unless stated otherwise, all integral lie between −∞ and ∞.

We begin by defining the two-dimensional delta function,

δ²(r−r₀)=δ(x−x₀)δ(y−y₀)

where

r=\hat{x}x+ŷy

and

r₀=\hat{x}x₀+ŷy₀

\hat{x} and ŷ being unit vectors in the x and y direction respectively. We now employ the following integral representation for the two-dimensional delta function,

$${δ}^{2} ( r - {r}_{0} ) = \frac{1}{{( 2 π )}^{2}} \int {\int }_{}^{} exp [ ⅈ k \cdot ( {r}_{0} - r ) ] {ⅆ}^{2} k = \\ \frac{1}{{( 2 π )}^{2}} \int \int exp ( ⅈ k \hat{n} \cdot {r}_{0} ) exp ( - ⅈ k \hat{n} \cdot r ) {ⅆ}^{2} k \\ where \\ \hat{n} = \frac{k}{k} ; k = \vert k \vert \qquad \text{(5.2)}$$

Also, we introduce the relationship (a consequence of the sampling property of the delta function)

∫δ(z−\hat{n}·r) exp(−ikz)dz=exp(−ik\hat{n}·r)

Substituting this result in to equation (5.2), we obtain

$${δ}^{2} ( r - {r}_{0} ) = \frac{1}{{( 2 π )}^{2}} \int \int {ⅆ}^{2} k exp ( ⅈ k \hat{n} \cdot {r}_{0} ) \int δ ( z - \hat{n} \cdot r ) exp ( - ⅈ kz ) ⅆ z$$

At this stage, it is useful to convert to polar co-ordinates d²k=kdkdθ, giving (after combining the exponential terms)

$${δ}^{2} ( r - {r}_{0} ) = \frac{1}{{( 2 π )}^{2}} {\int }_{0}^{2 π} ⅆ θ {\int }_{0}^{∞} ⅆ k k \int ⅆ z exp [ ⅈ k ( \hat{n} \cdot {r}_{0} - z ) \vert δ ( z - \hat{n} \cdot r )$$

We can then write the two-dimensional delta function in the following alternative form,

$${δ}^{2} ( r - {r}_{0} ) = \frac{1}{{( 2 π )}^{2}} {\int }_{0}^{π} \int ⅆ k \vert k \vert \int ⅆ z exp [ ⅈ k ( \hat{n} \cdot {r}_{0} - z ) ] δ ( z - \hat{n} \cdot r )$$

If we now employ the sgn function defined by

$$sgn ( k ) = \{ \begin{matrix}+ 1 , & k \geq 0 ; \\ - 1 , & k > 0.\end{matrix}$$

then |k | can be re-written as k sgn(k) so that

$${δ}^{2} ( r - {r}_{0} ) = \frac{1}{{( 2 π )}^{2}} {\int }_{0}^{π} ⅆ θ \int ⅆ k sgn ( k ) k \int ⅆ z exp [ ⅈ k ( \hat{n} \cdot {r}_{0} - z ) ] δ ( z - \hat{n} \cdot r ) \qquad \text{(5.3)}$$

We can progress further by utilizing the result

$$\begin{matrix}\frac{\partial }{\partial z} δ ( z - \hat{n} \cdot r ) = \frac{\partial }{\partial z} ( \frac{1}{2 π} \int exp [ ⅈ k ( z - \hat{n} \cdot r ) ] ⅆ k ) \\ = ⅈ k ( \frac{1}{2 π} \int exp [ - ⅈ k ( z - \hat{n} \cdot r ) ] ⅆ k ) - ⅈ k δ ( z - \hat{n} \cdot r )\end{matrix}$$

After multiplying both sides of this equation by exp(−ikz) and integrating over z, we obtain the relation

$$k \int δ ( z - \hat{n} \cdot r ) exp - ( ⅈ kz ) ⅆ z = - i \int ( \frac{\partial }{\partial z} δ ( z - \hat{n} \cdot r ) ) exp ( ⅈ kz ) ⅆ z$$

Substituting this result back into equation (5.3) and changing the order of integration, we get

$${δ}^{2} ( r - {r}_{0} ) = \frac{- i}{{( 2 π )}^{2}} {\int }_{0}^{π} ⅆ θ \int ⅆ z ( \frac{\partial }{\partial z} δ ( z - \hat{n} \cdot r ) ) \int ⅆ k sgn ( k ) exp [ ⅈ k ( \hat{n} \cdot {r}_{0} - z ) ]$$

Finally, we use the result

$$\int \frac{1}{u} exp ( - ⅈ ku ) ⅆ u = - ⅈπsgn ( k )$$

where u is a dummy variable. The left hand side of this equation is just the Fourier transform of 1/u. Hence, on taking the inverse Fourier transform, we obtain

$$\frac{1}{u} = \frac{1}{2 π} \int ( - ⅈ π ) sgn ( k ) exp ( ⅈ ku ) ⅆ k = - \frac{i}{2} \int sgn ( k ) exp ( ⅈ ku ) ⅆ k$$

or, after rearranging,

$$\int ⅆ k sgn ( k ) exp ( ⅈ ku ) = \frac{2 i}{u}$$

Substituting this result back into the last expression for δ², we obtain our desired integral form for the two-dimensional delta function, i.e.

$${δ}^{2} ( r - {r}_{0} ) = - \frac{1}{2 {π}^{2}} {\int }_{0}^{π} ⅆ θ \int ⅆ z \frac{1}{z - \hat{n} \cdot {r}_{0}} \frac{\partial }{\partial z} δ ( z - \hat{n} \cdot r )$$

This expression for the two-dimensional delta function allows us to derive both the forward and inverse Radon transforms relatively easily. This can be done by using the sampling property of the two-dimensional delta function, namely,

$$f ( {r}_{0} ) = \int f ( r ) {δ}^{2} ( r - {r}_{0} ) {ⅆ}^{2} r$$

Substituting the expression for δ² given above into this equation and interchanging the order of integration, we get

$$\begin{matrix}f ( {r}_{0} ) = - \int f ( r ) \frac{1}{2 {π}^{2}} {\int }_{0}^{π} ⅆ θ \int ⅆ z \frac{1}{z - \hat{n} \cdot {r}_{0}} \frac{\partial }{\partial z} δ ( z - \hat{n} \cdot r ) {ⅆ}^{2} r \\ = - \frac{1}{2 {π}^{2}} {\int }_{o}^{π} ⅆ θ \int ⅆ z \frac{1}{z - \hat{n} \cdot {r}_{0}} \frac{\partial }{\partial z} P ( \hat{n} , z )\end{matrix} \qquad ( 5.4 )$$

where

P(\hat{n}, z)=\hat{R}ƒ(r)=∫ƒ(r)δ(z−\hat{n}·r)d²r

The function P is defined as the Radon transform of ƒ. The beauty of deriving the Radon transform in this way is that the inverse Radon transform is immediately apparent from equation (5.4), i.e.

$$f ( r ) = {\hat{R}}^{- 1} P ( \hat{n} , z ) = - \frac{1}{2 {π}^{2}} {\int }_{0}^{π} ⅆ θ \int ⅆ z \frac{1}{z - \hat{n} \cdot r} \frac{\partial }{\partial z} P ( \hat{n} , z )$$

5.5 Reconstruction Methods

The formula for reconstructing a function from its Radon transform is given by

$$f ( r ) = {\hat{R}}^{- 1} P ( \hat{n} , z ) = - \frac{1}{2 {π}^{2}} {\int }_{0}^{π} ⅆ θ \int ⅆ z \frac{1}{z - \hat{n} \cdot r} \frac{\partial }{\partial z} P ( \hat{n} , z ) \qquad \text{(5.5)}$$

This formula is always valid is cases where P is continuous over an infinite set of projections for all lines, rather than a discrete set. This result is compounded in the Indeterminacy Theorem which states that ‘A function of compact support in two dimensional Radon space is uniquely determined by an infinite set; but by no finite set of its projections’. Thus a digital reconstruction process based on equation (5.5) will only be an approximation of the actual object by non-unique approximations. In other words, although the unknown function cannot be reconstructed exactly, good approximations can be found by utilising an increasingly large number of projections.

This section is concerned with methods of computing the inverse Radon transform given by equation (5.5). The reconstruction methods presented are:

(i) Reconstruction by Filtered Back-Projection.

(ii) Reconstruction by Back-Projection and Deconvolution.

(iii) Reconstruction using the Projection Slice Theorem.

Theoretically, all these methods are completely equivalent and are essentially variations on equation (5.5). However, computationally, each method poses a different set of problems and requires an algorithm whose computational performance can vary significantly depending on the data type and its structure.

The first two reconstruction methods listed above use the back-projection process as an intermediate step and are classified according to whether filtering is applied before (i) or after (ii) back-projection. In the following section, the back-projection process is discussed.

Back-Projection

The result B(x, y) of back-projecting a sequence of projections,

P(z,θ); z=x cos θ+y sin θ

can be written as

$$B ( x , y ) = \frac{1}{2 π} {\int }_{0}^{π} P ( x cos θ + y sin θ , θ ) ⅆ θ$$

In polar co-ordinates (r, θ′) where x=r cos θ′ and y=r sin θ′, we have

$$B ( r , θ ) = \frac{1}{2 π} {\int }_{0}^{π} P [ r cos ( {θ}^{′} - θ ) , {θ}^{′} ] ⅆ {θ}^{′} \qquad \text{(5.6)}$$

This result will be used later on. The function P(x cos θ+y sin θ, θ) is the distribution of P along the family of lines L. For a fixed value of θ, P(x cos θ+y sin θ, θ) is constructed by assigning the value of P at a point on z to all points along the original line of projection L. By repeating the process for all values of z and for each value of θ, the function P(x cos θ+y sin θ, θ) is obtained. Then, by summing all the functions P obtained for different values of θ between 0 and π, the back-projection function B is computed.

The back-projected function is a ‘blurred’ representation of the true object function. This necessitates a filtering operation to amplify the high frequency content of B. The required filter is obtained by performing a Fourier analysis of the operation

$$\int ⅆ z \frac{1}{z - \hat{n} \cdot r} \frac{\partial }{\partial z} P ( \hat{n} , z )$$

in equation (5.5).

Reconstruction by Filtered Back-Projection

In this section, we analyse the reconstruction of ƒ from P in terms of an appropriate set of operators. This makes the task of formulating an appropriate filtering operation easier. To start with, let us re-write equation (5.5) in the form

$$f ( r ) = - \frac{1}{2 π} {\int }_{0}^{π} ⅆ θ \frac{1}{π} \int ⅆ z \frac{1}{z - \hat{n} \cdot r} \frac{\partial }{\partial z} P ( \hat{n} , z )$$

Observe, that the integral over z is just the Hilbert transform of

$$\frac{\partial }{\partial z} P ( \hat{n} , z )$$

If we denote the Hilbert transform operator by Ĥ, then we can write

$$\hat{H} {\partial }_{x} P ( \hat{n} , z ) = \frac{1}{π} \int \frac{{\partial }_{x} P ( \hat{n} , z )}{z - \hat{n} \cdot r} ⅆ z$$

where, for convenience,

$${\partial }_{x} ≡ \frac{\partial }{\partial z}$$

Note, that the Hilbert transform is just a convolution in z. Let us also denote the back-projection process by the operator \hat{B}, i.e.

$$\hat{B} f ( \hat{n} , \hat{n} \cdot r ) = \frac{1}{2 π} {\int }_{0}^{π} f ( \hat{n} , \hat{n} \cdot r ) ⅆ θ$$

Using these operators, equation (5.5) can be written in the form

ƒ(r)=\hat{R}⁻¹P(\hat{n}, z)=\hat{B}Ĥ∂ₓP(\hat{n}, z)

It is now clear that the inverse Radon transform as actually composed of three separate operations;

differentiation ∂ₓ

Hilbert transform Ĥ

Back-projection \hat{B}

We can illustrate this by introducing the operator equivalence relationship,

\hat{R}⁻¹=\hat{B}Ĥ∂ₓ

Since the Hilbert transform is a linear functional, we have

Ĥ∂ₓP=∂ₓĤP

so the order in which the first operations are carried out (prior to back-projecting) does not matter.

The computational method which involves the operation \hat{B}Ĥ∂ₓ is known as Filtered Back-projection, the filtering being a consequence of the operation Ĥ∂ₓ. The exact form of the filter that is associated by this operation can be found by Fourier analysis. For a fixed value of \hat{n} we can write

$$\hat{H} {\partial }_{z} = \frac{1}{πz} ⊗ \frac{\partial P}{\partial z}$$

where P is the projection obtained for a given \hat{n} and [symbol] is the convolution operation. To find the filter we need to Fourier analyse this expression. This can be done by using the results

$${\hat{F}}_{1} \frac{\partial P}{\partial z} = ik {\hat{F}}_{1} P$$

$$and$$

$${\hat{F}}_{1} ( \frac{1}{πz} ) = - i sgn ( k )$$

where \hat{F}₁ is the one-dimensional Fourier transform operator and k is the spatial frequency and gives

\hat{F}(Ĥ∂ₓP)=−i sgn(k)(ik\hat{F}₁P)

Now,

−i sgn(k)(ik)=sgn(k)k=|k|

Hence, the operation Ĥ∂ₓP in real space is equivalent to applying the filter |k| in Fourier space. We can therefore write the reconstruction formula given by equation (5.5) in the form

ƒ(r)=\hat{B}\hat{F}₁⁻¹[|k|\hat{F}₁P(\hat{n}, z)]

Reconstruction by Back-Projection and Deconvolution

Another method of reconstructing ƒ from P can be acquired by considering the effect of back-projecting without filtering. The result will be some blurred version of the object function. The blurring inherent in such a reconstruction can be represented mathematically by the convolution of the object function with a PSF. By computing the functional form of the PSF, we can deconvolve, thus reconstructing the object.

The PSF can be computed by back-projecting the projections obtained from a single radially symmetric point located at (0, 0) described analytically by a two-dimensional delta function. The projection of a two-dimensional delta function, is a one-dimensional delta function and so in this case, we have,

P(x cos θ+y sin θ, θ)=δ(x cos θ+y sin θ), ∀θ

To compute the back-projection function, it is convenient to use a polar co-ordinate system. Thus, writing the above equation in (r, θ′) co-ordinates (i.e. writing x=r cos θ′ and y=r sin θ′) and substituting the result into equation (5.6), we obtain

$$B ( r , θ ) = \frac{1}{2 π} {\int }_{0}^{π} δ [ r cos ( θ - {θ}^{′} ) ] ⅆ {θ}^{′} = \frac{1}{r}$$

Hence, the PSF is given by

$$P ( x , y ) = \frac{1}{\sqrt{{x}^{2} + {y}^{2}}}$$

The back-projection function obtained from the sequence of projections taken through an object function ƒ is therefore given by

B(x, y)=P(x, y) [symbol] [symbol] ƒ(x, y)

In order to reconstruct ƒ from B we must deconvolve. This can be done by processing the equation above in Fourier space. Denoting the two-dimensional Fourier transform operator by \hat{F}₂, and using the convolution theorem, we can write

\tilde{B}(kₓ, k_{y})=\tilde{P}(kₓ, k_{y})\tilde{ƒ}(kₓ, k_{y})

where

\tilde{ƒ}(kₓ, k_{y})=\hat{F}₂ƒ(x, y)

\tilde{P}(kₓ, k_{y})=\hat{F}₂P(x, y)

and

\tilde{B}(kₓ, k_{y})=\hat{F}₂B(x, y)

Rearranging

$$\tilde{f} ( {k}_{x ,} {k}_{y} ) = \frac{\tilde{B} ( {k}_{x ,} {k}_{y} )}{\tilde{P} ( {k}_{x ,} {k}_{y} )}$$

The function 1/\tilde{P} is called the inverse filter and can fortunately be computed analytically. The result is

$$P ( {k}_{x ,} {k}_{y} ) = \frac{1}{\sqrt{{k}_{x}^{2} + {k}_{y}^{2}}}$$

Hence, we arrive at the following reconstruction formula for the object function

ƒ(x, y)=\hat{F}₂⁻¹[|k |\tilde{B}(kₓ, k_{y})]

where k is the two-dimensional spatial frequency vector (k=\hat{x}kₓ+ŷk_{y}). Unfiltered back-projection produces a reconstruction which can be considered to be a blurred low-pass filtered image of the object function due to the poor transmission of high spatial frequencies. Deconvolution amplifies the high spatial frequencies inherent in the back-projection function.

Reconstruction Using the Projection Slice Theorem

The two-dimensional version of the Projection Slice Theorem (also known as the Central Slice Theorem) provides a relationship between the Radon transform of an object and its two dimensional Fourier transform. The theorem shows that the one dimensional Fourier transform of a projection at a given angle θ is equal to the function obtained by taking a radial slice through the two dimensional Fourier domain of the object at the same angle θ.

The proof of the central slice theorem comes from analysing the two-dimensional Fourier transform of an object function ƒ(r) given by

\tilde{ƒ}(k\hat{n})=\hat{F}₂ƒ(r)=∫ƒ(r) exp(−ik\hat{n}·r)d²r

Substituting the result

exp(−ik\hat{n}·r)=∫exp(−-ikz)δ(z−\hat{n}·r)dz

into this equation, and changing the order of integration, we obtain

$$\tilde{f} ( k \hat{n} ) = \int f ( r ) \int ⅆ z exp ( - ⅈ kz ) δ ( z - \hat{n} \cdot r ) {d}^{2} r = \int ⅆ z exp ( - ⅈ kz ) \int f ( r ) δ ( z - \hat{n} \cdot r ) {d}^{2} r$$

Observe, that the integral over r is just the Radon transform of ƒ and the integral over z is a one-dimensional Fourier transform. Using operator notation, we can write this result in the form

\tilde{ƒ}(k\hat{n})=\hat{F}₁P(\hat{n}, z)

or

\hat{F}₂ƒ(r)=\hat{F}₁P(\hat{n}, z)

where

P(\hat{n}, z)=\hat{R}ƒ(r)

This theorem provides yet another way of reconstructing an object function from a set of its projections; a method which is compounded in the reconstruction formula

ƒ(r)=\hat{F}₂⁻¹[\hat{F}₁P(\hat{n}, z)]

6. Summary

Deconvolution is concerned with the restoration of a signal or image from a recording which is resolution limited and corrupted by noise. This document has been concerned with a class of solutions to this problem which are based on different criteria for solving ill-posed problems (e.g. the least squares principle and the maximum entropy principle) in the case when the noise is additive.

Three cases have been discussed:

(i) The object is convolved with a Point Spread Function whose spectrum is continuous (e.g. a Gaussian Point Spread Function).

(ii) The object is convolved with a sinc Point Spread Function whose spectrum is discontinuous and consequently gives rise to a bandlimited image.

(iii) The image is reconstructed from a complete set of parallel projections.

Solutions to the first problem have been discussed which are based on the Wiener filter, Power Spectrum Equalization filter, the Matched filter and the Maximum Entropy Method. In addition, Bayesian estimation methods have been considered which rely on a priori information on the statistics (compounded in models for the Probability Density Function) of the noise function nᵢⱼ and object function ƒᵢⱼ. The Maximum Likelihood and Maximum a Posteriori methods are both forms of Bayesian estimation. In this report, only Gaussian statistics have been considered to illustrate the principles involved.

In all cases, knowledge of the characteristic function of the imaging system (i.e. the Point Spread Function) is required together with an estimate of the signal to noise ratio (SNR). The success of these methods depends on both the accuracy of the Point Spread Function and the SNR value used. An optimum restoration is then obtained by experimenting with different values of SNR for a given Point Spread Function.

In some cases, the PSF may either be difficult to obtain experimentally or simply not available. In such cases, it must be estimated from the data alone. This is known as ‘Blind Deconvolution’. If it is known a priori that the spectrum of the object function is ‘white’ (i.e. the average value of each Fourier component is roughly the same over the entire frequency spectrum), then any large scale variations in the recorded spectrum should be due to the frequency distribution of the PSF. By smoothing the data spectrum, an estimate of the instrument function can be established. This estimate may then be used to deconvolve the data by employing an appropriate filter.

The optimum value of the SNR when applied to the Wiener filter for example, can be obtained by searching through a range of values and for each restored image, computing the ratio of the magnitude of the digital gradient to the number of zero crossing's. This ratio is based on the idea that the optimum restoration is one which provides a well focused image with minimal ringing.

The problem of reconstructing a bandlimited function from limited Fourier data is an ill-posed problem. Hence, practical digital techniques for solving this problem tend to rely on the use of a priori information to limit the class of possible solutions. In this report, the least squares principle has been used as the basis for a solution and then modified to incorporate a priori information and provide a data consistent result. In this sense, the algorithm derived belongs to the same class as the Wiener filter and like the Wiener filter ultimately relies on the experience and intuition of a user for optimization.

Section 5 of this report discussed the problem of reconstruction from projections—a problem which is compounded in the forward and inverse Radon transform. Three types of reconstruction techniques have been derived, namely, back-projection and deconvolution, filtered back-projection and reconstruction using the central slice theorem. Although this problem is more specialised compared to deconvolution in general, it is still an important area of imaging science and has therefore been included for completeness. In addition, the Radon transform together with the Hough transform (a derivative of the Radon transform) is being used for image processing in general, in particular, for computer vision.

A detailed discussion of the computer implementation of the techniques discussed is beyond the scope of this work. However, Appendix B provides some example C-code for the 2D FFT, convolution and the Wiener filter which is provided to give the reader some additional appreciation of the software used to implement the results (i.e. filters) derived.

All the methods of restoration and reconstruction discussed here are based on the fundamental imaging equation

s=p [symbol] [symbol] ƒ+n

which is a stationary model where the (blurring) effect of the PSF on the object function is the same at all locations on the ‘object plane’. In some cases, a stationary model is not a good approximation for s. Non-stationary models (in which the value of functional form of p changes with position) cannot use the methods discussed to restore/reconstruct a digital image. The basic reason for this is that the convolution theorem for a non-stationary convolution operation does not apply. However, it is possible to write out a (discrete) non-stationary convolution in terms of a matrix operation. The non-stationary deconvolution problem is then reduced to solving a large set of linear equations, the characteristic matrix being determined by the variable PSF. Another approach is to partition the image into regions in which a stationary model can be applied and deconvolve for each partition separately.

7. Further Reading

Andrews H C and Hunt B R, Digital Image Reconstruction, Prentice-Hall, 1977

Bates R H T and McDonnel M J, Image Restoration and Reconstruction, Oxford Science Publications, 1986.

Deans S R, The Radon Transform and some of its Applications, Wiley-Interscience, 1983.

Rosenfeld A and Kak A C, Digital Picture Processing, Academic Press, 1980.

Sanz J L C, Hinkle E B and Jain A K, Radon and Projection Transform-Based Computer Vision, Springer-Verlag, 1988.

Appendix A: The Least Squares Method, the Orthogonality Principle, Norms and Hilbert Spaces

The least squares method and the orthogonality principle are used extensively in signal and image processing. This appendix has been written to provide supplementary material which would be out of context in the main body of this report.

The Least Squares Principle

Suppose, we have a real function ƒ(x) which we want to approximate by a function \hat{ƒ}(x). We can choose to construct \hat{ƒ} in such a way that its functional behaviour can be controlled be adjusting the value of a parameter a say. We can then adjust the value of a to find the best estimate \hat{ƒ} of ƒ. What is the best value of a to choose?

To solve this problem, we can construct the mean square error

e=∫[ƒ(x)−\hat{ƒ}(x, a)]²dx

where the integral is over the spatial support of ƒ(x). This error is a function of a. The value of a which produces the best approximation \hat{ƒ} of ƒ is therefore the one where e(a) is a minimum. Hence, a must be chosen so that

$$\frac{\partial e}{\partial a} = 0$$

Substituting the expression for e into the above equation and differentiating we obtain

$$\int [ f ( x ) - \hat{f} ( x , a ) ] \frac{\partial }{\partial a} \hat{f} ( x , a ) ⅆ x = 0$$

Solving this equation for \hat{ƒ} provides the minimum mean square estimate for ƒ. This method is known generally as the least squares principle.

Linear Polynomial Models

To use the least squares principle, some sought of model for the estimate \hat{ƒ} must be introduced. Suppose we expand \hat{ƒ} in terms of a linear combination of (known) basis functions yₙ(x), i.e.

$$\hat{f} ( x ) = {\sum }_{n}^{} {a}_{n} {y}_{n} ( x )$$

For simplicity, let us first assume that ƒ is real. Since, the basis functions are known, to compute \hat{ƒ} the coefficients aₙ must be found. Using the least squares principle, we require aₙ such that the mean square error

$$e = \int {( f ( x ) - {\sum }_{n}^{} {a}_{n} {y}_{n} ( x ) )}^{2} ⅆ x$$

is a minimum. This occurs when

$$\frac{\partial e}{\partial {a}_{m}} = 0 ∀ m$$

Differentiating,

$$\frac{\partial }{\partial {a}_{m}} \int {( f ( x ) - {\sum }_{n}^{} {a}_{n} {y}_{n} ( x ) )}^{2} ⅆ x = 2 \int ( f ( x ) - {\sum }_{n}^{} {a}_{n} {y}_{n} ( x ) ) \frac{\partial }{\partial {a}_{m}} ( f ( x ) - {\sum }_{n}^{} {a}_{n} {y}_{n} ( x ) ) ⅆ x$$

Now

$$\frac{\partial }{\partial {a}_{m}} ( f ( x ) - {\sum }_{n}^{} {a}_{n} {y}_{n} ( x ) ) = - \frac{\partial }{\partial {a}_{m}} {\sum }_{n}^{} {a}_{n} {y}_{n} ( x )$$

$$\begin{matrix} = - \frac{\partial }{\partial {a}_{m}} ( … + {a}_{1} {y}_{1} ( x ) + {a}_{2} {y}_{2} ( x ) + … + {a}_{n} {y}_{n} ( x ) + … ) \\ = - {y}_{1} ( x ) , m = 1 \\ = - {y}_{2} ( x ) , m = 2 \\ ⋮ \\ = - {y}_{m} ( x ) , m = n\end{matrix}$$

Hence,

$$\frac{\partial e}{\partial {a}_{m}} = - 2 \int ( f ( x ) - {\sum }_{n}^{} {a}_{n} {y}_{n} ( x ) ) {y}_{m} ( x ) ⅆ x = 0$$

The coefficients aₙ which minimize the mean square error for a linear polynomial model are therefore obtained by solving the equation

$$\int f ( x ) {y}_{m} ( x ) {\sum }_{n}^{} {a}_{n} \int {y}_{n} ( x ) {y}_{m} ( x ) ⅆ x$$

for aₙ.

The Orthogonality Principle

The above result demonstrates that the coefficients aₙ are such that the error ƒ−\hat{ƒ} is orthogonal to the basis functions yₘ. We can write this result in the form

[symbol]

ƒ−\hat{ƒ}, yₘ [symbol] ≡∫[ƒ(x)−\hat{ƒ}(x)]yₘ(x)dx=0

This is known as the orthogonality principle.

Complex Functions, Norms and Hilbert Spaces

Consider the case when ƒ is a complex function. In this case, \hat{ƒ} must be a complex estimate of this function. We should therefore also assume that both yₙ and aₙ are complex for generality.

The mean square error should then be defined by

$$e = \int {\vert f ( x ) - {\sum }_{n}^{} {a}_{n} {y}_{n} ( x ) \vert}^{2} ⅆ x$$

The operation

(∫|ƒ(x)|²dx)^{1/2}

defines the Euclidean norm of the function ƒ which is denoted by the sign ∥•∥. If ƒ is discrete and—sampled at points ƒₙ say, then the Euclidean norm is defined by

$${( {\sum }_{n}^{} \vert {f}_{n} \vert )}^{\frac{1}{2}}$$

Using this notation, we can write the mean square error in the form

e=∥ƒ(x)−\hat{ƒ}(x)∥²

which saves having to write integral signs (for piecewise continuous functional analysis) or summation signs (for discrete functional analysis) all the time. Note, there are many other definitions of norms which fall into the general classification

$${‖ f ( x ) ‖}_{p} = {( \int {\vert f ( x ) \vert}^{p} ⅆ x )}^{\frac{1}{2}} , p = 1 , 2 , …$$

However, the Euclidean norm is one of the most useful and is the basis for least squares estimation methods in general.

The error function e is an example of a ‘Hilbert space’ which is a vector space. It is a function of the complex coefficients aₙ and is a minimum when

$$\begin{matrix}\frac{\partial e}{\partial {a}_{m}^{r}} = 0 \\ and \\ \frac{\partial e}{\partial {a}_{m}^{i}} = 0\end{matrix}$$

where

aₘ^{r}=Re[aₘ]

and

aₘⁱ=Im[aₘ]

The above conditions lead to the result

$$\int ( f ( x ) - {\sum }_{ n}^{} {a}_{n} {y}_{n} ( x ) ) {y}_{m}^{*} ( x ) ⅆ x = 0$$

or

[symbol]

ƒ−\hat{ƒ}, y*ₘ [symbol] =0

which follows from the analysis below:

$$\begin{matrix} & \\ e = \int \vert f - {\sum }_{ n}^{} ( {a}_{n}^{r} + {ia}_{n}^{i} ) {y}_{n} {\vert}^{2} ⅆ x \int ( f - {\sum }_{ n}^{} ( {a}_{n}^{r} + {ia}_{n}^{i} ) {y}_{n} ) \\ ( {f}^{*} - {\sum }_{ n}^{} ( {a}_{n}^{r} - {ia}_{n}^{i} ) {y}_{n}^{*} ) ⅆ x \frac{\partial e}{\partial {a}_{m}^{r}} = \int ( f - {\sum }_{ n}^{} ( {a}_{n}^{r} + {ia}_{n}^{i} ) {y}_{n} ) {y}_{m}^{*} ⅆ x - \int ( {f}^{*} - {\sum }_{ n}^{} ( {a}_{n}^{r} + {ia}_{n}^{i} ) {y}_{n}^{*} ) {y}_{m} ⅆ x = 0 & ( A1 ) \\ \frac{\partial e}{\partial {a}_{m}^{i}} = i \int ( f - {\sum }_{ n}^{} ( {a}_{n}^{r} + {ia}_{n}^{i} ) {y}_{n} ) {y}_{m}^{*} ⅆ x - \int ( {f}^{*} - {\sum }_{ n}^{} ( {a}_{n}^{r} - {ia}_{n}^{i} ) {y}_{n}^{*} ) {y}_{m} ⅆ x = 0 \int ( f - {\sum }_{ n}^{} ( {a}_{n}^{r} + {ia}_{n}^{i} ) {y}_{n} ) {y}_{m}^{*} ⅆ x - \\ {\int }_{}^{} ( {f}^{*} - {\sum }_{n}^{} ( {a}_{n}^{r} - {ia}_{n}^{i} ) {y}_{n}^{*} ) {y}_{m} ⅆ x = 0 & ( A2 )\end{matrix}$$

Equation (A2) minus equation (A1) gives

$$\int ( f - {\sum }_{ n}^{} ( {a}_{n}^{r} + {ia}_{n}^{i} ) {y}_{n} ) {y}_{m}^{*} ⅆ x = 0$$

or

$$\int ( f - {\sum }_{ n}^{} {a}_{n} {y}_{n} ) {y}_{m}^{*} ⅆ x = 0$$

Linear Convolution Models

So far, we have demonstrated the least squares principle for approximating a function using a model for the estimate \hat{ƒ} of the form

$$\hat{f} ( x ) = {\sum }_{ n}^{} {a}_{n} {y}_{n} ( x )$$

Another model which has a number of important applications is the linear convolution model

\hat{ƒ}(x)=y(x) [symbol] a(x)

In this case, the least squares principle can again be used to find the function a. A simple way to show how this can be done is to demonstrate the technique for digital signals and then use a limiting argument for continuous functions.

Real Discrete Functions—Digital Signals

If ƒᵢ is a real discrete function, i.e. a vector consisting of a set of numbers ƒ₁, ƒ₂, ƒ₃, . . . etc., then we may use a linear convolution model for the discrete estimate \hat{ƒ}ᵢ given by

$${\hat{f}}_{i} = {\sum }_{ j}^{} {y}_{i - j} {a}_{j}$$

In this case, using the least squares principle, we find aᵢ by minimizing the mean square error

$$e = {\sum }_{ i}^{} {( {f}_{i} - {\hat{f}}_{i} )}^{2}$$

This error is a minimum when

$$\frac{\partial }{\partial {a}_{k}} {\sum }_{ i}^{} {( {f}_{i} - {\sum }_{ j}^{} {y}_{i - j} {a}_{j} )}^{2} = 0$$

Differentiating, we get

$$- 2 {\sum }_{ I}^{} ( {f}_{i} - {\sum }_{ j}^{} {y}_{i - j} {a}_{j} ) \frac{\partial }{\partial {a}_{k}} {\sum }_{ j}^{} {y}_{i - j} {a}_{j} = - 2 {\sum }_{ i}^{} ( {f}_{i} - {\sum }_{ j}^{} {y}_{i - j} {a}_{j} ) {y}_{i - k} = 0$$

and rearranging, we have

$${\sum }_{i}^{} {f}_{i} {y}_{i - k} = {\sum }_{i}^{} ( {\sum }_{j}^{} {y}_{i - j} {a}_{j} ) {y}_{i - k}$$

The left hand side of this equation is just the discrete correlation of ƒᵢ with yᵢ and the right hand side is a correlation of yᵢ with

$${\sum }_{j}^{} {y}_{i - j} {a}_{j}$$

which is itself just a discrete convolution of yᵢ with aᵢ. Hence, using the appropriate symbols we can write this equation as

ƒᵢ⊙yᵢ=(yᵢ [symbol] aᵢ)⊙yᵢ

Real Continuous Functions—Analogue Signals

For continuous functions, the optimum function a which minimizes the mean square error

e=∫[ƒ(x)−\hat{ƒ}(x)]²dx

where

\hat{ƒ}(x)=a(x) [symbol] y(x)

is obtained by solving the equation

[ƒ(x)−a(x) [symbol] y(x)]⊙y(x)=0

This result is based on extending the result derived above for digital signals to infinite sums and using a limiting argument to integrals.

Complex Digital Signals

If the data are a elements of a complex discrete function ƒᵢ where ƒᵢ corresponds to a set of complex numbers ƒ₁, ƒ₂, ƒ₃, . . . , then we use the mean square error defined by

$$e = {\sum }_{i}^{} {\vert {f}_{i} - {\hat{f}}_{i} \vert}^{2}$$

and a linear convolution model of the form

$${\hat{f}}_{i} = {\sum }_{j}^{} {y}_{i - j} {a}_{j}$$

In this case, the error is a minimum when

$$\frac{\partial e}{\partial {a}_{k}^{′}} = {\sum }_{i}^{} ( {f}_{i} - {\sum }_{j}^{} {y}_{i - j} {a}_{i} ) {y}_{i - k}^{*} = 0$$

or

ƒᵢ⊙y*ᵢ=(yᵢ [symbol] aᵢ)⊙y*ᵢ

Complex Analogue Signals

If \hat{ƒ}(x) is a complex estimate given by

\hat{ƒ}(x)=a(x) [symbol] y(x)

then the function a(x) which minimizes the error

e=∥ƒ(x)−\hat{ƒ}(x)∥²

is given by solving the equation

[ƒ(x)−a(x) [symbol] y(x)]⊙(y*(x)=0

This result is just another version of the orthogonality principle.

Points on Notation

Note that in the work presented above, the symbols [symbol] and ⊙ have been used to denote convolution and correlation respectively for both continuous and discrete data. With discrete signals, [symbol] and ⊙ denote convolution and correlation sums respectively. This is indicated by the presence of subscripts on the appropriate functions. If subscripts are not present, then the functions in question are continuous and [symbol] and ⊙ are taken to denote convolution and correlation integrals respectively.

Two Dimensions

In two dimensions, the least squares method may also be used to approximate a function using the same methods that have been presented above. For example, suppose we wish to approximate the complex 2D function ƒ(x, y) using an estimate of the form

$$\hat{f} ( x , y ) = {\sum }_{n}^{} {\sum }_{m}^{} {a}_{n m} {φ}_{n m} ( x , y )$$

In this case, the mean square error is given by

e=∫∫|ƒ(x, y)−\hat{ƒ}(x, y)|²dxdy

Using the orthogonality principle, this error is a minimum when

$$\int \int [ f ( x , y ) - {\sum }_{n}^{} {\sum }_{m}^{} {a}_{n m} {φ}_{n m} ( x , y ) ] {φ}_{pq}^{*} ( x , y ) ⅆ x ⅆ y = 0$$

This is just a two dimensional version of the orthogonality principle. Another important linear model that is used for designing two dimensional digital filters is

$${\hat{f}}_{ij} = {\sum }_{n}^{} {\sum }_{m}^{} {y}_{i - n , j - m} {a}_{n m}$$

In this case, for complex data, the mean square error

$$e = {\sum }_{i}^{} {\sum }_{j}^{} {\vert {f}_{ij} - {\hat{f}}_{ij} \vert}^{2}$$

is a minimum when

$${\sum }_{i}^{} {\sum }_{j}^{} ( {f}_{ij} - {\sum }_{n}^{} {\sum }_{m}^{} {y}_{i - n , j - m} {a}_{n m} ) {y}_{i - p , j - q}^{*} = 0$$

Using the appropriate symbols we can write this equation in the form

ƒᵢⱼ⊙⊙y*ᵢⱼ=(yᵢⱼ [symbol] [symbol] aᵢⱼ)⊙⊙y*ᵢⱼ

For continuous functions, when

\hat{ƒ}(x, y)=y(x, y) [symbol] [symbol] a(x, y)

the error

e=∫∫|ƒ(x, y)−\hat{ƒ}(x, y)|²dxdy

is a minimum when

[ƒ(x, y)−a(x, y) [symbol] [symbol] y(x, y)]⊙⊙y*(x, y)=0

### SECTION 5

Title: “Predictive Apparatus and Method”

THIS INVENTION relates to apparatus including a computer, for predicting trends and outcomes in fields involving phenomena which, in fractal terms, are statistically self-affine.

WO99/17260, the disclosure of which is incorporated herein by reference, incorporates a discussion of fractal concepts applied to the statistics of phenomena having a significant random or pseudo-random component and provides a mathematical treatment of a technique for imposing a so-called fractal modulation upon such phenomena whereby information can be encoded in, for example, a printed image on documents such as banknotes, in such a way as not to be apparent upon ordinary visual inspection or scrutiny, and likewise provides a mathematical treatment of a corresponding technique for a converse demodulation process by means of which such information can be recovered from the printed image, for example to verify the authenticity of the document.

The inventors in respect of the present application have discovered that similar fractal statistical demodulation techniques can also be used in extracting useful information from “natural” phenomena which exhibit similarly statistically fractal characteristics and which, in particular, are statistically self-affine, in the sense in which that term is used in the mathematics of fractals.

According to one aspect of the invention, there is provided a method of deriving predictive information relating to phenomena which are statistically fractal in a time dimension, comprising analysing, by computer means, statistical data relating to such phenomena at different times, such computer means being arranged to execute a program such as to perform, on said data, mathematical processes based upon fractal demodulation, in order to derive predictive information relating to the phenomena.

According to another aspect of the invention, there is provided apparatus for deriving predictive information relating to statistically fractal information, including a computer programmed to perform, on said data, mathematical processes based upon fractal demodulation, to derive predictive information relating to the phenomena.

According to another aspect of the invention, there is provided a data carrier, such as a floppy disk or CD-ROM, carrying a program for a computer whereby a computer programmed with the program may carry out the method of the invention.

The said mathematical processes based upon fractal demodulation may be or include mathematical processes disclosed in WO99/17260.

The computer program concerned may suitably incorporate an algorithm or algorithms of general application to phenomena of a broad class. The applicants envisage that the program, in a simple form, may be arranged to apply, to the relevant data, two such general algorithms successively.

In one embodiment the method is applied to the analysis of financial data, for example relating to the stock market or commodity prices or the like, to provide a more reliable detection and prediction of economic trends. Thus, in accordance with this embodiment, it may be possible to detect the first signs of a market “crash” months before it would occur, and in time to allow financial institutions to take remedial action.

In another embodiment, the method is applied to the field of medicine. The inventors have discovered that epidemiological data on a geographical perspective is statistically self-affine, irrespective of the type of disease concerned, and is thus susceptible of study by the method and apparatus of the invention. Thus, the invention may provide a new tool in the study of cause and effect in matters of health.

The applicants believe that this approach will, in the future, be of significant value in the analysis of health care, and in allowing government expenditure on health care to be appropriately directed.

The applicants believe that the following areas of medicine are among those which will benefit from the invention:

1. The analysis and comparison of genetic sequences with insertions and deletions.

2. The analysis of the complex electrical patterns of the heart (cardiac arrhythmias) and brain (EMG recording).

3. Epidemiology of infectious disease and targeting of vaccination, including epidemic prediction worldwide, particularly with regard to illnesses which are poorly understood such as B.S.E. and ME.

4. Pharmacology. When analysing a new pharmaceutical product the importance of crucial data may not be appreciated when normal Gaussian statistical models are applied. Millions, if not billions, of dollars may be invested in a new drug's development. All this can be lost if the drug has to be unexpectedly withdrawn due to a side effect not predicted. If the invention could help predict these events the commercial benefit would be enormous.

5. Engineering of raw pharmaceuticals. The way viruses, bacteria, cancerous cells, etc., evolve and mutate (cell dynamics) appears initially to be random. If this “natural selection” could be predicted a pharmaceutical response could be prepared. Examples would include Multidrug resistant TB, HIV treatment, and MRSA (a common resistant infection in hospitals). Drug resistance is an increasing problem. If the mutations made by bacterial could be predicted then treatment could be appropriately devised. Application of the invention to appropriate data may provide warning of a multi-drug resistant crisis and allow antibiotic use to be curtailed immediately, or other preventative measures to be taken.

The invention may, of course, be applied to analysis and prediction of events involving other phenomena exhibiting fractal, self-affine, behaviour. For example, the invention may be applied to weather forecasting or climatological forecasting etc.

In the present specification “comprises” means “includes or consists of” and “comprising” means “including or consisting of”.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

### CONCLUDING SECTION

From the foregoing, it will be appreciated that some of the aspects of the invention disclosed are concerned with converting meaningful data (or plain text) to a chaotic or pseudo chaotic form (i.e. encrypted form) whilst other aspects disclosed are concerned with the interpretation of chaotic or seemingly chaotic data in such a way as to derive more meaningful information from it. Thus, for example, the invention in some of these other aspects allows day-to-day variation in hospital admissions for example to be interpreted so as to provide reliable predictions of future demand for hospital beds, or allows short-term variations in meteorological measurements to be interpreted to provide predictions of future weather or climate, or allows seemingly chaotic variations is histology slides to provide a screening of normal specimens from pathological or possibly pathological ones.

1. A document, card, or the like, having an area adapted to receive a signature or other identifying marking, and which bears a two-dimensional coded marking adapted for reading by a complementary automatic reading device.

2. A document, card, or the like in accordance with claim 1, wherein said area is adapted to have a signature written thereon.

3. An automatic reading device for reading document, card, or the like in accordance with claim 2, and which is capable of reading the information coded into said two-dimensional coded marking and of comparing the modification of the coded marking due to a signature or other marking thereon with the effect of a signature which is the subject of stored data to which the reading device has access in order to determine whether the signature on said area is that of the individual whose signature is the subject of that stored data.

4. A data encryption system utilising fractal principles.

5. A data encryption system utilising the mathematics of chaos.

6. A data encryption system which uses a chaotic or pseudo-random key and a camouflage encryption key.

7. A method of processing a section of video “footage” to produce a “still” view of higher visual quality than the individual frames of that footage, comprising sampling, over a plurality of video “frames”, image quantities (such as brightness and hue or colour) for corresponding points over such frames, and processing the samples to produce a high quality “still” frame.

8. A method according to claim 7 wherein said processing includes utilisation of one or more of the techniques disclosed in Part 2 of this specification, including the appendices thereto.

9. A method according to claim 7 or claim 8 wherein an initial stage of said processing comprises averaging said image quantities for such corresponding image points over a plurality of video frames to produce an average frame, utilised in subsequent processing steps.

10. Apparatus for processing a section of video footage to produce a “still” view of higher visual quality than the individual frames of that footage, the apparatus comprising means for receiving data in digital form corresponding to said frames, processing means for processing such data and producing digital data corresponding to an enhanced image based on such individual frames, and means for displaying or printing said enhanced image.

11. Apparatus according to claim 10 wherein said processing means is programmed to execute one or more of the processing techniques disclosed in Part 2 of this specification, including the appendices thereto.

12. A method of deriving predictive information relating to phenomena which are statistically fractal in a time dimension, comprising analysing, by computer means, statistical data relating to such phenomena at different times, such computer means being arranged to execute a program such as to perform, on said data, mathematical processes based upon fractal demodulation, in order to derive predictive information relating to the phenomena.

13. Apparatus for deriving predictive information relating to statistically fractal information, including a computer programmed to perform, on said data, mathematical processes based upon fractal demodulation, to derive predictive information relating to the phenomena.

14. A data carrier, such as a floppy disk or CD-ROM, carrying a program for a computer whereby a computer programmed with the program may carry out the method of the invention.
